(19) United States
(12) Patent Application Publication
(10) Pub. No.: US 2024/0103678 A1
(43) Pub. Date: Mar. 28, 2024

(54) DEVICES, METHODS, AND GRAPHICAL USER INTERFACES FOR INTERACTING WITH EXTENDED REALITY EXPERIENCES

(71) Applicant: Apple Inc., Cupertino, CA (US)

(72) Inventors: Allison W. DRYER, Healdsburg, CA (US); Anshu K. CHIMALAMARRI, Sunnyvale, CA (US); Giancarlo YERKES, San Francisco, CA (US); Nahckjoon KIM, Sunnyvale, CA (US); Stephen O. LEMAY, Palo Alto, CA (US); Jessica TRINH, Oakland, CA (US)

(21) Appl. No.: 18/369,075

(22) Filed: Sep. 15, 2023

Related U.S. Application Data
(60) Provisional application No. 63/538,453, filed on Sep. 14, 2023.
(60) Provisional application No. 63/409,184, filed on Sep. 22, 2022.

(51) Int. Cl. G06F 3/04815; G06F 3/01; G06F 3/04842; G06F 3/16

(52) U.S. Cl. CPC G06F 3/04815; G06F 3/013; G06F 3/04842; G06F 3/167

(57) ABSTRACT

The present disclosure generally relates to user interfaces for electronic devices, including user interfaces for navigating between and/or interacting with extended reality user interfaces.

### CROSS-REFERENCE TO RELATED APPLICATIONS

This application claims priority to U.S. Provisional Patent Application Ser. No. 63/538,453, entitled “DEVICES, METHODS, AND GRAPHICAL USER INTERFACES FOR INTERACTING WITH EXTENDED REALITY EXPERIENCES,” filed Sep. 14, 2023, and to U.S. Provisional Patent Application Ser. No. 63/409,184, entitled “DEVICES, METHODS, AND GRAPHICAL USER INTERFACES FOR INTERACTING WITH EXTENDED REALITY EXPERIENCES,” filed Sep. 22, 2022, the content of which are incorporated herein by reference in their entirety.

### TECHNICAL FIELD

The present disclosure relates generally to computer systems that are in communication with one or more display generation components and one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences such as, for example, extended reality experiences, to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with extended reality experiences. Such methods and interfaces may complement or replace conventional methods for interacting with extended reality experiences. Such methods and interfaces reduce the number, extent, and/or the nature of the inputs from a user and produce a more efficient human-machine interface. For battery-operated computing devices, such methods and interfaces conserve power and increase the time between battery charges.

In accordance with some embodiments, a method is described. The method comprises: at a computer system that is in communication with one or more display generation components and one or more input devices: concurrently displaying, via the one or more display generation components, in a three-dimensional environment, representations of a plurality of augmented reality experiences, including: a first representation of a first augmented reality experience; and a second representation of a second augmented reality experience that is different from the first augmented reality experience, wherein the second representation is different from the first representation; while concurrently displaying, in the three-dimensional environment, the representations of the plurality of augmented reality experiences, receiving, via the one or more input devices, a first user input; and in response to receiving the first user input: ceasing display of the representations of one or more of the plurality of augmented reality experiences; and in accordance with a determination that the first user input corresponds to selection of the first representation of the first augmented reality experience, displaying, via the one or more display generation components, in the three-dimensional environment, the first augmented reality experience.

In accordance with some embodiments, a non-transitory computer-readable storage medium is described. In some embodiments, the non-transitory computer-readable storage medium stores one or more programs configured to be executed by one or more processors of a computer system that is in communication with one or more display generation components and one or more input devices, the one or more programs including instructions for: concurrently displaying, via the one or more display generation components, in a three-dimensional environment, representations of a plurality of augmented reality experiences, including: a first representation of a first augmented reality experience; and a second representation of a second augmented reality experience that is different from the first augmented reality experience, wherein the second representation is different from the first representation; while concurrently displaying, in the three-dimensional environment, the representations of the plurality of augmented reality experiences, receiving, via the one or more input devices, a first user input; and in response to receiving the first user input: ceasing display of the representations of one or more of the plurality of augmented reality experiences; and in accordance with a determination that the first user input corresponds to selection of the first representation of the first augmented reality experience, displaying, via the one or more display generation components, in the three-dimensional environment, the first augmented reality experience.

In accordance with some embodiments, a transitory computer-readable storage medium is described. In some embodiments, the transitory computer-readable storage medium stores one or more programs configured to be executed by one or more processors of a computer system that is in communication with one or more display generation components and one or more input devices, the one or more programs including instructions for: concurrently displaying, via the one or more display generation components, in a three-dimensional environment, representations of a plurality of augmented reality experiences, including: a first representation of a first augmented reality experience; and a second representation of a second augmented reality experience that is different from the first augmented reality experience, wherein the second representation is different from the first representation; while concurrently displaying, in the three-dimensional environment, the representations of the plurality of augmented reality experiences, receiving, via the one or more input devices, a first user input; and in response to receiving the first user input: ceasing display of the representations of one or more of the plurality of augmented reality experiences; and in accordance with a determination that the first user input corresponds to selection of the first representation of the first augmented reality experience, displaying, via the one or more display generation components, in the three-dimensional environment, the first augmented reality experience.

In accordance with some embodiments, a computer system is described. In some embodiments, the computer system is configured to communicate with one or more display generation components and one or more input devices, and comprises: one or more processors; and memory storing one or more programs configured to be executed by the one or more processors, the one or more programs including instructions for: concurrently displaying, via the one or more display generation components, in a three-dimensional environment, representations of a plurality of augmented reality experiences, including: a first representation of a first augmented reality experience; and a second representation of a second augmented reality experience that is different from the first augmented reality experience, wherein the second representation is different from the first representation; while concurrently displaying, in the three-dimensional environment, the representations of the plurality of augmented reality experiences, receiving, via the one or more input devices, a first user input; and in response to receiving the first user input: ceasing display of the representations of one or more of the plurality of augmented reality experiences; and in accordance with a determination that the first user input corresponds to selection of the first representation of the first augmented reality experience, displaying, via the one or more display generation components, in the three-dimensional environment, the first augmented reality experience.

In accordance with some embodiments, a computer system is described. In some embodiments, the computer system is configured to communicate with one or more display generation components and one or more input devices, and the computer system comprises: means for concurrently displaying, via the one or more display generation components, in a three-dimensional environment, representations of a plurality of augmented reality experiences, including: a first representation of a first augmented reality experience; and a second representation of a second augmented reality experience that is different from the first augmented reality experience, wherein the second representation is different from the first representation; means for, while concurrently displaying, in the three-dimensional environment, the representations of the plurality of augmented reality experiences, receiving, via the one or more input devices, a first user input; and means for, in response to receiving the first user input: ceasing display of the representations of one or more of the plurality of augmented reality experiences; and in accordance with a determination that the first user input corresponds to selection of the first representation of the first augmented reality experience, displaying, via the one or more display generation components, in the three-dimensional environment, the first augmented reality experience.

In accordance with some embodiments, a computer program product is described. In some embodiments, the computer program product comprises one or more programs configured to be executed by one or more processors of a computer system that is in communication with one or more display generation components and one or more input devices, the one or more programs including instructions for: concurrently displaying, via the one or more display generation components, in a three-dimensional environment, representations of a plurality of augmented reality experiences, including: a first representation of a first augmented reality experience; and a second representation of a second augmented reality experience that is different from the first augmented reality experience, wherein the second representation is different from the first representation; while concurrently displaying, in the three-dimensional environment, the representations of the plurality of augmented reality experiences, receiving, via the one or more input devices, a first user input; and in response to receiving the first user input: ceasing display of the representations of one or more of the plurality of augmented reality experiences; and in accordance with a determination that the first user input corresponds to selection of the first representation of the first augmented reality experience, displaying, via the one or more display generation components, in the three-dimensional environment, the first augmented reality experience.

In accordance with some embodiments, a method is described. The method comprises: at a computer system that is in communication with one or more display generation components and one or more input devices: receiving, via a first physical control, a first sequence of one or more user inputs; and in response to receiving the first sequence of one or more user inputs: in accordance with a determination that the first sequence of one or more user inputs has a first magnitude: displaying, via the one or more display generation components, in a three-dimensional environment, a first extended reality experience; and in accordance with a determination that the first sequence of one or more user inputs has a second magnitude different from the first magnitude: displaying, via the one or more display generation components, in the three-dimensional environment, a second extended reality experience different from the first extended reality experience.

In accordance with some embodiments, a non-transitory computer-readable storage medium is described. In some embodiments, the non-transitory computer-readable storage medium stores one or more programs configured to be executed by one or more processors of a computer system that is in communication with one or more display generation components and one or more input devices, the one or more programs including instructions for: receiving, via a first physical control, a first sequence of one or more user inputs; and in response to receiving the first sequence of one or more user inputs: in accordance with a determination that the first sequence of one or more user inputs has a first magnitude: displaying, via the one or more display generation components, in a three-dimensional environment, a first extended reality experience; and in accordance with a determination that the first sequence of one or more user inputs has a second magnitude different from the first magnitude: displaying, via the one or more display generation components, in the three-dimensional environment, a second extended reality experience different from the first extended reality experience.

In accordance with some embodiments, a transitory computer-readable storage medium is described. In some embodiments, the transitory computer-readable storage medium stores one or more programs configured to be executed by one or more processors of a computer system that is in communication with one or more display generation components and one or more input devices, the one or more programs including instructions for: receiving, via a first physical control, a first sequence of one or more user inputs; and in response to receiving the first sequence of one or more user inputs: in accordance with a determination that the first sequence of one or more user inputs has a first magnitude: displaying, via the one or more display generation components, in a three-dimensional environment, a first extended reality experience; and in accordance with a determination that the first sequence of one or more user inputs has a second magnitude different from the first magnitude: displaying, via the one or more display generation components, in the three-dimensional environment, a second extended reality experience different from the first extended reality experience.

In accordance with some embodiments, a computer system is described. In some embodiments, the computer system is configured to communicate with one or more display generation components and one or more input devices, and comprises: one or more processors; and memory storing one or more programs configured to be executed by the one or more processors, the one or more programs including instructions for: receiving, via a first physical control, a first sequence of one or more user inputs; and in response to receiving the first sequence of one or more user inputs: in accordance with a determination that the first sequence of one or more user inputs has a first magnitude: displaying, via the one or more display generation components, in a three-dimensional environment, a first extended reality experience; and in accordance with a determination that the first sequence of one or more user inputs has a second magnitude different from the first magnitude: displaying, via the one or more display generation components, in the three-dimensional environment, a second extended reality experience different from the first extended reality experience.

In accordance with some embodiments, a computer system is described. In some embodiments, the computer system is configured to communicate with one or more display generation components and one or more input devices, and the computer system comprises: means for receiving, via a first physical control, a first sequence of one or more user inputs; and means for, in response to receiving the first sequence of one or more user inputs: in accordance with a determination that the first sequence of one or more user inputs has a first magnitude: displaying, via the one or more display generation components, in a three-dimensional environment, a first extended reality experience; and in accordance with a determination that the first sequence of one or more user inputs has a second magnitude different from the first magnitude: displaying, via the one or more display generation components, in the three-dimensional environment, a second extended reality experience different from the first extended reality experience.

In accordance with some embodiments, a computer program product is described. In some embodiments, the computer program product comprises one or more programs configured to be executed by one or more processors of a computer system that is in communication with one or more display generation components and one or more input devices, the one or more programs including instructions for: receiving, via a first physical control, a first sequence of one or more user inputs; and in response to receiving the first sequence of one or more user inputs: in accordance with a determination that the first sequence of one or more user inputs has a first magnitude: displaying, via the one or more display generation components, in a three-dimensional environment, a first extended reality experience; and in accordance with a determination that the first sequence of one or more user inputs has a second magnitude different from the first magnitude: displaying, via the one or more display generation components, in the three-dimensional environment, a second extended reality experience different from the first extended reality experience.

In accordance with some embodiments, a method is described. The method comprises: at a computer system that is in communication with one or more display generation components and one or more input devices: while a view of a three-dimensional environment in which the computer system is located is visible, detecting, via the one or more input devices, a first set of conditions in the three-dimensional environment; and in response to detecting the first set of conditions in the three-dimensional environment: displaying, via the one or more display generation components and concurrently with at least a portion of the view of the three-dimensional environment of the computer system, a first suggestion that corresponds to a first augmented reality experience, wherein the first augmented reality experience is selected from a plurality of augmented reality experiences available to be displayed by the computer system.

In accordance with some embodiments, a non-transitory computer-readable storage medium is described. In some embodiments, the non-transitory computer-readable storage medium stores one or more programs configured to be executed by one or more processors of a computer system that is in communication with one or more display generation components and one or more input devices, the one or more programs including instructions for: while a view of a three-dimensional environment in which the computer system is located is visible, detecting, via the one or more input devices, a first set of conditions in the three-dimensional environment; and in response to detecting the first set of conditions in the three-dimensional environment: displaying, via the one or more display generation components and concurrently with at least a portion of the view of the three-dimensional environment of the computer system, a first suggestion that corresponds to a first augmented reality experience, wherein the first augmented reality experience is selected from a plurality of augmented reality experiences available to be displayed by the computer system.

In accordance with some embodiments, a transitory computer-readable storage medium is described. In some embodiments, the transitory computer-readable storage medium stores one or more programs configured to be executed by one or more processors of a computer system that is in communication with one or more display generation components and one or more input devices, the one or more programs including instructions for: while a view of a three-dimensional environment in which the computer system is located is visible, detecting, via the one or more input devices, a first set of conditions in the three-dimensional environment; and in response to detecting the first set of conditions in the three-dimensional environment: displaying, via the one or more display generation components and concurrently with at least a portion of the view of the three-dimensional environment of the computer system, a first suggestion that corresponds to a first augmented reality experience, wherein the first augmented reality experience is selected from a plurality of augmented reality experiences available to be displayed by the computer system.

In accordance with some embodiments, a computer system is described. In some embodiments, the computer system is configured to communicate with one or more display generation components and one or more input devices, and comprises: one or more processors; and memory storing one or more programs configured to be executed by the one or more processors, the one or more programs including instructions for: while a view of a three-dimensional environment in which the computer system is located is visible, detecting, via the one or more input devices, a first set of conditions in the three-dimensional environment; and in response to detecting the first set of conditions in the three-dimensional environment: displaying, via the one or more display generation components and concurrently with at least a portion of the view of the three-dimensional environment of the computer system, a first suggestion that corresponds to a first augmented reality experience, wherein the first augmented reality experience is selected from a plurality of augmented reality experiences available to be displayed by the computer system.

In accordance with some embodiments, a computer system is described. In some embodiments, the computer system is configured to communicate with one or more display generation components and one or more input devices, and the computer system comprises: means for, while a view of a three-dimensional environment in which the computer system is located is visible, detecting, via the one or more input devices, a first set of conditions in the three-dimensional environment; and means for, in response to detecting the first set of conditions in the three-dimensional environment: displaying, via the one or more display generation components and concurrently with at least a portion of the view of the three-dimensional environment of the computer system, a first suggestion that corresponds to a first augmented reality experience, wherein the first augmented reality experience is selected from a plurality of augmented reality experiences available to be displayed by the computer system.

In accordance with some embodiments, a computer program product is described. In some embodiments, the computer program product comprises one or more programs configured to be executed by one or more processors of a computer system that is in communication with one or more display generation components and one or more input devices, the one or more programs including instructions for: while a view of a three-dimensional environment in which the computer system is located is visible, detecting, via the one or more input devices, a first set of conditions in the three-dimensional environment; and in response to detecting the first set of conditions in the three-dimensional environment: displaying, via the one or more display generation components and concurrently with at least a portion of the view of the three-dimensional environment of the computer system, a first suggestion that corresponds to a first augmented reality experience, wherein the first augmented reality experience is selected from a plurality of augmented reality experiences available to be displayed by the computer system.

In accordance with some embodiments, a method is described. The method comprises: at a computer system that is in communication with one or more display generation components and one or more input devices: detecting, via the one or more input devices, a gaze of a user corresponding to a first display position of the one or more display generation components; in response to detecting the gaze of the user corresponding to the first display position of the one or more display generation components, displaying, via the one or more display generation components, a first object; while displaying the first object, detecting that a first set of criteria are met; in response to detecting that the first set of criteria are met, displaying, via the one or more display generation components, movement of the first object; and subsequent to displaying movement of the first object: in accordance with a determination that the gaze of the user meets a second set of criteria indicative of gaze tracking of the movement of the first object, performing a first operation; and in accordance with a determination that the gaze of the user does not meet the second set of criteria indicative of gaze tracking of the movement of the first object, forgoing performing the first operation.

In accordance with some embodiments, a non-transitory computer-readable storage medium is described. In some embodiments, the non-transitory computer-readable storage medium stores one or more programs configured to be executed by one or more processors of a computer system that is in communication with one or more display generation components and one or more input devices, the one or more programs including instructions for: detecting, via the one or more input devices, a gaze of a user corresponding to a first display position of the one or more display generation components; in response to detecting the gaze of the user corresponding to the first display position of the one or more display generation components, displaying, via the one or more display generation components, a first object; while displaying the first object, detecting that a first set of criteria are met; in response to detecting that the first set of criteria are met, displaying, via the one or more display generation components, movement of the first object; and subsequent to displaying movement of the first object: in accordance with a determination that the gaze of the user meets a second set of criteria indicative of gaze tracking of the movement of the first object, performing a first operation; and in accordance with a determination that the gaze of the user does not meet the second set of criteria indicative of gaze tracking of the movement of the first object, forgoing performing the first operation.

In accordance with some embodiments, a transitory computer-readable storage medium is described. In some embodiments, the transitory computer-readable storage medium stores one or more programs configured to be executed by one or more processors of a computer system that is in communication with one or more display generation components and one or more input devices, the one or more programs including instructions for: detecting, via the one or more input devices, a gaze of a user corresponding to a first display position of the one or more display generation components; in response to detecting the gaze of the user corresponding to the first display position of the one or more display generation components, displaying, via the one or more display generation components, a first object; while displaying the first object, detecting that a first set of criteria are met; in response to detecting that the first set of criteria are met, displaying, via the one or more display generation components, movement of the first object; and subsequent to displaying movement of the first object: in accordance with a determination that the gaze of the user meets a second set of criteria indicative of gaze tracking of the movement of the first object, performing a first operation; and in accordance with a determination that the gaze of the user does not meet the second set of criteria indicative of gaze tracking of the movement of the first object, forgoing performing the first operation.

In accordance with some embodiments, a computer system is described. In some embodiments, the computer system is configured to communicate with one or more display generation components and one or more input devices, and comprises: one or more processors; and memory storing one or more programs configured to be executed by the one or more processors, the one or more programs including instructions for: detecting, via the one or more input devices, a gaze of a user corresponding to a first display position of the one or more display generation components; in response to detecting the gaze of the user corresponding to the first display position of the one or more display generation components, displaying, via the one or more display generation components, a first object; while displaying the first object, detecting that a first set of criteria are met; in response to detecting that the first set of criteria are met, displaying, via the one or more display generation components, movement of the first object; and subsequent to displaying movement of the first object: in accordance with a determination that the gaze of the user meets a second set of criteria indicative of gaze tracking of the movement of the first object, performing a first operation; and in accordance with a determination that the gaze of the user does not meet the second set of criteria indicative of gaze tracking of the movement of the first object, forgoing performing the first operation.

In accordance with some embodiments, a computer system is described. In some embodiments, the computer system is configured to communicate with one or more display generation components and one or more input devices, and the computer system comprises: means for detecting, via the one or more input devices, a gaze of a user corresponding to a first display position of the one or more display generation components; means for, in response to detecting the gaze of the user corresponding to the first display position of the one or more display generation components, displaying, via the one or more display generation components, a first object; means for, while displaying the first object, detecting that a first set of criteria are met; means for, in response to detecting that the first set of criteria are met, displaying, via the one or more display generation components, movement of the first object; and means for, subsequent to displaying movement of the first object: in accordance with a determination that the gaze of the user meets a second set of criteria indicative of gaze tracking of the movement of the first object, performing a first operation; and in accordance with a determination that the gaze of the user does not meet the second set of criteria indicative of gaze tracking of the movement of the first object, forgoing performing the first operation.

In accordance with some embodiments, a computer program product is described. In some embodiments, the computer program product comprises one or more programs configured to be executed by one or more processors of a computer system that is in communication with one or more display generation components and one or more input devices, the one or more programs including instructions for: detecting, via the one or more input devices, a gaze of a user corresponding to a first display position of the one or more display generation components; in response to detecting the gaze of the user corresponding to the first display position of the one or more display generation components, displaying, via the one or more display generation components, a first object; while displaying the first object, detecting that a first set of criteria are met; in response to detecting that the first set of criteria are met, displaying, via the one or more display generation components, movement of the first object; and subsequent to displaying movement of the first object: in accordance with a determination that the gaze of the user meets a second set of criteria indicative of gaze tracking of the movement of the first object, performing a first operation; and in accordance with a determination that the gaze of the user does not meet the second set of criteria indicative of gaze tracking of the movement of the first object, forgoing performing the first operation.

In accordance with some embodiments, a method is described. The method comprises: at a computer system that is in communication with one or more display generation components and one or more input devices: displaying, via the one or more display generation components, virtual content; while displaying the virtual content, detecting, via the one or more input devices, a first hand gesture in front of a face of a user of the computer system; and in response to detecting the first hand gesture: in accordance with a determination that the first hand gesture in front of the face of the user meets a first set of criteria, ceasing display of at least a portion of the virtual content; and in accordance with a determination that the first hand gesture in front of the face of the user does not meet the first set of criteria, maintaining display of the virtual content.

In accordance with some embodiments, a non-transitory computer-readable storage medium is described. In some embodiments, the non-transitory computer-readable storage medium stores one or more programs configured to be executed by one or more processors of a computer system that is in communication with one or more display generation components and one or more input devices, the one or more programs including instructions for: displaying, via the one or more display generation components, virtual content; while displaying the virtual content, detecting, via the one or more input devices, a first hand gesture in front of a face of a user of the computer system; and in response to detecting the first hand gesture: in accordance with a determination that the first hand gesture in front of the face of the user meets a first set of criteria, ceasing display of at least a portion of the virtual content; and in accordance with a determination that the first hand gesture in front of the face of the user does not meet the first set of criteria, maintaining display of the virtual content.

In accordance with some embodiments, a transitory computer-readable storage medium is described. In some embodiments, the transitory computer-readable storage medium stores one or more programs configured to be executed by one or more processors of a computer system that is in communication with one or more display generation components and one or more input devices, the one or more programs including instructions for: displaying, via the one or more display generation components, virtual content; while displaying the virtual content, detecting, via the one or more input devices, a first hand gesture in front of a face of a user of the computer system; and in response to detecting the first hand gesture: in accordance with a determination that the first hand gesture in front of the face of the user meets a first set of criteria, ceasing display of at least a portion of the virtual content; and in accordance with a determination that the first hand gesture in front of the face of the user does not meet the first set of criteria, maintaining display of the virtual content.

In accordance with some embodiments, a computer system is described. In some embodiments, the computer system is configured to communicate with one or more display generation components and one or more input devices, and comprises: one or more processors; and memory storing one or more programs configured to be executed by the one or more processors, the one or more programs including instructions for: displaying, via the one or more display generation components, virtual content; while displaying the virtual content, detecting, via the one or more input devices, a first hand gesture in front of a face of a user of the computer system; and in response to detecting the first hand gesture: in accordance with a determination that the first hand gesture in front of the face of the user meets a first set of criteria, ceasing display of at least a portion of the virtual content; and in accordance with a determination that the first hand gesture in front of the face of the user does not meet the first set of criteria, maintaining display of the virtual content.

In accordance with some embodiments, a computer system is described. In some embodiments, the computer system is configured to communicate with one or more display generation components and one or more input devices, and the computer system comprises: means for displaying, via the one or more display generation components, virtual content; means for, while displaying the virtual content, detecting, via the one or more input devices, a first hand gesture in front of a face of a user of the computer system; and means for, in response to detecting the first hand gesture: in accordance with a determination that the first hand gesture in front of the face of the user meets a first set of criteria, ceasing display of at least a portion of the virtual content; and in accordance with a determination that the first hand gesture in front of the face of the user does not meet the first set of criteria, maintaining display of the virtual content.

In accordance with some embodiments, a computer program product is described. In some embodiments, the computer program product comprises one or more programs configured to be executed by one or more processors of a computer system that is in communication with one or more display generation components and one or more input devices, the one or more programs including instructions for: displaying, via the one or more display generation components, virtual content; while displaying the virtual content, detecting, via the one or more input devices, a first hand gesture in front of a face of a user of the computer system; and in response to detecting the first hand gesture: in accordance with a determination that the first hand gesture in front of the face of the user meets a first set of criteria, ceasing display of at least a portion of the virtual content; and in accordance with a determination that the first hand gesture in front of the face of the user does not meet the first set of criteria, maintaining display of the virtual content.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7K illustrate example techniques for navigating extended reality experiences, in accordance with some embodiments.

FIG. 8 is a flow diagram of methods of navigating extended reality experiences, in accordance with various embodiments.

FIG. 9 is a flow diagram of methods of navigating extended reality experiences, in accordance with various embodiments.

FIGS. 10A-10G illustrate example techniques for providing suggestions pertaining to extended reality experiences, in accordance with some embodiments.

FIG. 11 is a flow diagram of methods of providing suggestions pertaining to extended reality experiences, in accordance with various embodiments.

FIGS. 12A-12K illustrate example techniques for gaze-based interactions, in accordance with some embodiments.

FIG. 13 is a flow diagram of methods of gaze-based interactions, in accordance with some embodiments.

FIGS. 14A-14L illustrate example techniques for interacting with virtual content, in accordance with various embodiments.

FIG. 15 is a flow diagram of methods of interacting with virtual content, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with extended reality environments and other virtual content in multiple ways.

In some embodiments, a computer system concurrently displays, in a three-dimensional environment, representations of a plurality of augmented reality experiences, including a first representation of a first augmented reality experience, and a second representation of a second augmented reality experience. While concurrently displaying the representations of the plurality of augmented reality experiences, the computer system receives a first user input. In response to receiving the first user input, the computer system ceases display of the representations of one or more of the plurality of augmented reality experiences and, based on the direction and/or magnitude of the first user input, displays the first augmented reality experience or the second augmented reality experience. The computer system thereby provides a user with the ability to switch between different augmented reality experiences in an intuitive and efficient manner.

In some embodiments, a computer system receives a first sequence of one or more user inputs via a first physical control. In some embodiments, the first physical control is a rotatable and depressible physical control such that a user is able to provide rotational inputs as well as depression inputs via the first physical control. In response to receiving the first sequence of one or more user inputs, the computer system displays a first extended reality experience or a second extended reality experience based on the direction and/or magnitude of the first sequence of one or more user inputs. The computer system thereby provides a user with the ability to switch between different augmented reality experiences in an intuitive and efficient manner.

In some embodiments, a computer system detects a first set of conditions in a three-dimensional environment in which the computer system is located. For example, in various embodiments, the computer system detects one or more visible objects, audio content, or other conditions in the physical environment in which the computer system is located. In response to detecting the first set of conditions in the three-dimensional environment, the computer system displays a first suggestion that corresponds to a first augmented reality experience. The first augmented reality experience is selected from a plurality of augmented reality experiences available to be displayed by the computer system. For example, in some embodiments, the first augmented reality experience is selected based on the first set of conditions in the three-dimensional environment. The computer system thereby provides a user with suggestions for potentially relevant augmented reality experiences based on the conditions detected by the computer system.

In some embodiments, a computer system detects the gaze of a user corresponding to a first display position of one or more display generation components. In response to detecting the gaze of the user corresponding to the first display position, the computer system displays a first object. For example, the computer system displays a gaze target that the user is intended to track with his or her eyes. While displaying the first object, the computer system detects that a first set of criteria are met, and in response to detecting that the first set of criteria are met, the computer system displays movements of the first object. If the user successfully tracks movement of the first object with his or her gaze, the computer system performs a first operation, and if the user does not successfully track movement of the first object with his or her gaze, the computer system does not perform the first operation. For example, in some embodiments, the user is able to unlock the computer system with a gaze input by tracking movement of the first object. The computer system thereby provides a user with an intuitive and efficient way to perform an operation, such as unlocking the computer system, with a gaze input.

In some embodiments, a computer system displays virtual content. While displaying the virtual content, the computer system detects a first hand gesture in front of a face of a user of the computer system. If the first hand gesture meets a first set of criteria, the computer system ceases display of at least a portion of the virtual content. In this way, the computer system allows a user to quickly and easily clear some or all virtual content with a hand gesture.

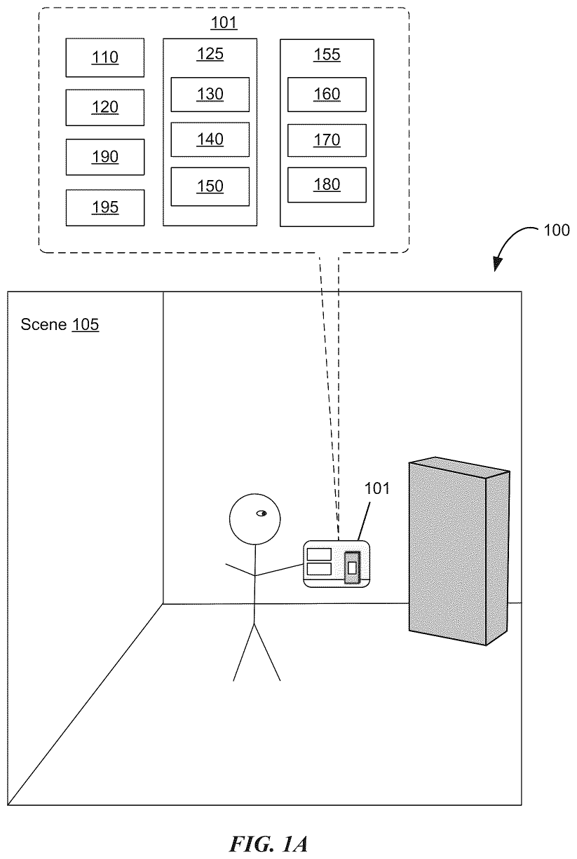

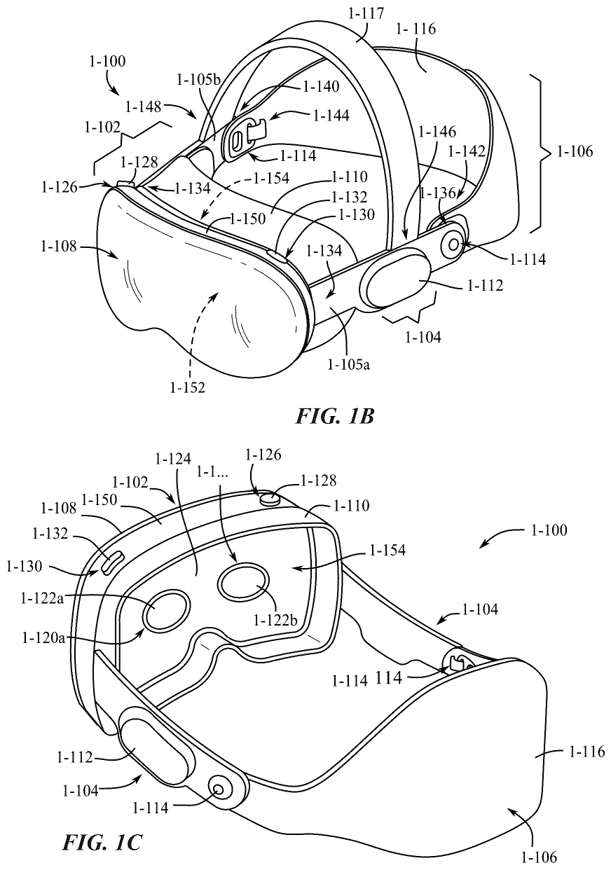

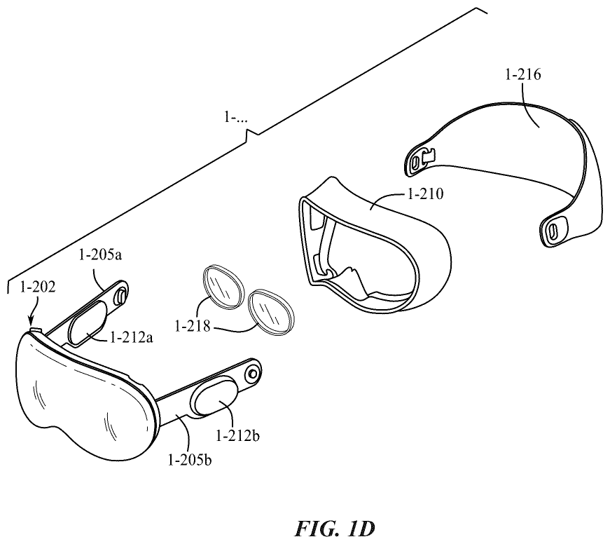

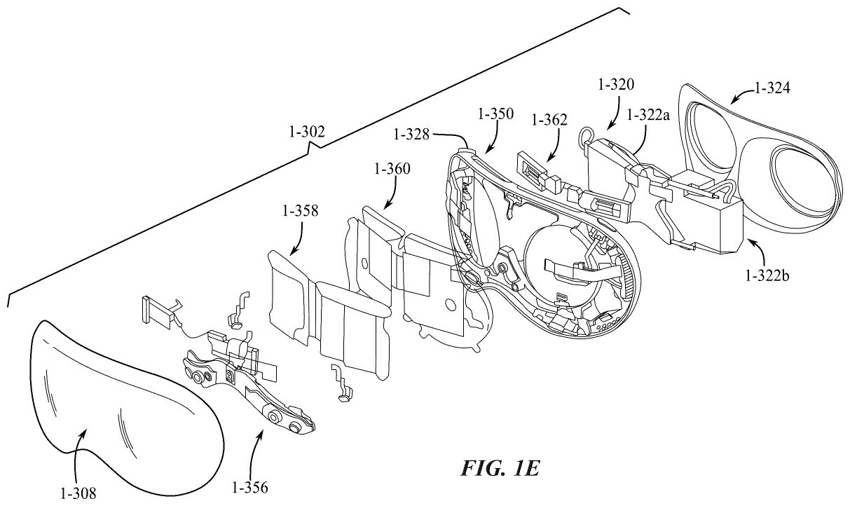

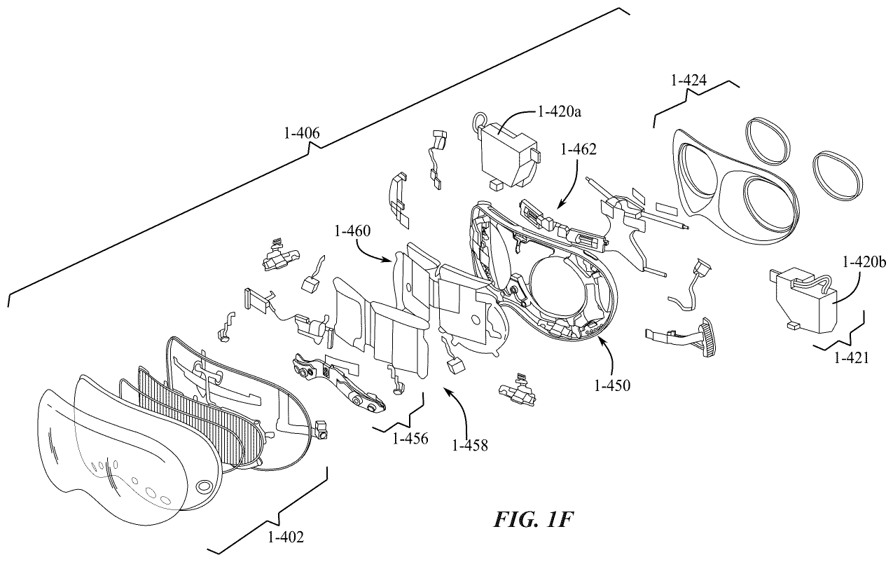

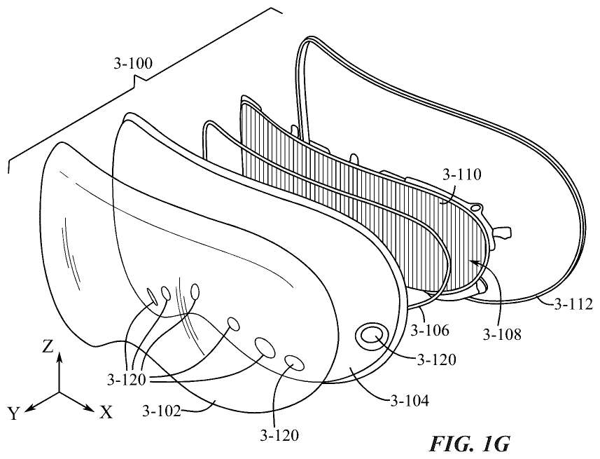

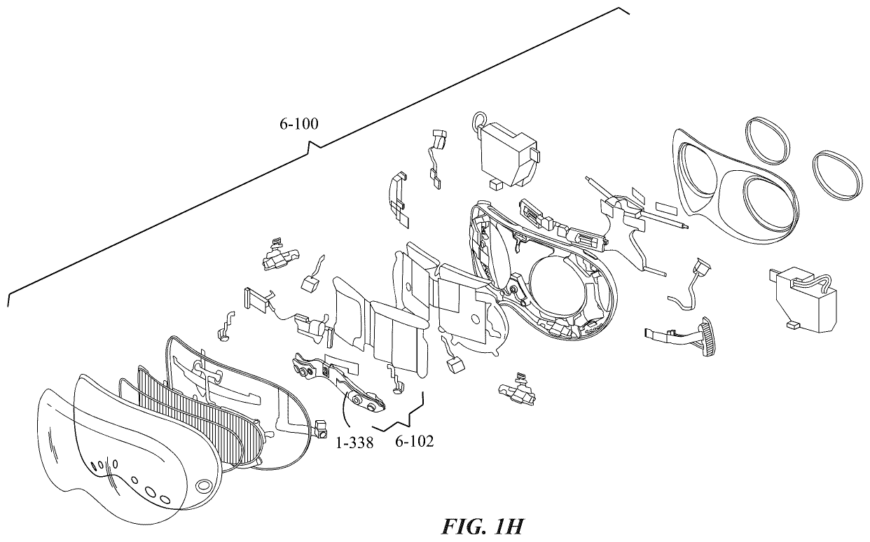

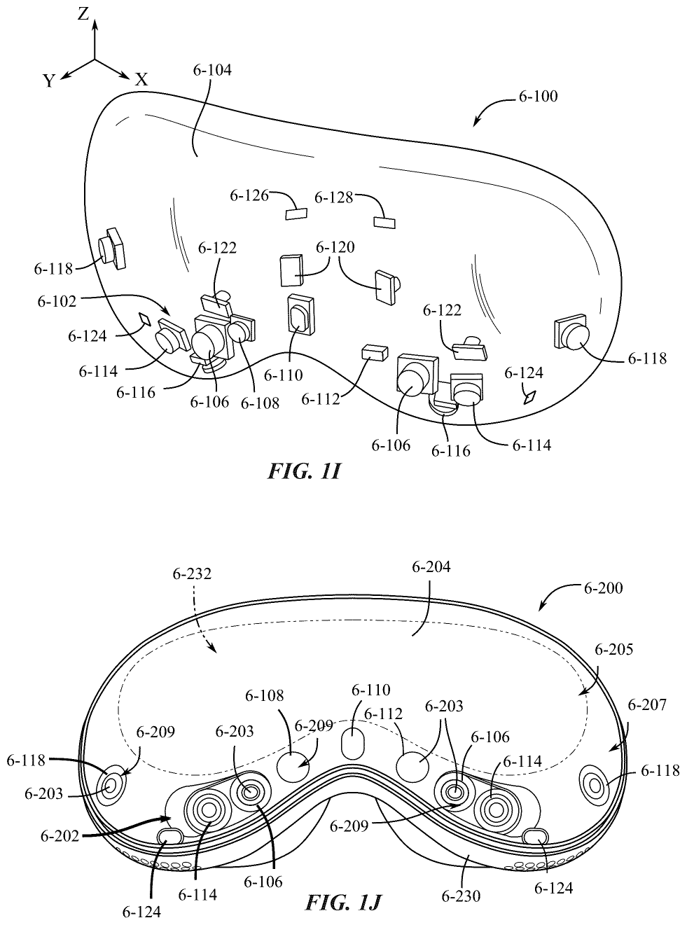

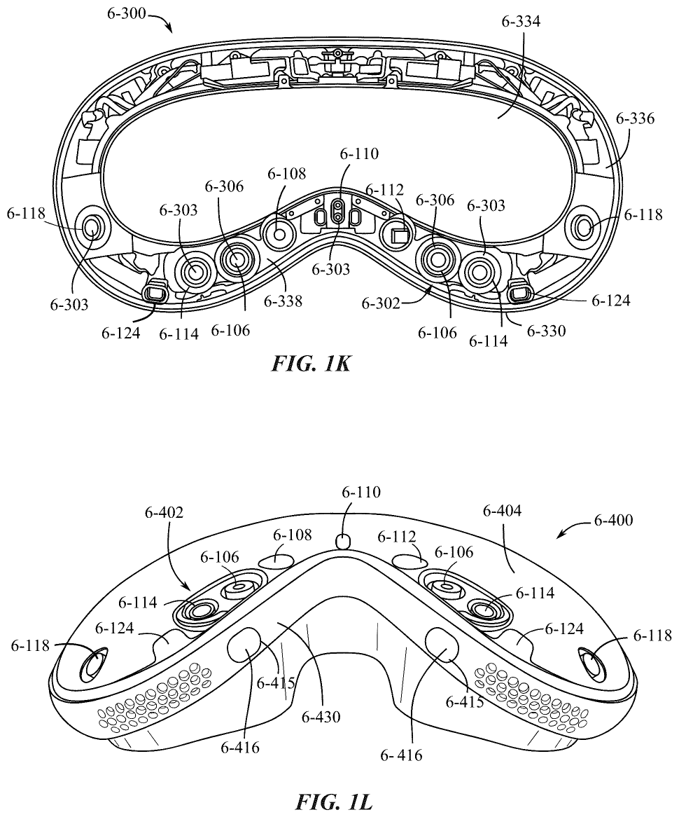

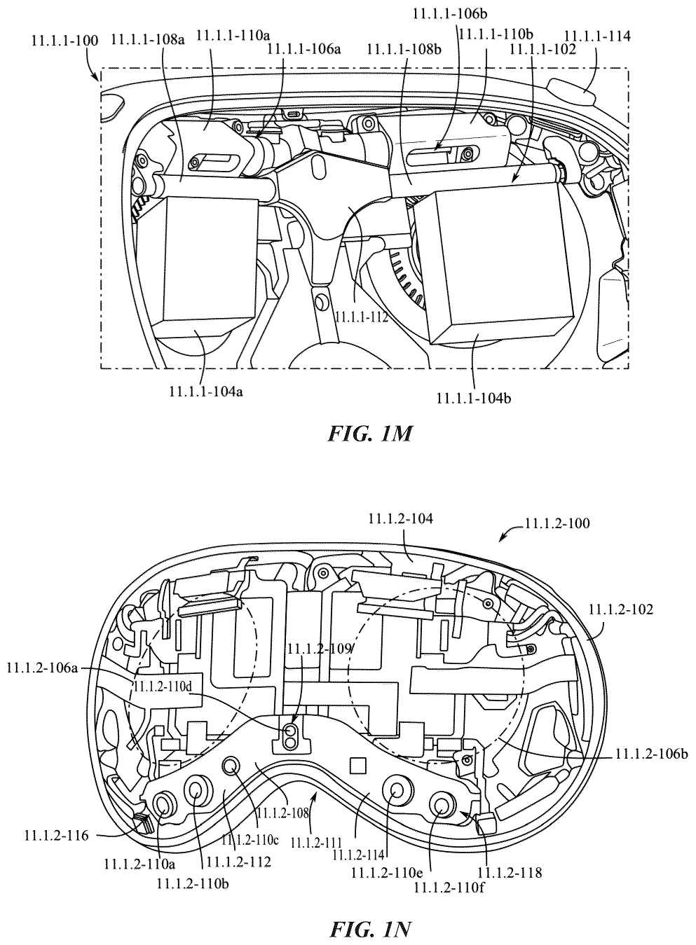

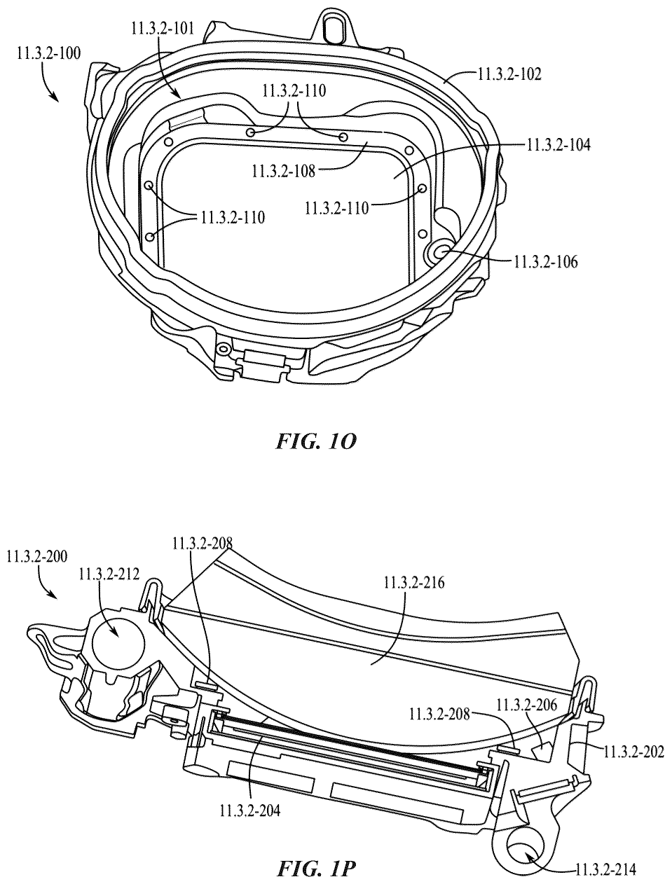

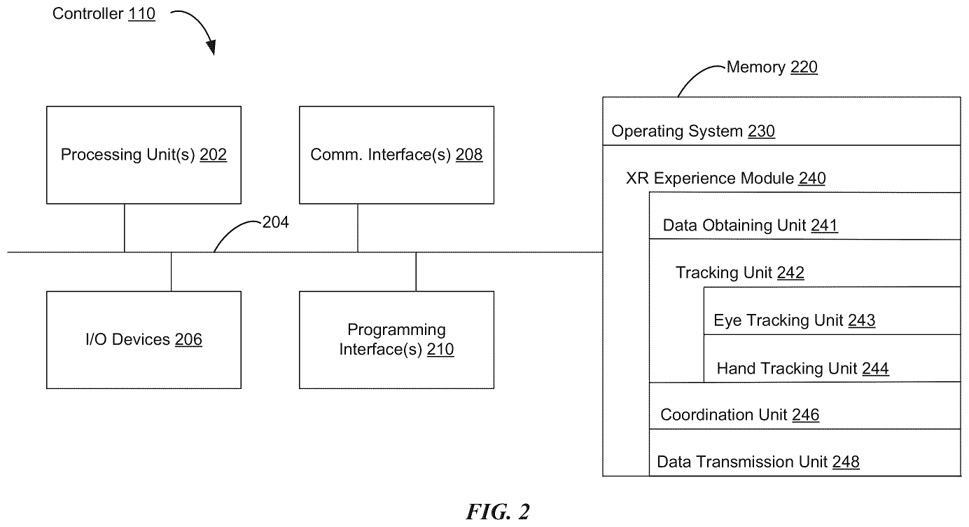

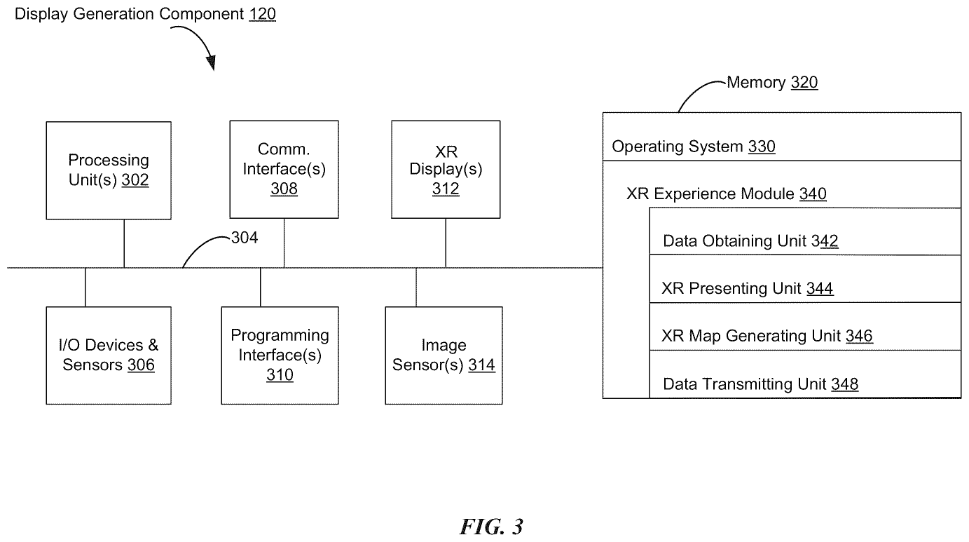

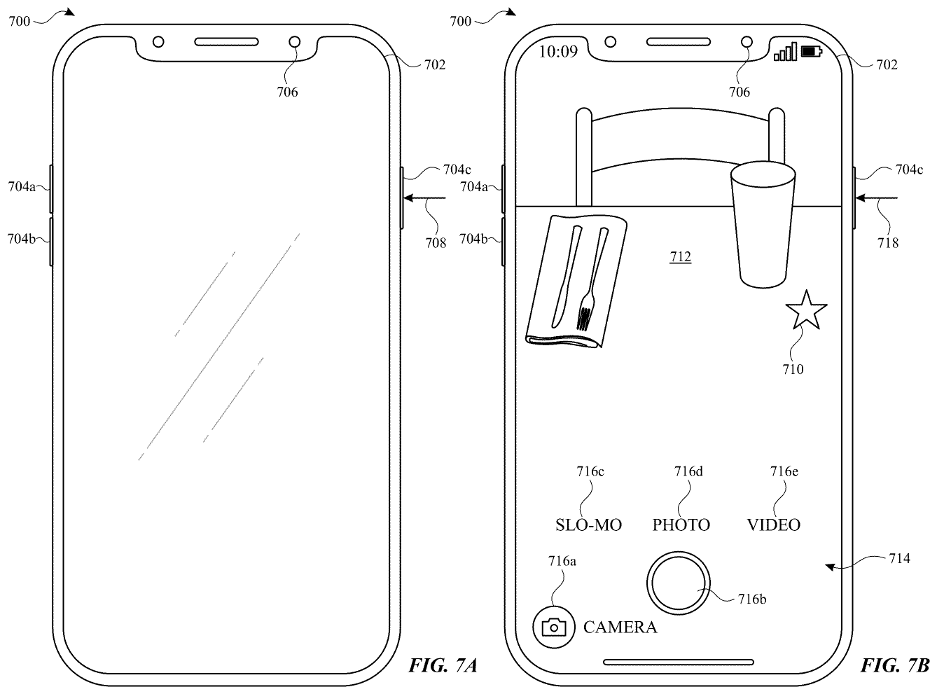

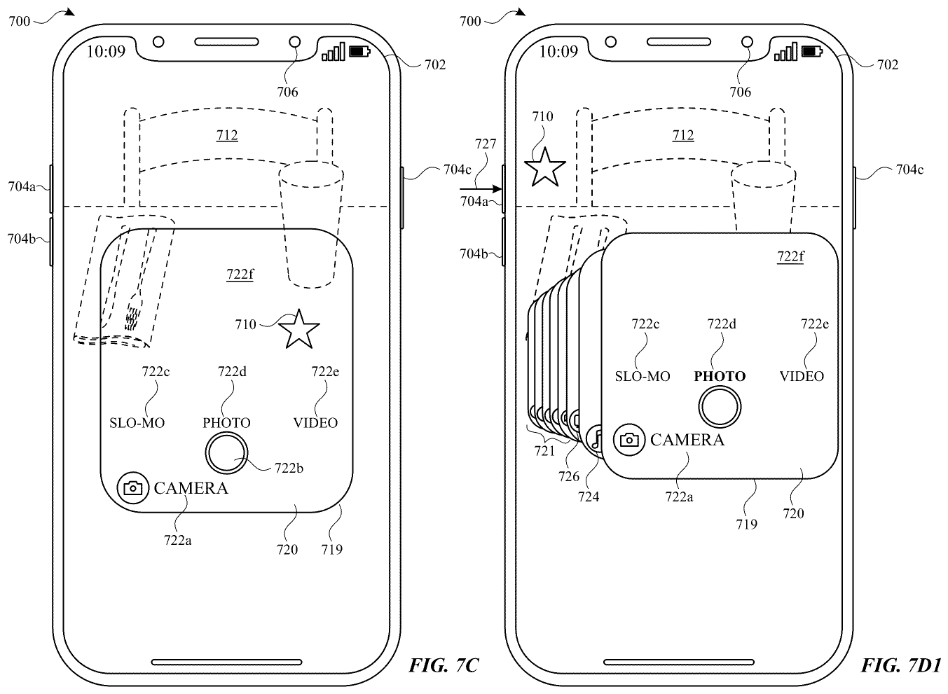

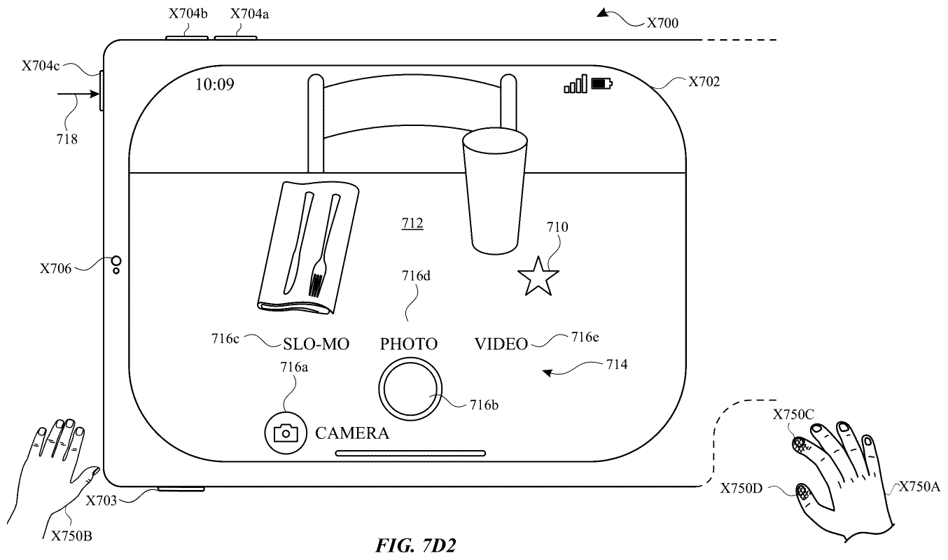

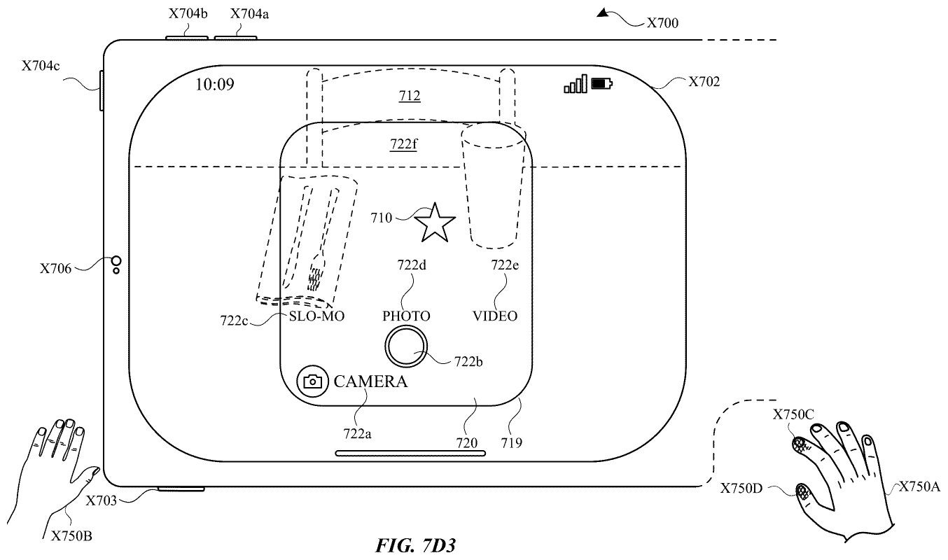

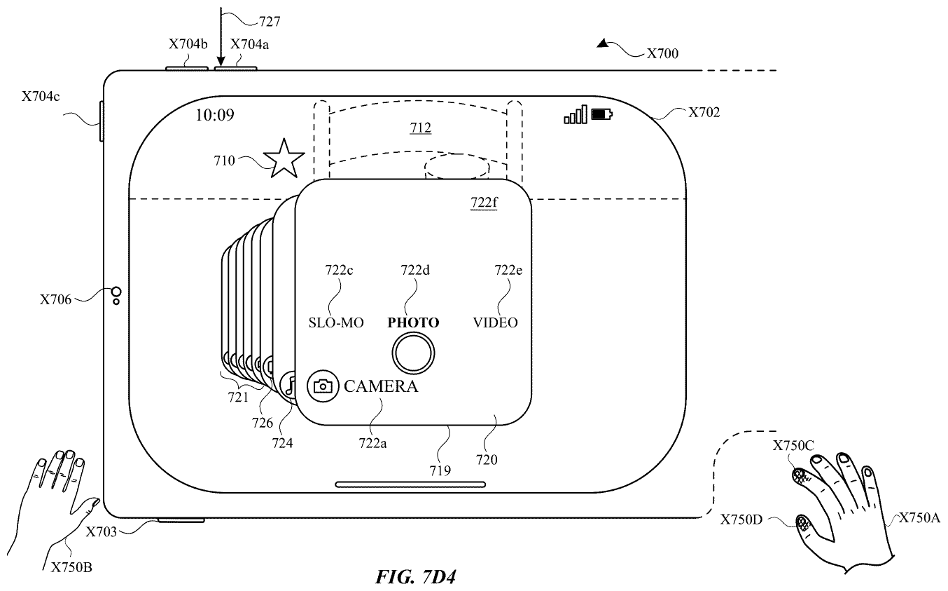

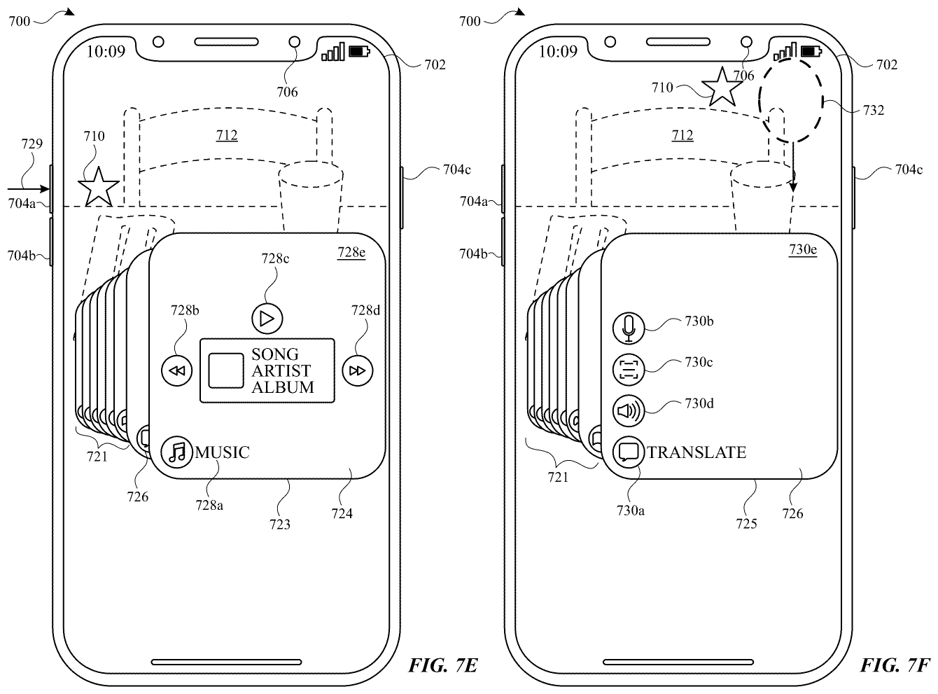

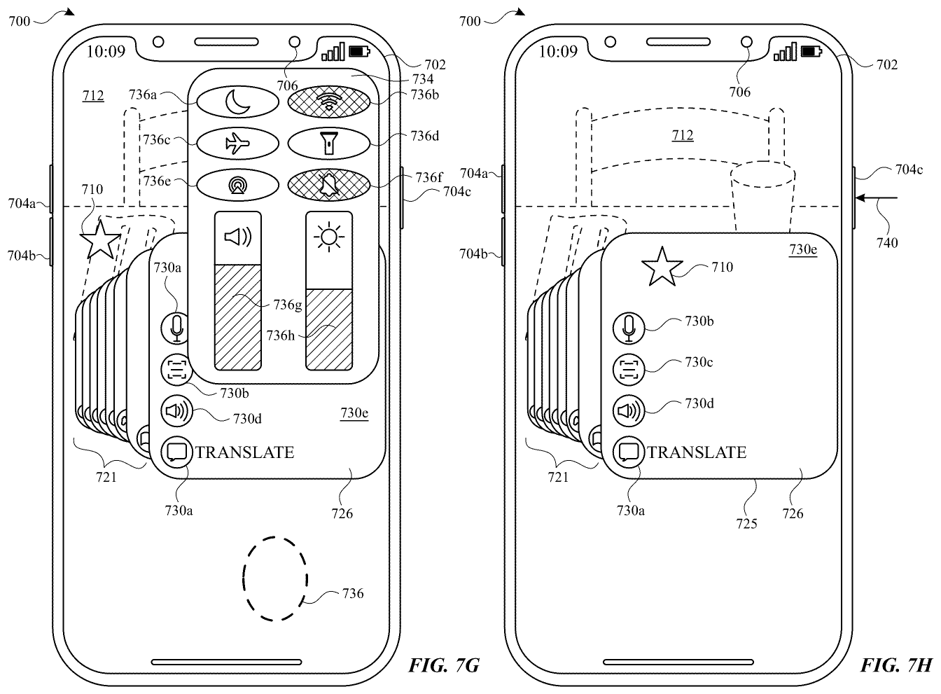

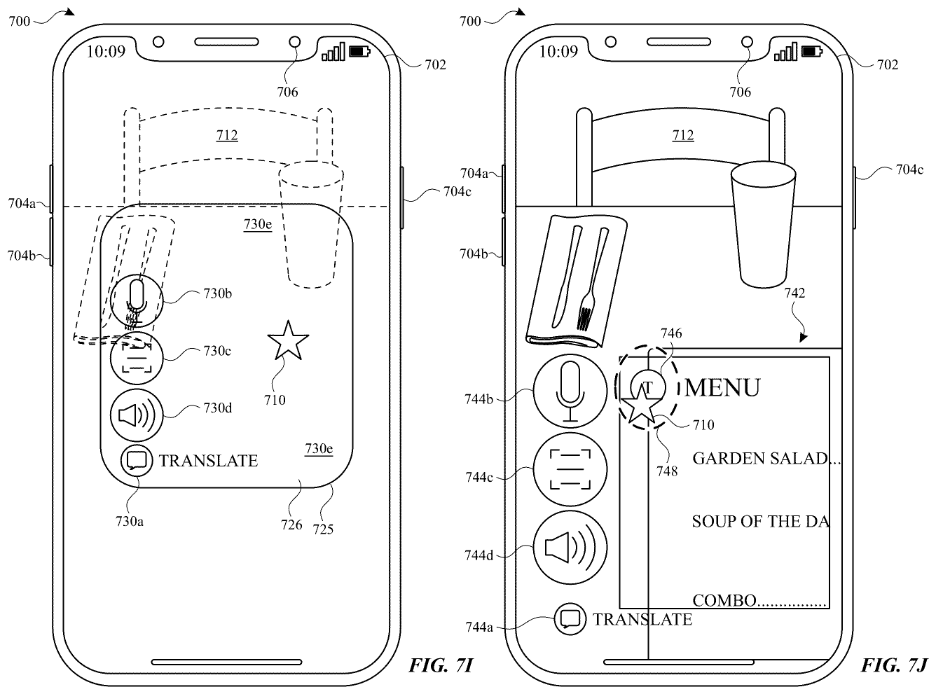

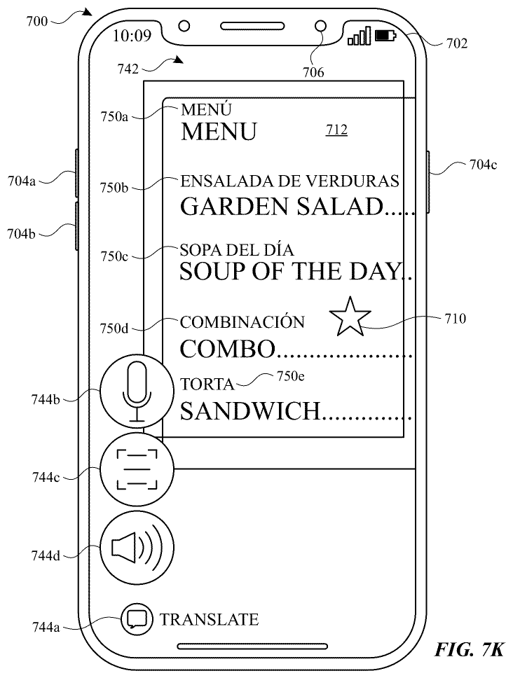

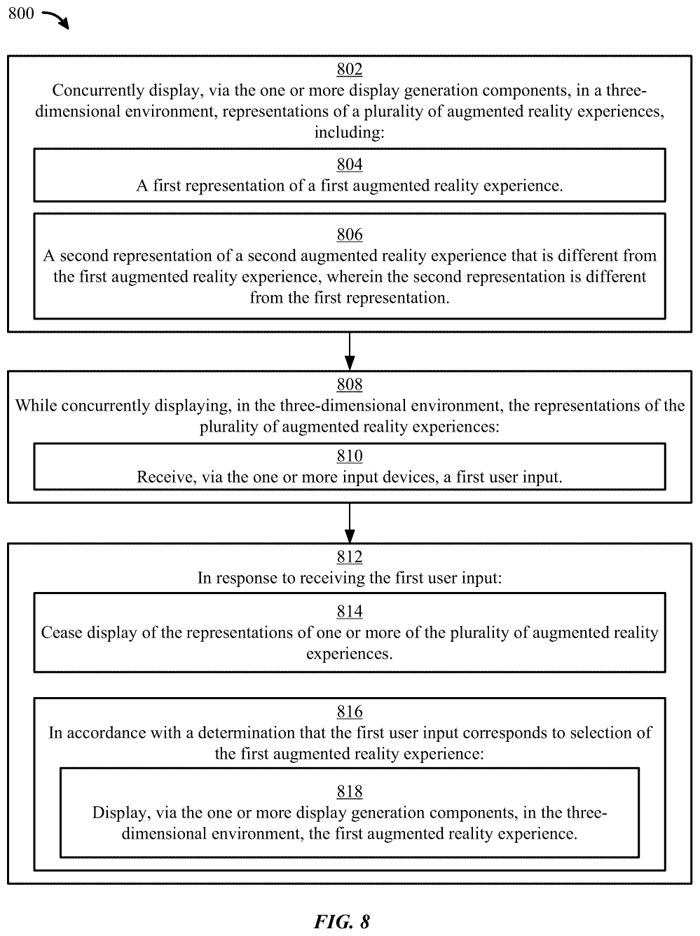

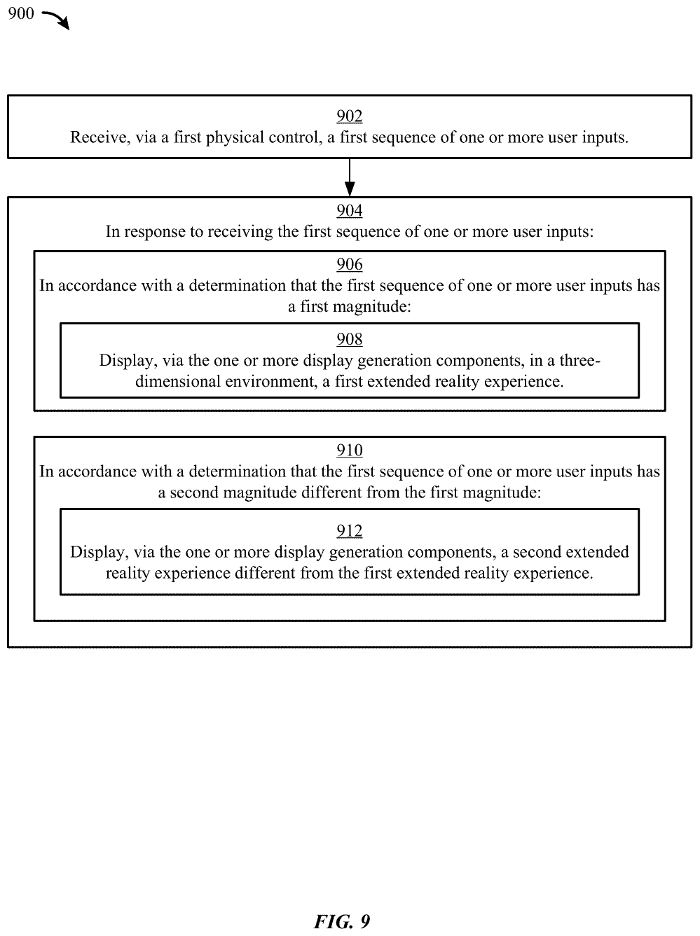

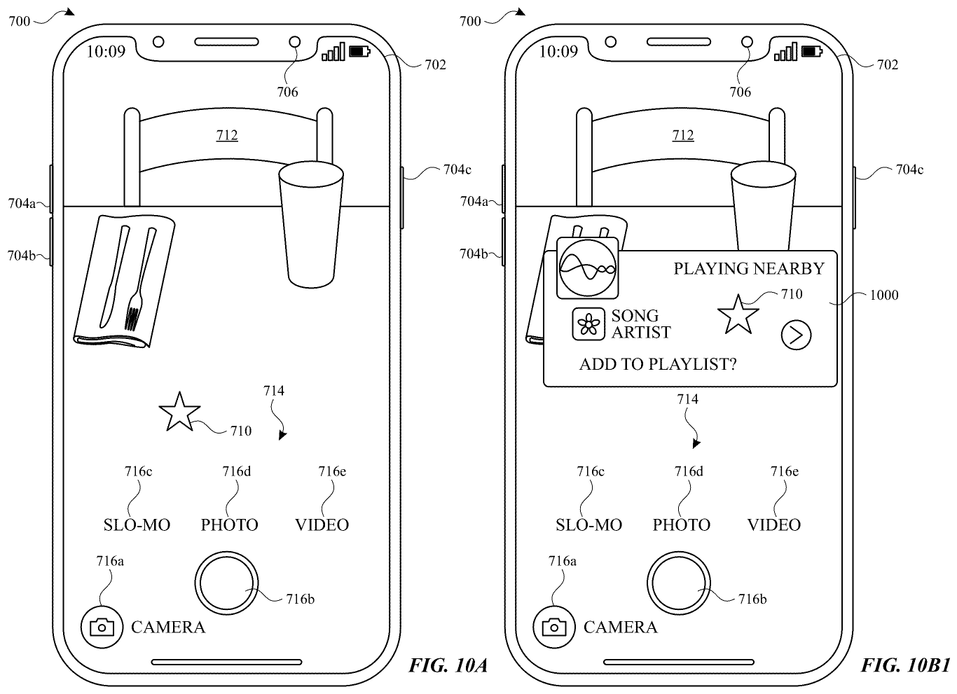

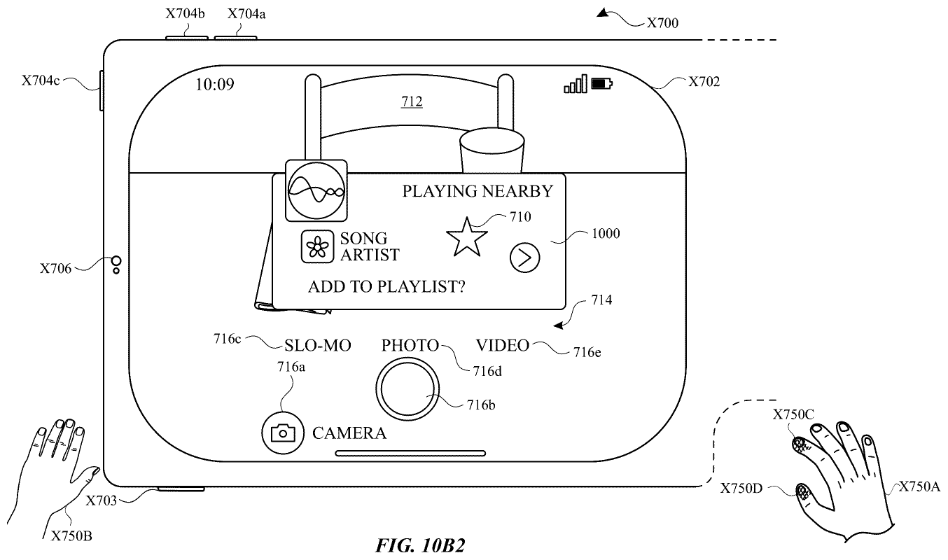

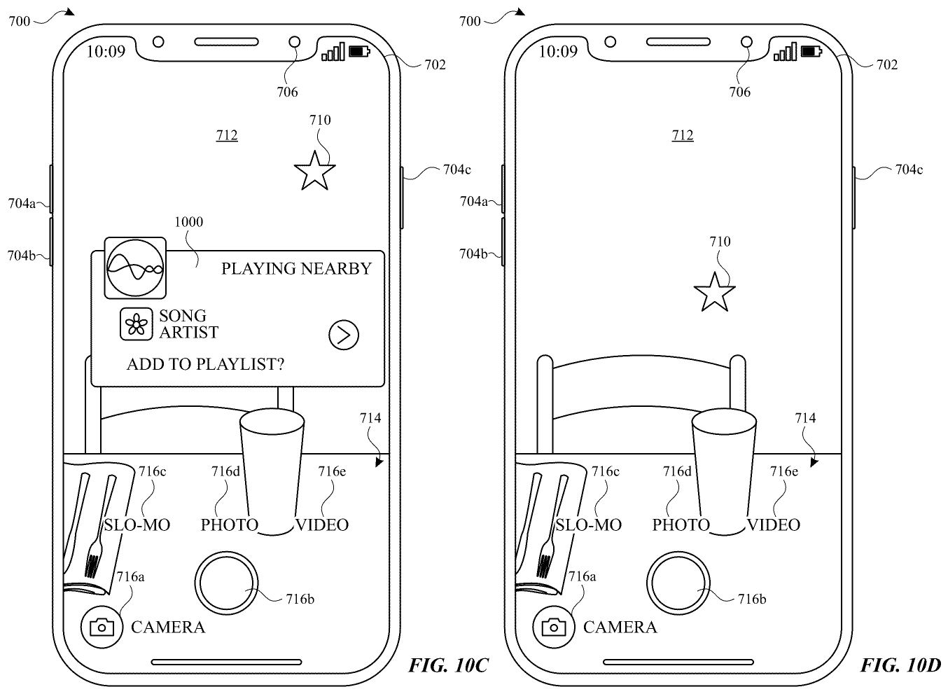

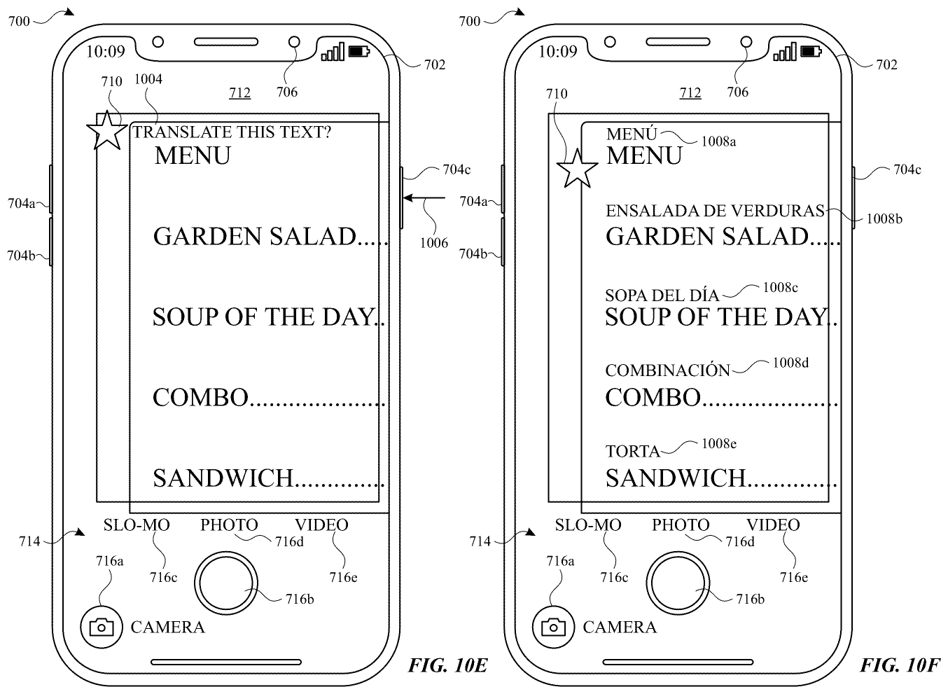

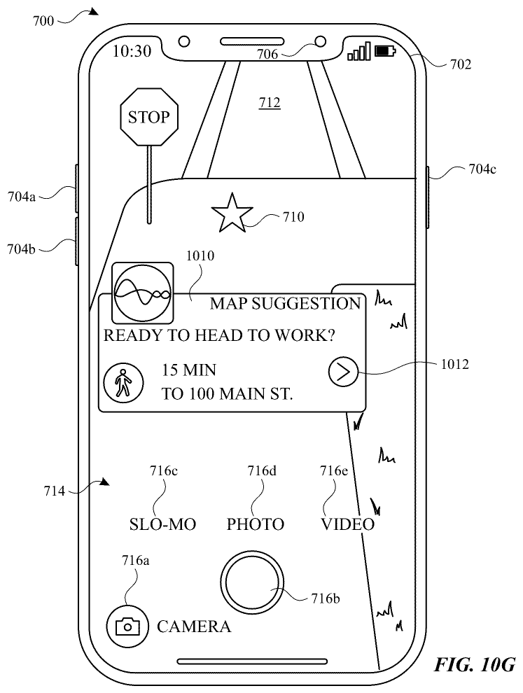

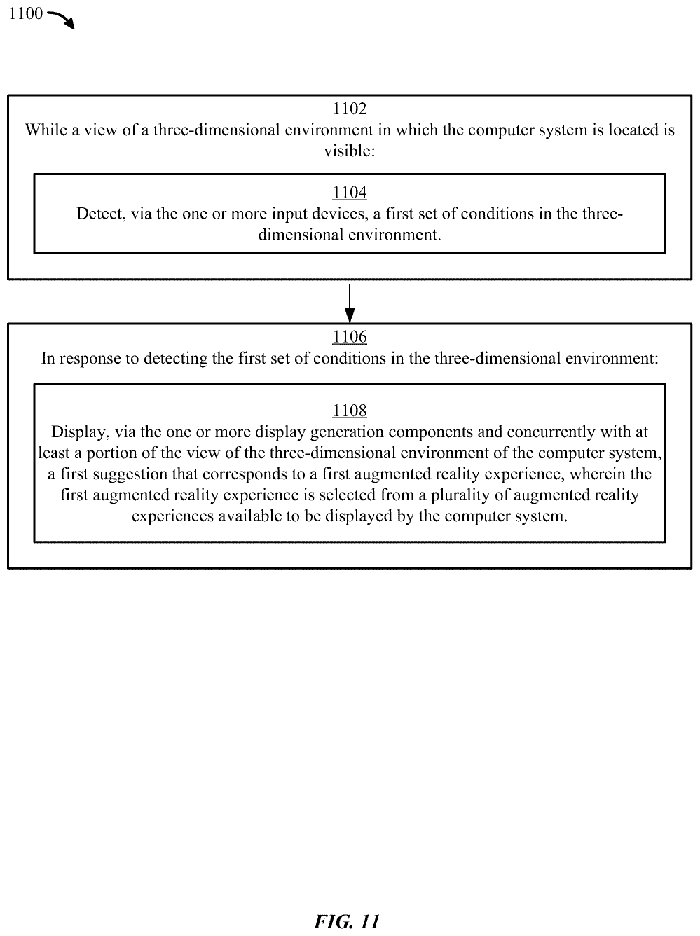

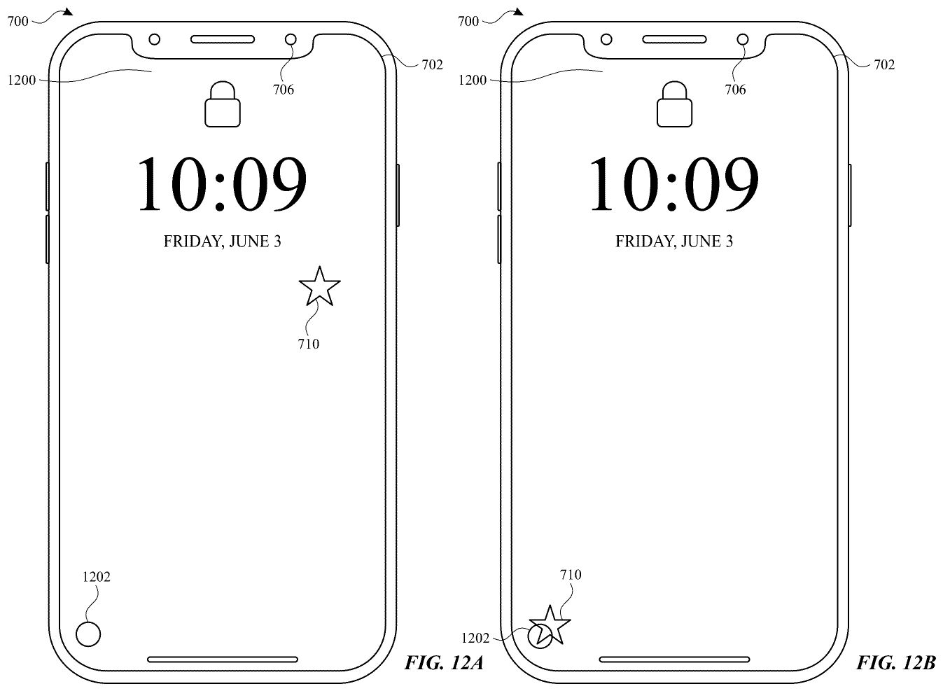

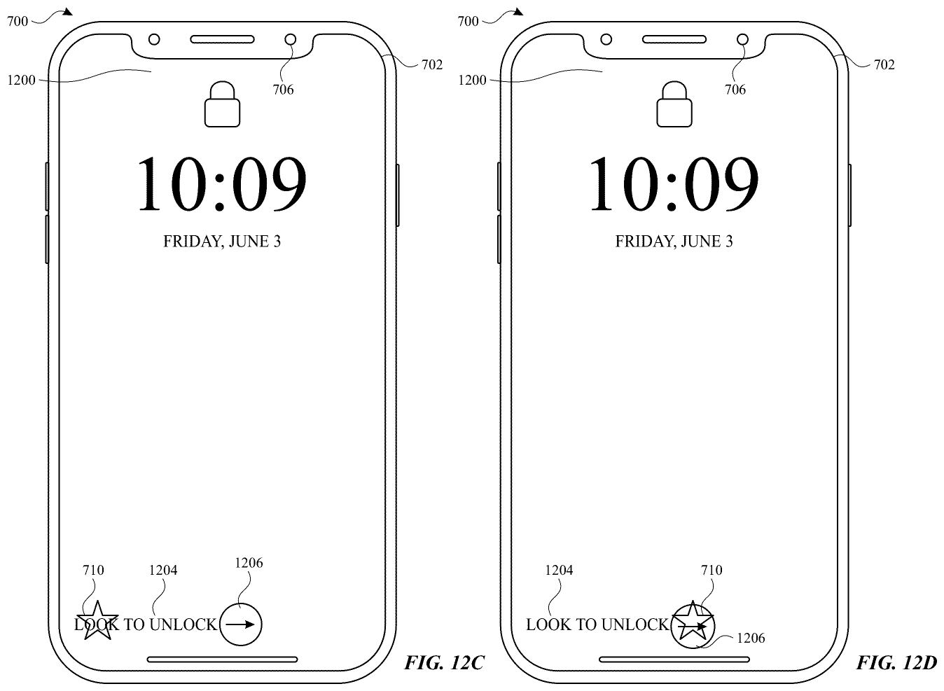

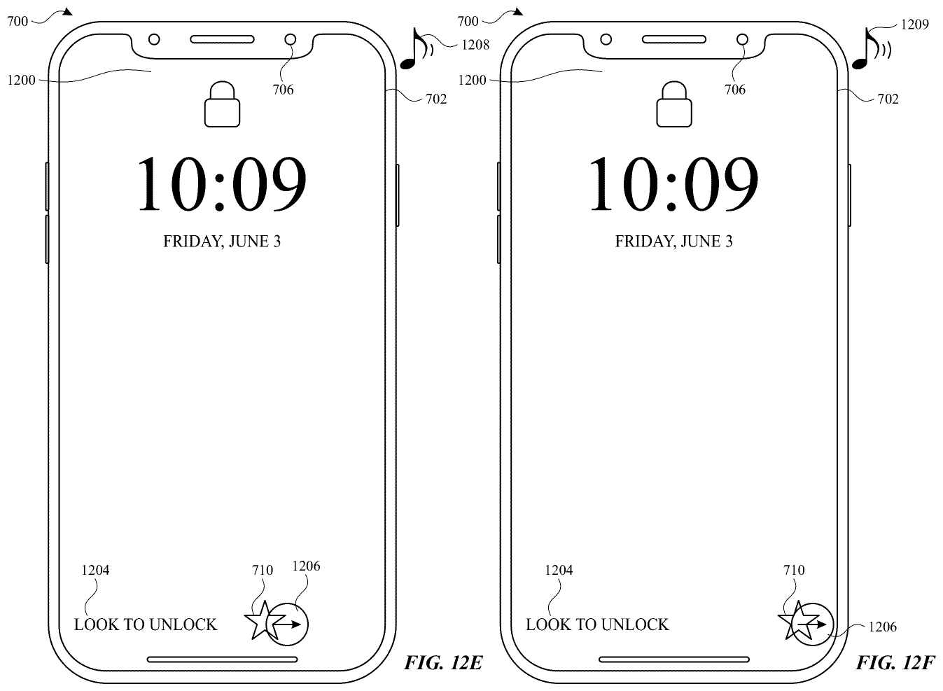

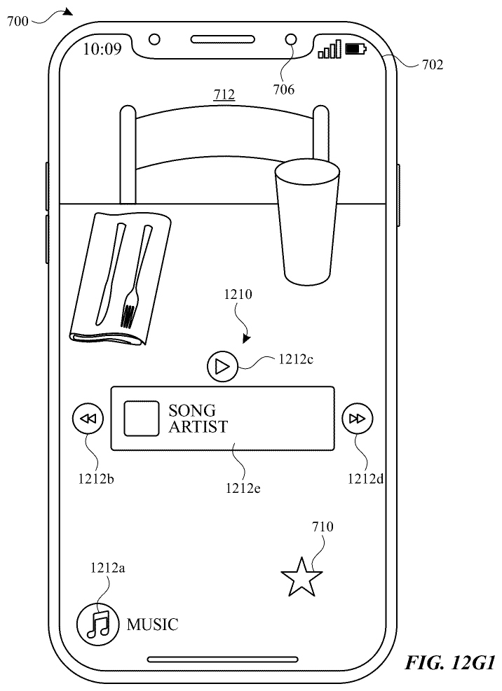

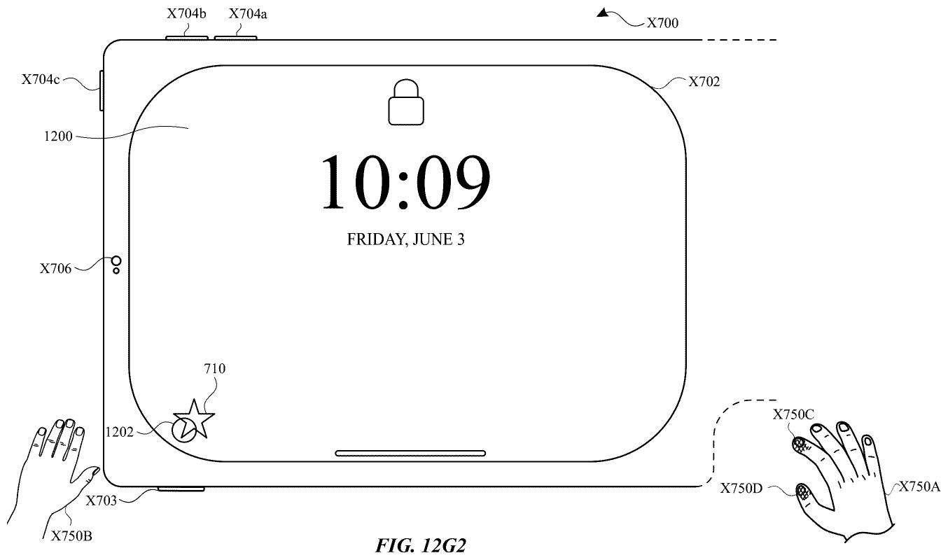

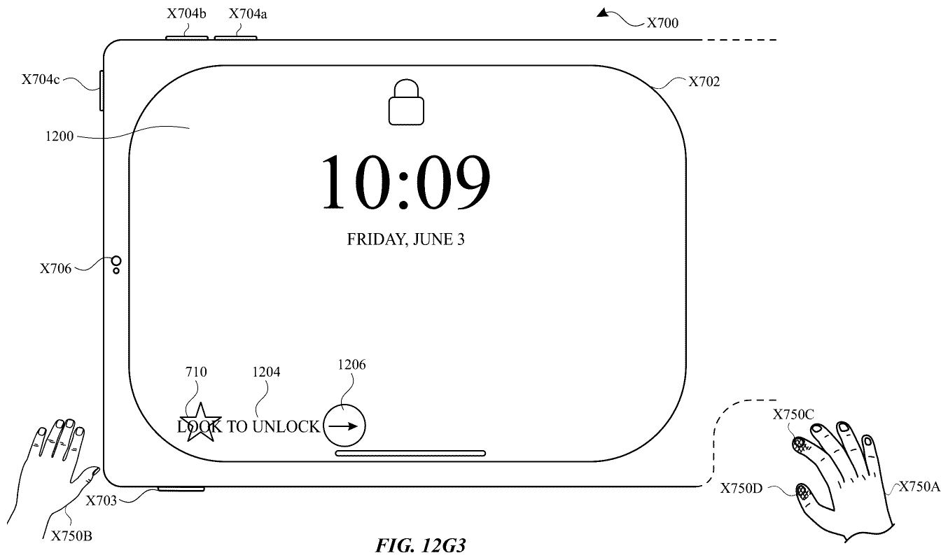

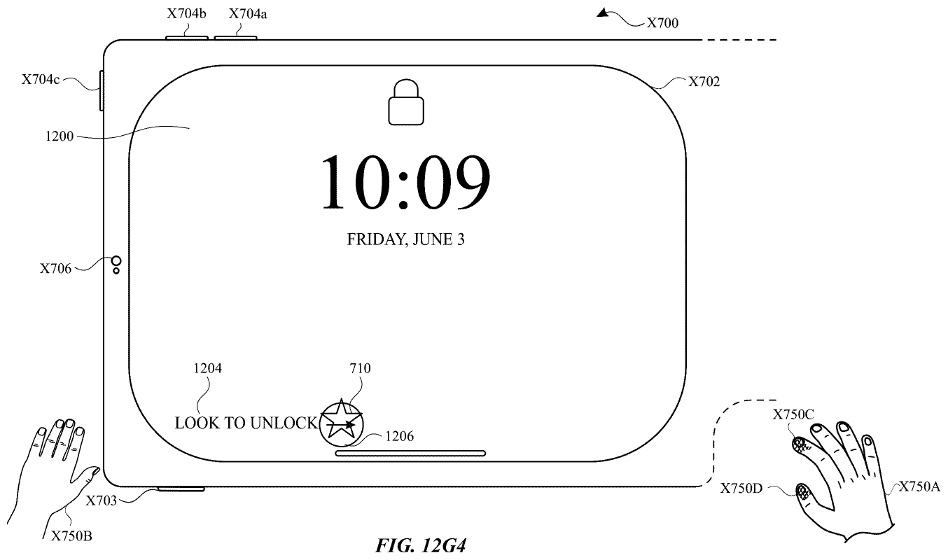

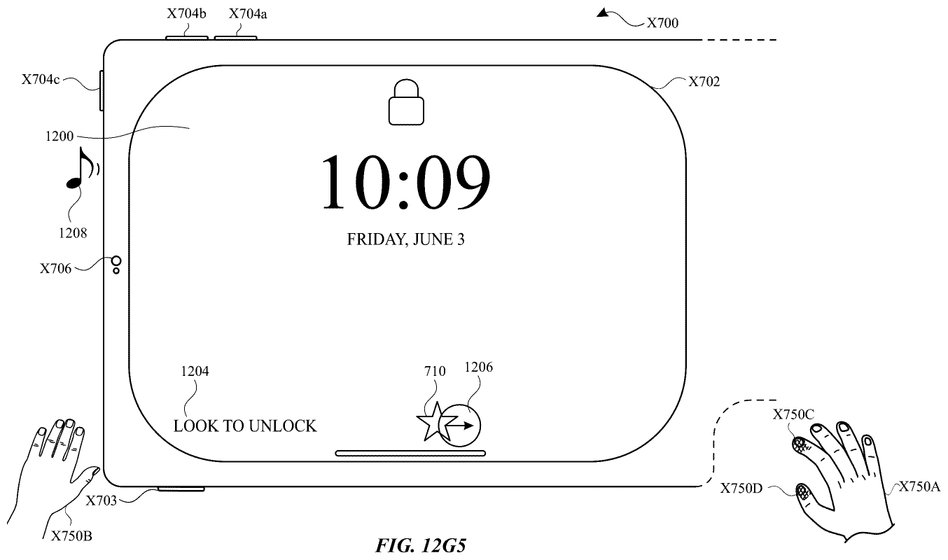

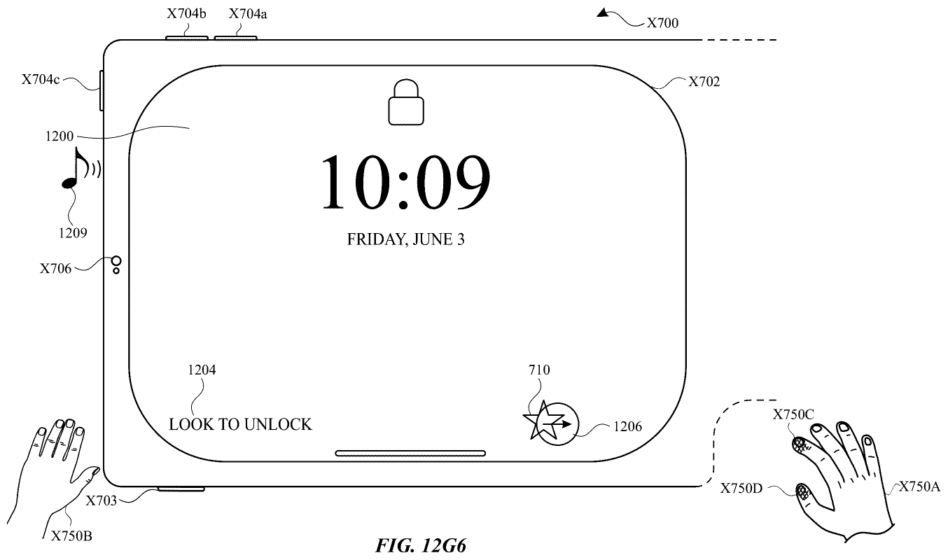

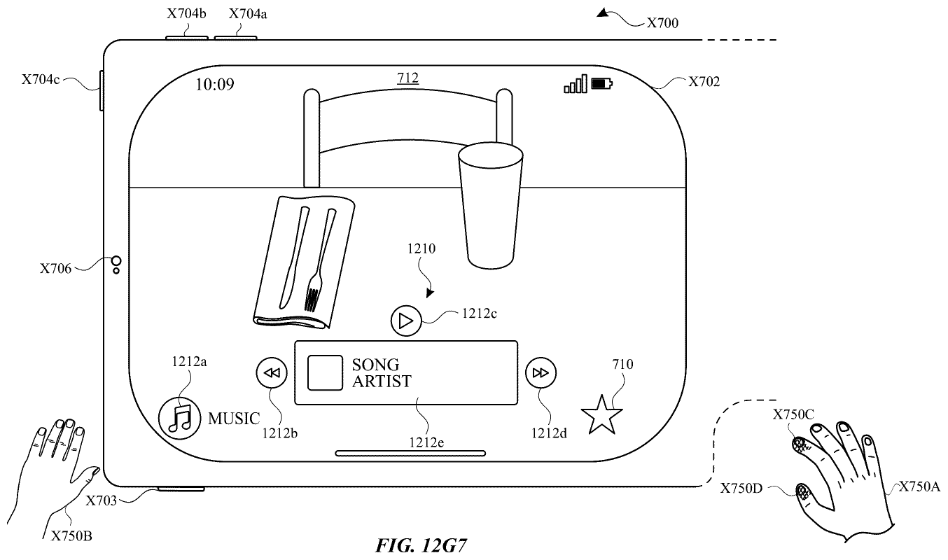

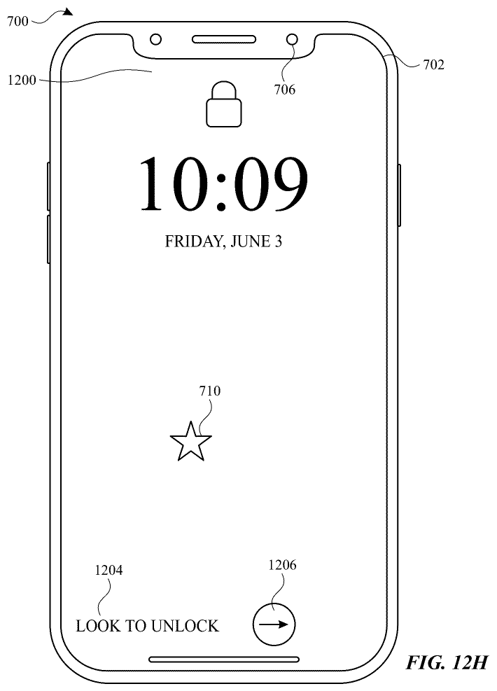

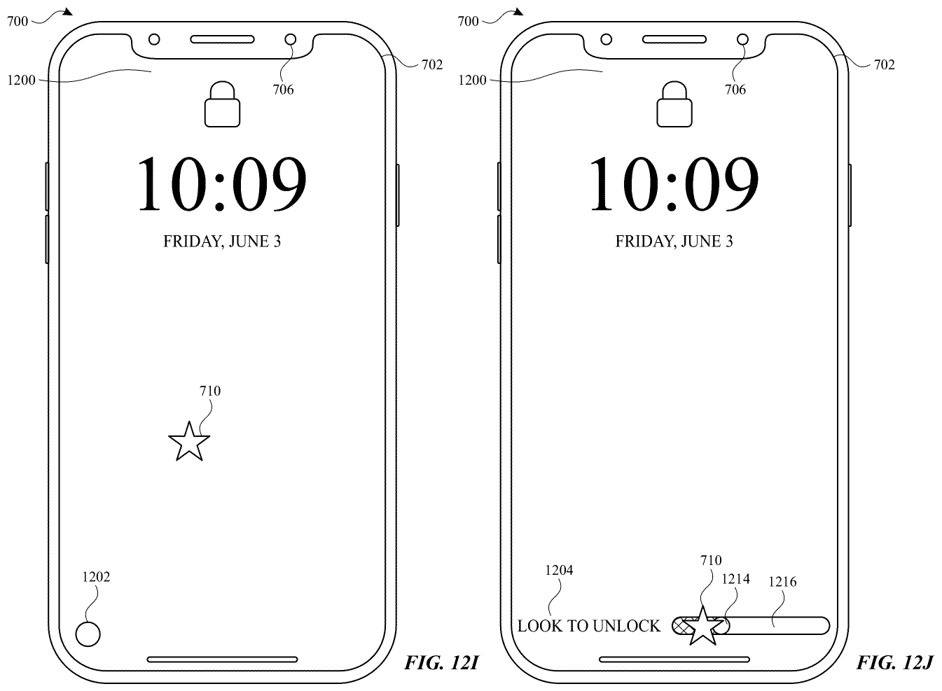

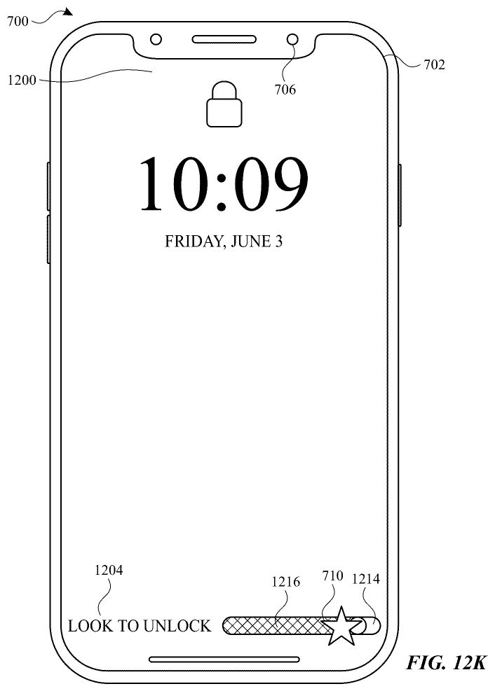

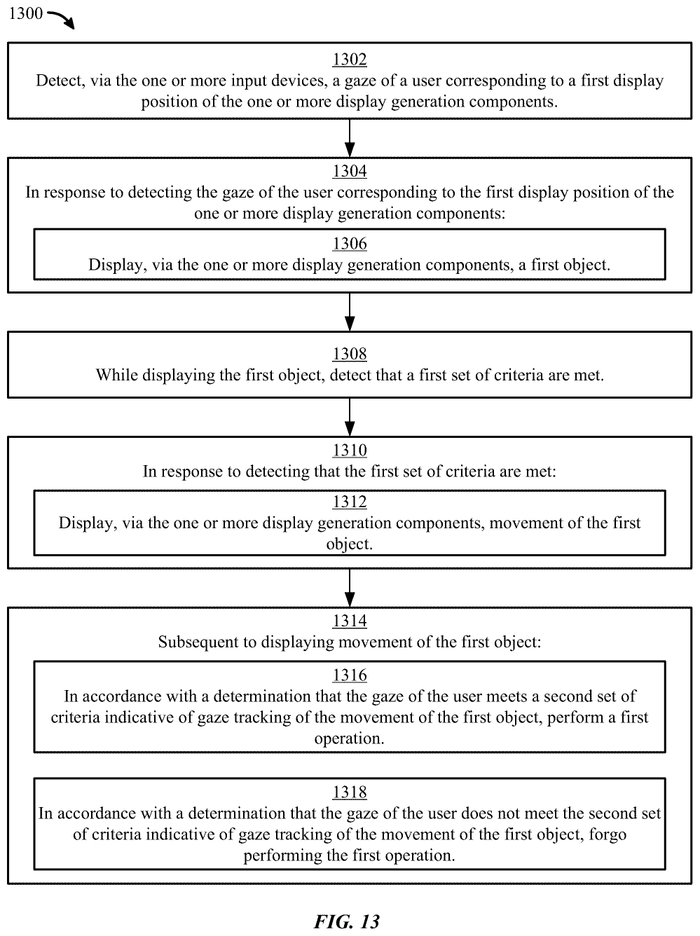

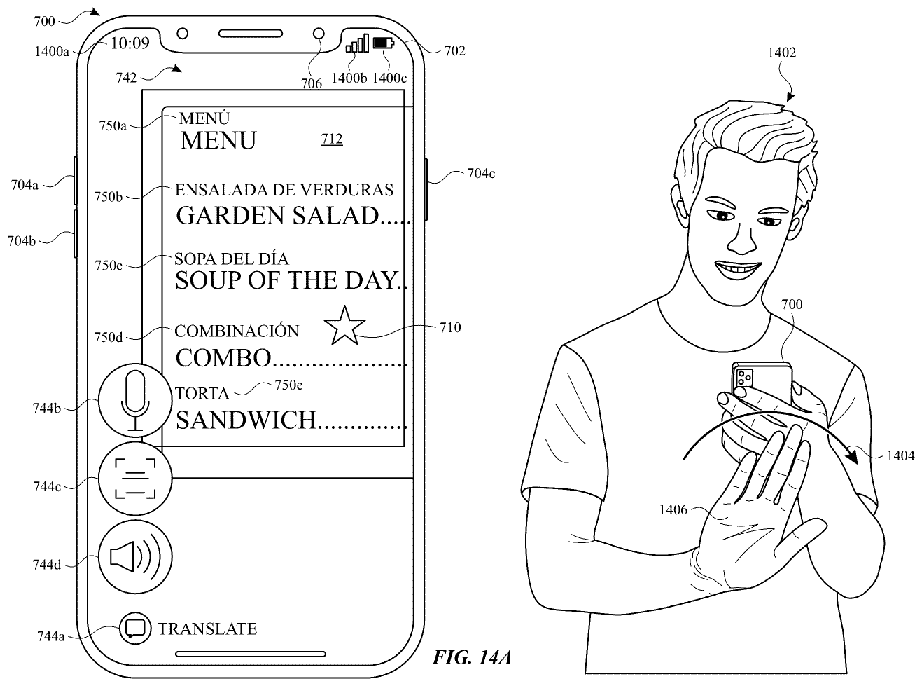

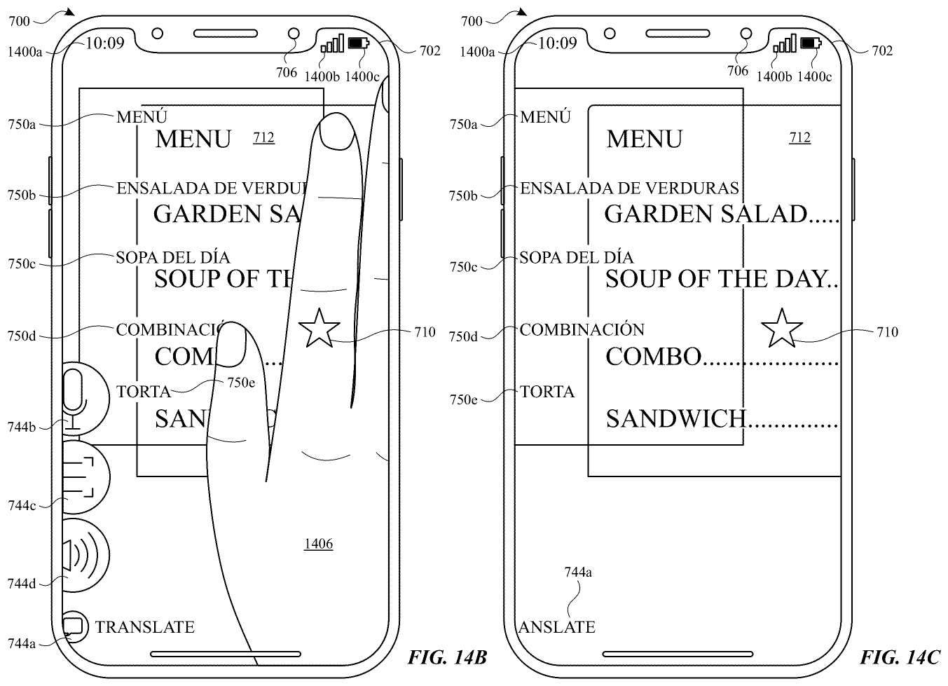

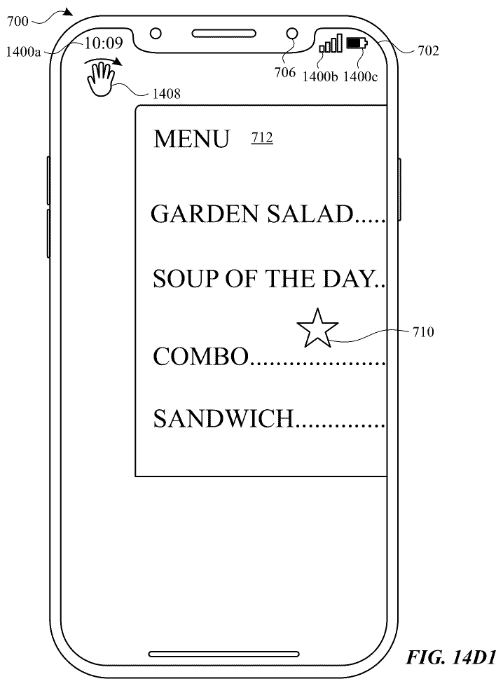

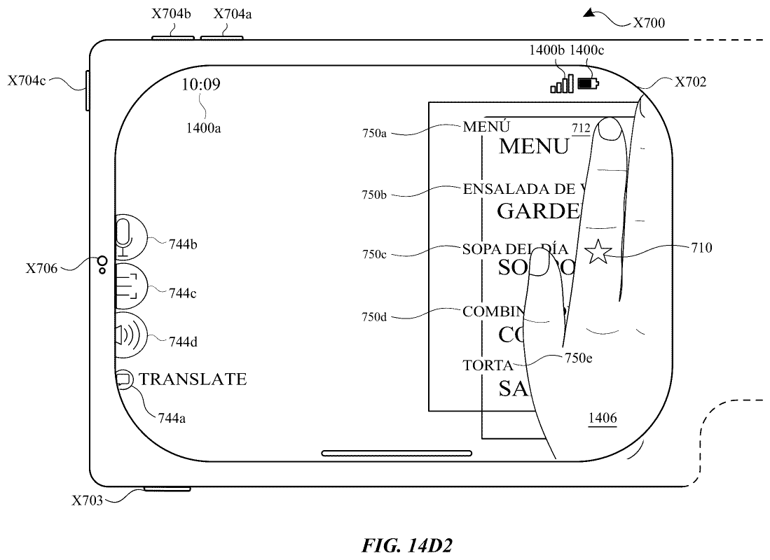

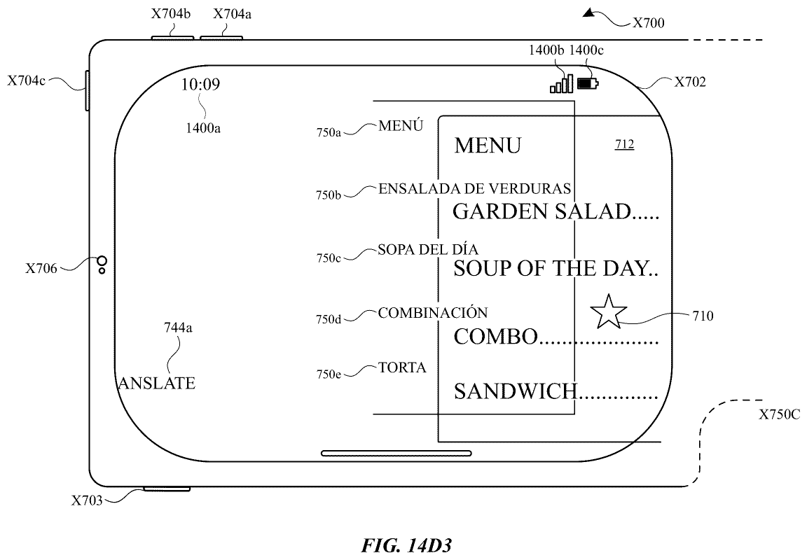

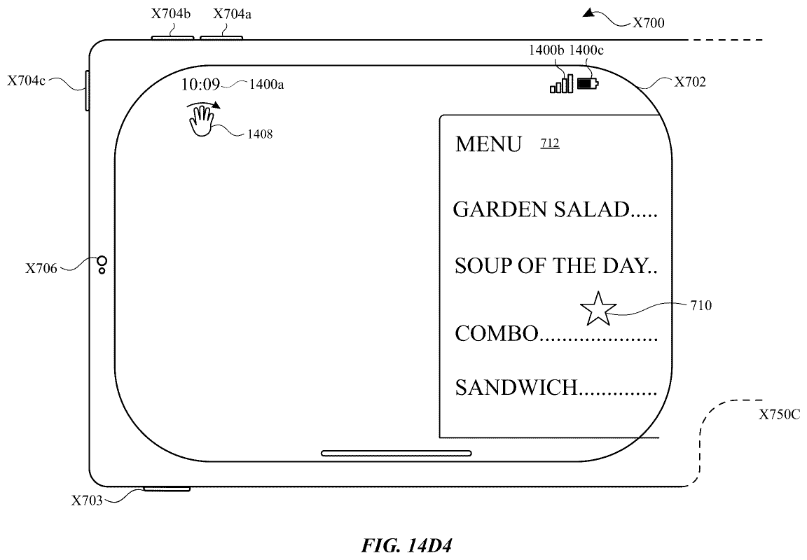

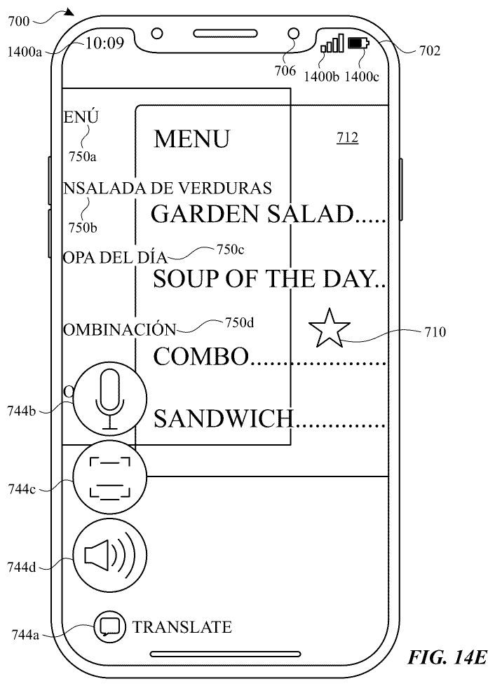

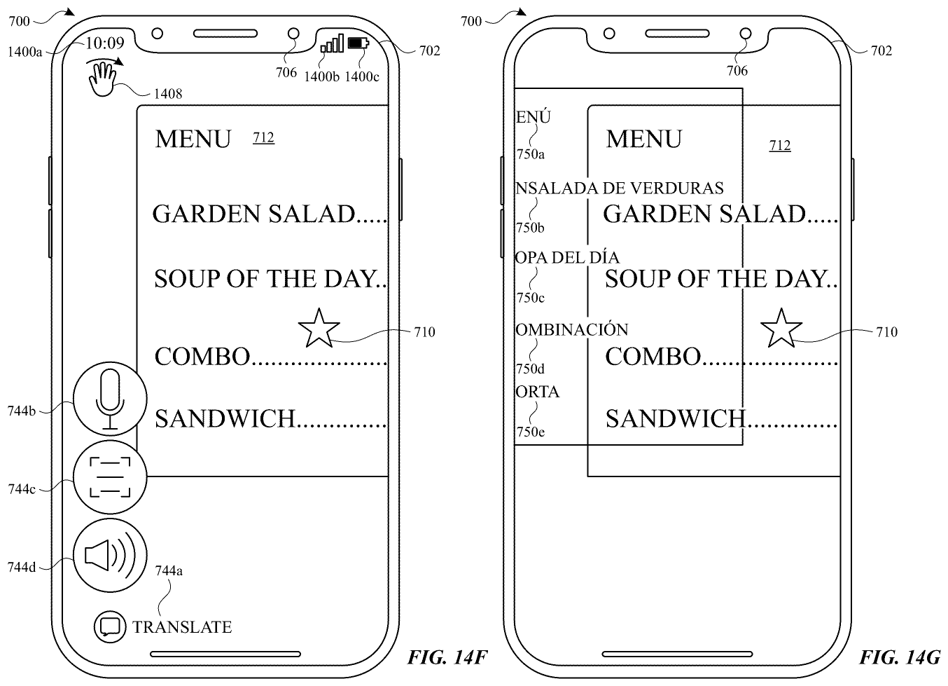

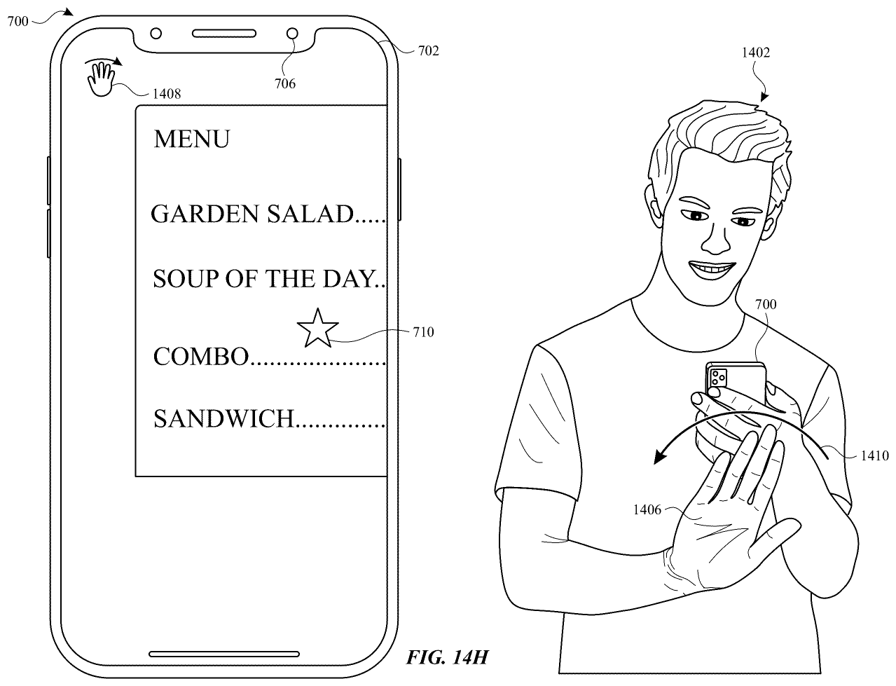

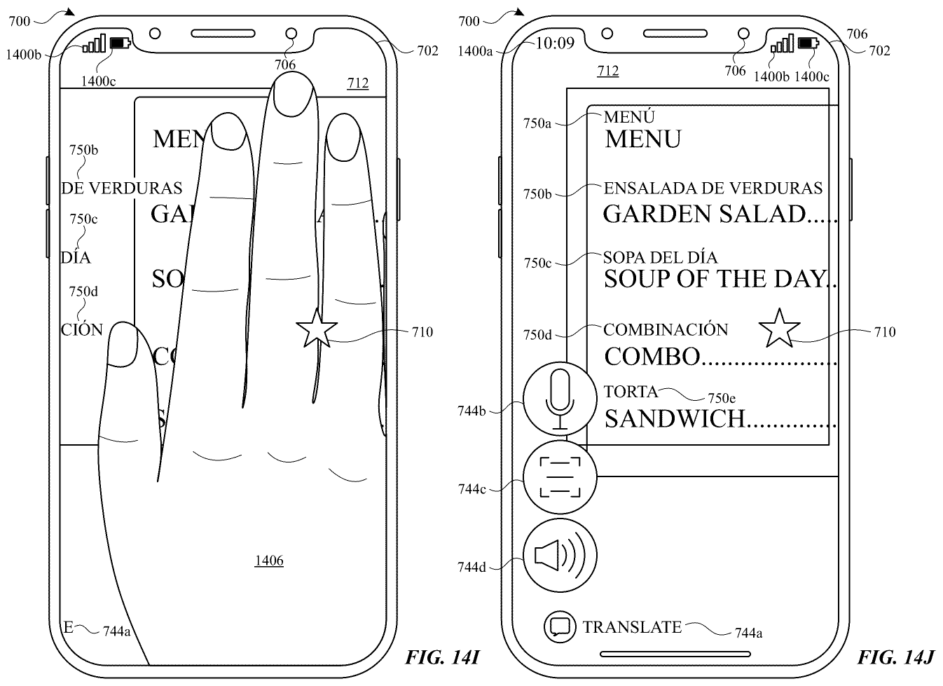

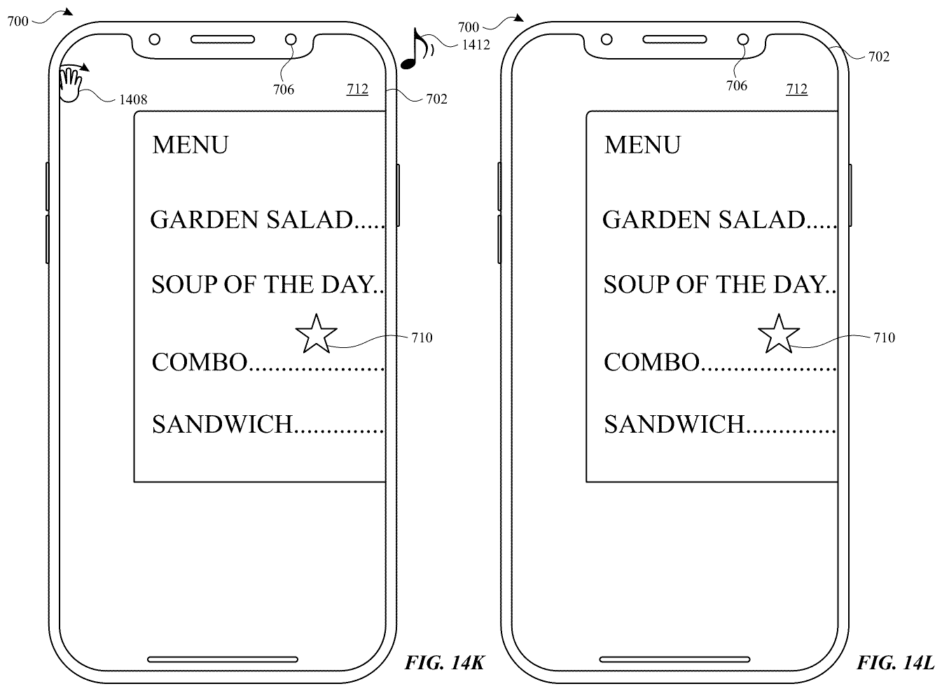

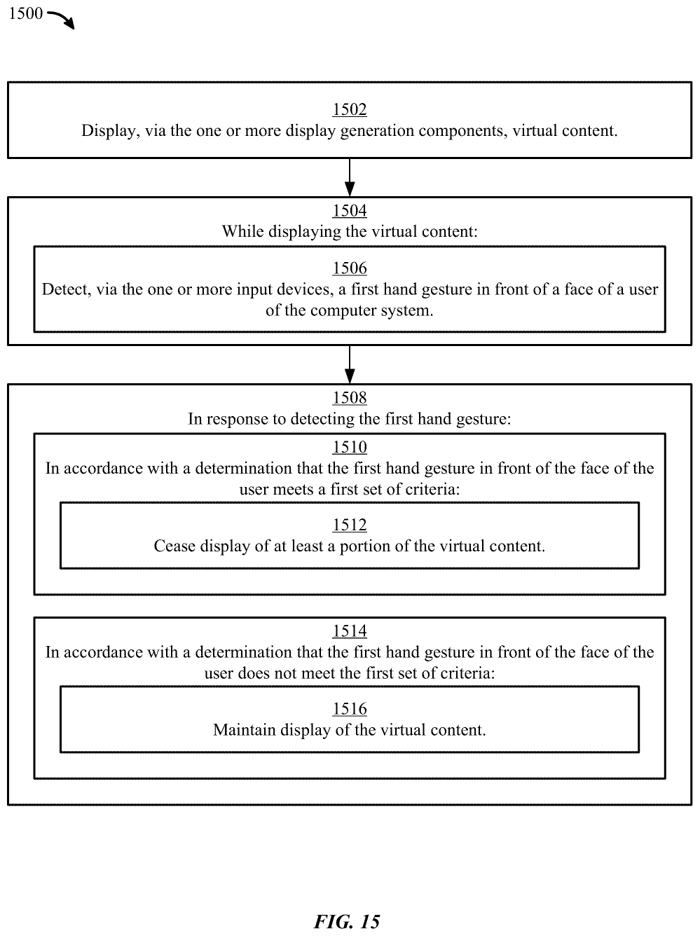

FIGS. 1A-6 provide a description of example computer systems for providing XR experiences to users. FIGS. 7A-7K illustrate example techniques for navigating extended reality experiences, in accordance with some embodiments. FIG. 8 is a flow diagram of methods of navigating extended reality experiences, in accordance with various embodiments. FIG. 9 is a flow diagram of methods of navigating extended reality experiences, in accordance with some embodiments. The user interfaces in FIGS. 7A-7K are used to illustrate the processes in FIG. 8 and FIG. 9. FIGS. 10A-10G illustrate example techniques for providing suggestions pertaining to extended reality experiences, in accordance with some embodiments. FIG. 11 is a flow diagram of methods of providing suggestions pertaining to extended reality experiences, in accordance with various embodiments. The user interfaces in FIGS. 10A-10G are used to illustrate the processes in FIG. 11. FIGS. 12A-12K illustrate example techniques for gaze-based interactions, in accordance with some embodiments. FIG. 13 is a flow diagram of methods of gaze-based interactions, in accordance with various embodiments. The user interfaces in FIGS. 12A-12K are used to illustrate the processes in FIG. 13. FIGS. 14A-14L illustrate example techniques for interacting with virtual content, in accordance with some embodiments. FIG. 15 is a flow diagram of methods of interacting with virtual content, in accordance with various embodiments. The user interfaces in FIGS. 14A-14L are used to illustrate the processes in FIG. 15.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing a XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality. Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100.

The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 11 illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 11. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 11 can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 11.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 11, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

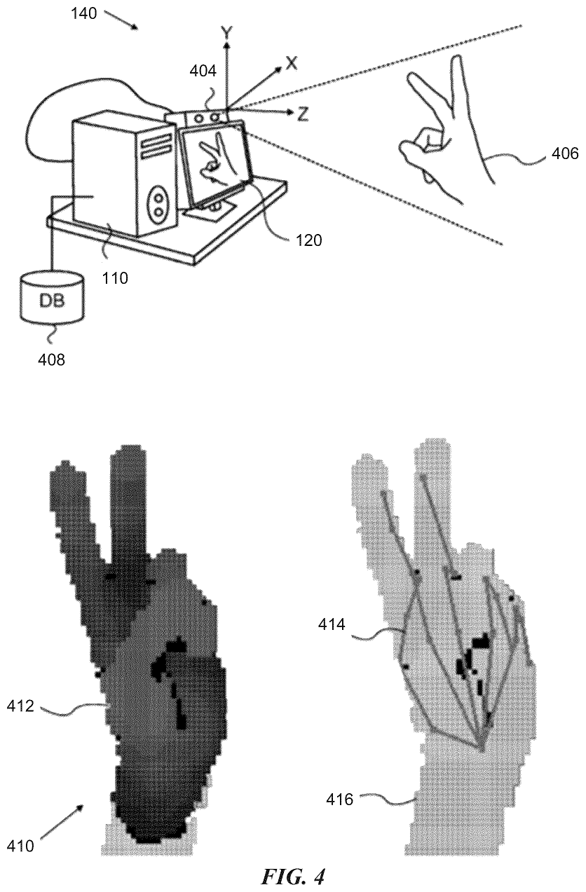

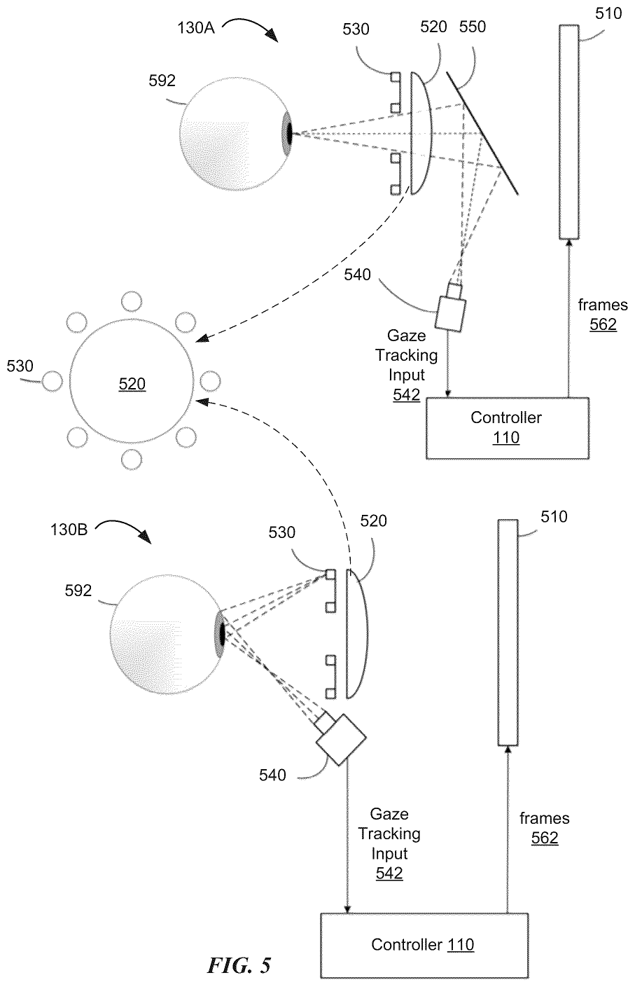

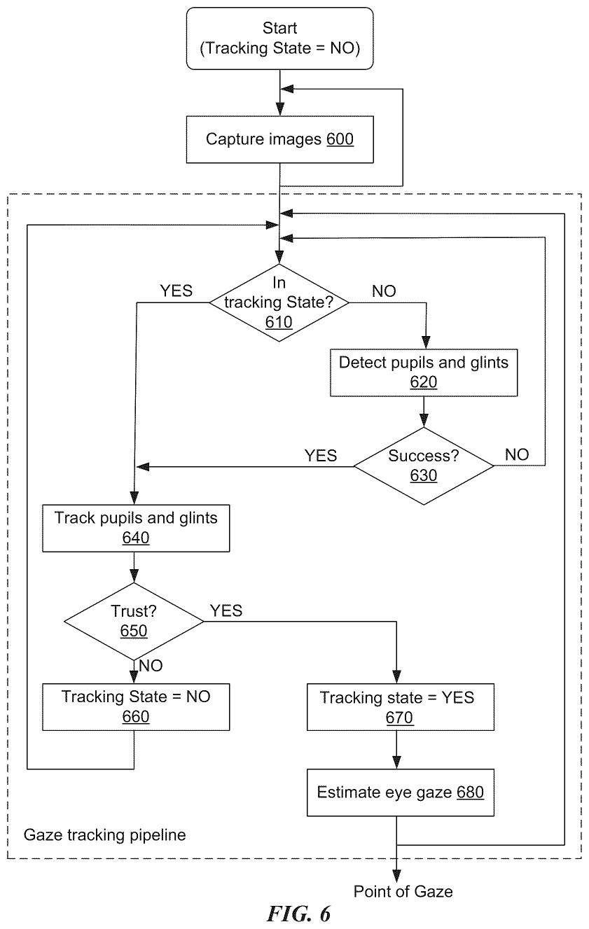

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. n some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand). In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user, user inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, wherein the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UP”) and associated processes that may be implemented on a computer system, such as a portable multifunction device or a head-mounted device, in communication with a display generation component, one or more input devices, and (optionally) one or more physical controls.

FIGS. 7A-7K illustrate examples of techniques for navigating extended reality experiences. FIG. 8 is a flow diagram of an exemplary method 800 for navigating extended reality experiences. FIG. 9 is a flow diagram of an exemplary method 900 for navigating extended reality experiences. The user interfaces in FIGS. 7A-7K are used to illustrate the processes described below, including the processes in FIG. 8 and FIG. 9.

FIG. 7A depicts electronic device 700, which is a smartphone that includes touch-sensitive display 702, buttons 704a-704c, and one or more input sensors 706 (e.g., one or more cameras, eye gaze trackers, hand movement trackers, and/or head movement trackers). In some embodiments described below, electronic device 700 is a smartphone. In some embodiments, electronic device 700 is a tablet, a wearable device, a wearable smartwatch device, a head-mounted system (e.g., a headset), or other computer system that includes and/or is in communication with one or more display devices (e.g., display screen, projection device, or the like). Electronic device 700 is a computer system (e.g., computer system 101 in FIG. 1A).

At FIG. 7A, electronic device 700 is in a low power, inactive, or sleep state, in which content is not displayed via display 702. At FIG. 7A, electronic device 700 detects user input 708. In the depicted embodiment, user input 708 is a button press input via button 704c. However, in some embodiments, user input 708 is a different type of input, such as a gesture or other action taken by a user. For example, in some embodiments, electronic device 700 is a head-mounted system, and user input 708 includes, for example, a user putting the electronic device 700 on his or her head, performing a gesture while wearing electronic device 700, pressing a button while wearing electronic device 700, rotating a rotatable input mechanism while wearing electronic device 700, providing a gaze-based gesture (e.g., looking at an object and/or moving his or her gaze in a particular manner), and/or any combination of the forgoing.

At FIG. 7B, in response to user input 708, electronic device 700 transitions from the low power, inactive, or sleep state to an active state, in which electronic device 700 displays, via display 702, three-dimensional environment 712 and extended reality experience 714 (e.g., an augmented reality experience and/or a virtual reality experience). In the depicted scenario, three-dimensional environment 712 includes a chair, a table, and a place setting placed on the table (e.g., a napkin, fork, knife, and cup). In some embodiments, three-dimensional environment 712 is displayed by a display (as depicted in FIG. 7B). In some embodiments, three-dimensional environment 712 includes a virtual environment or an image (or video) of a physical environment captured by one or more cameras (e.g., one or more cameras that are part of input sensors 706 and/or one or more cameras that are not shown in FIG. 7B). In some embodiments, three-dimensional environment 712 is visible to a user behind extended reality experience 714, but is not displayed by a display. For example, in some embodiments, three-dimensional environment 712 is a physical environment that is visible to a user (e.g., through a transparent display) behind extended reality experience 712 without being displayed by a display.

In FIG. 7B, extended reality experience 714 is a camera extended reality experience, as indicated by identifier 716a, which includes a logo of a camera and the name of the extended reality experience. Camera extended reality experience 714 includes one or more selectable objects 716b-e that are selectable by a user to capture photo and/or video content via one or more cameras (e.g., one or more cameras that are part of input sensors 706 and/or one or more cameras that are not shown in FIG. 7B). Object 716b is a shutter button that is selectable to capture a photo and/or a video. Object 716c is selectable to enable a slow motion capture mode. Option 716d is selectable to enable a photo capture mode. Option 716e is selectable to enable a video capture mode. In FIG. 7B, electronic device 700 detects that the user is looking at the right side of display 702, as indicated by gaze indication 710. Gaze indication 710 is provided for a better understanding of the described techniques and is optionally not a part of the user interface of the described device (e.g., is not displayed by electronic device 700). At FIG. 7B, electronic device 700 detects user input 718. In the depicted embodiment, user input 718 is a button press input via button 704c. However, in some embodiments, user input 718 is a different type of input, such as a gesture or other action taken by a user. For example, in some embodiments, electronic device 700 is a head-mounted system, and user input 718 includes, for example, a user performing a gesture (e.g., an air gesture) while wearing electronic device 700, pressing a button while wearing electronic device 700, rotating a rotatable input mechanism while wearing electronic device 700, providing a gaze-based gesture (e.g., looking at an object and/or moving his or her gaze in a particular manner), and/or any combination of the forgoing.

In FIG. 7C, in response to user input 718, electronic device 700 displays an animation in which extended reality experience 714 appears to move away from the user. In FIG. 7C, electronic device 700 displays representation 720, which is representative of camera extended reality experience 714. Representation 720 includes objects 722a-722e that are representative of objects 716a-716e (e.g., are smaller, non-interactive versions of objects 716a-716e) that are overlaid on background portion 722f and surrounded by border 719. Representation 720 appears to move away from the user by, for example, gradually getting smaller in size over time. In some embodiments, in response to user input 718 and/or while displaying the animation, three-dimensional environment 712 is visually obscured (as indicated by the dashed lines in FIG. 7C) (e.g., displayed with decreased focus, decreased sharpness, decreased color saturation, and/or greater opacity) in order to draw the user's attention and gaze to representation 720. As discussed above, in some embodiments, three-dimensional environment 712 is a “pass-through” environment that a user sees through a transparent display and is not displayed by a display. In some such embodiments, three-dimensional environment 712 is visually de-emphasized by applying masking or other techniques to the regions of the display (e.g., display 702) through which the user can view three-dimensional environment 712.

At FIG. 7D1, the animation of representation 720 (and/or extended reality experience 714) appearing to move away from the user is completed, and representation 720 is now displayed at the top of a stack of representations 721, 724, 726. Representations 721, 724, and/or 726 are representative of other extended reality experiences that can be selected by a user and/or displayed by electronic device 700. For example, as discussed above, representation 720 is representative of a camera extended reality experience (e.g., camera extended reality experience 714). In some embodiments, representation 724 is representative of a music extended reality experience (e.g., that includes one or more selectable options for playing music), representation 726 is representative of a translate extended reality experience (e.g., that includes one or more selectable options for translating content (e.g., content captured by one or more cameras and/or content within a field of view of the user and/or a field of view of electronic device 700)), and representations 721 include, for example, a representation of a reading extended reality experience, a representation of a photo gallery extended reality experience, a representation of a video messaging extended reality experience, a representation of a navigation extended reality experience, and/or a representation of a workout extended reality experience. As will be demonstrated in subsequent figures, a user is able to scroll through the stack of representations 720, 721, 724, and/or 726 to choose which extended reality experience the user would like to be displayed. In some embodiments, each extended reality experience corresponds to a different color, and the representation corresponding to the extended reality experience is displayed in the corresponding color that corresponds to the extended reality experience. For example, in some embodiments, camera extended reality experience 714 corresponds to a first color, and representation 720 is displayed in the first color (e.g., background 722f is displayed in the first color, border 720 is displayed in the first color, and/or object 722a (e.g., the logo and/or name) is displayed in the first color); and the music extended reality experience corresponds to a second color, such that representation 724 is displayed in the second color (e.g., a background portion of representation 724, a border of representation 724, and/or an identifier of representation 724 is displayed in the second color). In this way, a user is able to quickly recognize the order in which the extended reality experiences are stacked based on the colors of representations 720, 721, 724, and/or 726.

In FIG. 7D1 representation 720 is displayed at a first display position (e.g., at the top of the stack) indicating that a selection input (e.g., a press of button 704c or other selection input) would result in an extended reality experience corresponding to representation 720 being displayed (e.g., would result in camera extended reality experience 714 being displayed). At FIG. 7D1, electronic device 700 detects user input 727. In FIG. 7D1, user input 727 is a button press of button 704a. In some embodiments, a button press of button 704a indicates a request to navigate and/or scroll in a first direction (e.g., rotate the stack forward), and a button press of button 704b indicates a request to navigate and/or scroll in a second direction (e.g., rotate the stack backwards). Furthermore, in some embodiments, user input 727 is a different type of input, such as a gesture or other action taken by a user. For example, in some embodiments, electronic device 700 is a head-mounted system, and user input 727 includes, for example, a user performing a gesture (e.g., an air gesture) while wearing electronic device 700, pressing a button while wearing electronic device 700, rotating a rotatable input mechanism while wearing electronic device 700, providing a gaze-based gesture (e.g., looking at an object and/or moving his or her gaze in a particular manner), and/or any combination of the forgoing. For example, in some embodiments, rotation of a rotatable input mechanism in a first direction (e.g., rotation in a clockwise direction) (in some embodiments, rotation of the rotatable input mechanism while looking at the stack) indicates a request to navigate and/or scroll in a second direction (e.g., rotate the stack forward), and rotation of the rotatable input mechanism in a third direction (e.g., rotation in a counterclockwise direction) (in some embodiments, rotation of the rotatable input mechanism while looking at the stack) indicates a request to navigate and/or scroll in a fourth direction (e.g., rotate the stack backwards).

In some embodiments, the techniques and user interface(s) described in FIGS. 7A-7K are provided by one or more of the devices described in FIGS. 1A-1P. For example, FIGS. 7D2-7D4 illustrates an embodiment in which the transition animation described in FIGS. 7B-7D1 is displayed on display module X702 of head-mounted device (HMD) X700. In some embodiments, device X700 includes a pair of display modules that provide stereoscopic content to different eyes of the same user. For example, HMD X700 includes display module X702 (which provides content to a left eye of the user) and a second display module (which provides content to a right eye of the user). In some embodiments, the second display module displays a slightly different image than display module X702 to generate the illusion of stereoscopic depth.

In FIG. 7D2, extended reality experience 714 is a camera extended reality experience, as indicated by identifier 716a, which includes a logo of a camera and the name of the extended reality experience. Camera extended reality experience 714 includes one or more selectable objects 716b-e that are selectable by a user to capture photo and/or video content via one or more cameras (e.g., one or more cameras that are part of input sensors X706 and/or one or more cameras that are not shown in FIG. 7D2). Object 716b is a shutter button that is selectable to capture a photo and/or a video. Object 716c is selectable to enable a slow motion capture mode. Option 716d is selectable to enable a photo capture mode. Option 716e is selectable to enable a video capture mode. In FIG. 7D2, HMD X700 detects that the user is looking at the right side of display module X702, as indicated by gaze indication 710. Gaze indication 710 is provided for a better understanding of the described techniques and is optionally not a part of the user interface of the described device (e.g., is not displayed by HMD X700). At FIG. 7D2, HMD X700 detects user input 718. In the depicted embodiment, user input 718 is a button press input via button X704c. However, in some embodiments, user input 718 is a different type of input, such as a gesture or other action taken by a user. For example, in some embodiments, user input 718 includes, for example, a user performing a gesture (e.g., an air gesture) while wearing HMD X700, pressing a button while wearing HMD X700, rotating a rotatable input mechanism while wearing HMD X700, providing a gaze-based gesture (e.g., looking at an object and/or moving his or her gaze in a particular manner), and/or any combination of the forgoing.

In FIG. 7D3, in response to user input 718, HMD X700 displays an animation in which extended reality experience 714 appears to move away from the user. In FIG. 7D3, HMD X700 displays representation 720, which is representative of camera extended reality experience 714. Representation 720 includes objects 722a-722e that are representative of objects 716a-716e (e.g., are smaller, non-interactive versions of objects 716a-716e) that are overlaid on background portion 722f and surrounded by border 719. Representation 720 appears to move away from the user by, for example, gradually getting smaller in size over time. In some embodiments, in response to user input 718 and/or while displaying the animation, three-dimensional environment 712 is visually obscured (as indicated by the dashed lines in FIG. 7D3) (e.g., displayed with decreased focus, decreased sharpness, decreased color saturation, and/or greater opacity) in order to draw the user's attention and gaze to representation 720. As discussed above, in some embodiments, three-dimensional environment 712 is a “pass-through” environment that a user sees through a transparent display and is not displayed by a display. In some such embodiments, three-dimensional environment 712 is visually de-emphasized by applying masking or other techniques to the regions of the display (e.g., display module X702) through which the user can view three-dimensional environment 712.

At FIG. 7D4, the animation of representation 720 (and/or extended reality experience 714) appearing to move away from the user is completed, and representation 720 is now displayed at the top of a stack of representations 721, 724, 726. Representations 721, 724, and/or 726 are representative of other extended reality experiences that can be selected by a user and/or displayed by electronic device 700. For example, as discussed above, representation 720 is representative of a camera extended reality experience (e.g., camera extended reality experience 714). In some embodiments, representation 724 is representative of a music extended reality experience (e.g., that includes one or more selectable options for playing music), representation 726 is representative of a translate extended reality experience (e.g., that includes one or more selectable options for translating content (e.g., content captured by one or more cameras and/or content within a field of view of the user and/or a field of view of electronic device 700)), and representations 721 include, for example, a representation of a reading extended reality experience, a representation of a photo gallery extended reality experience, a representation of a video messaging extended reality experience, a representation of a navigation extended reality experience, and/or a representation of a workout extended reality experience. As will be demonstrated in subsequent figures, a user is able to scroll through the stack of representations 720, 721, 724, and/or 726 to choose which extended reality experience the user would like to be displayed. In some embodiments, each extended reality experience corresponds to a different color, and the representation corresponding to the extended reality experience is displayed in the corresponding color that corresponds to the extended reality experience. For example, in some embodiments, camera extended reality experience 714 corresponds to a first color, and representation 720 is displayed in the first color (e.g., background 722f is displayed in the first color, border 720 is displayed in the first color, and/or object 722a (e.g., the logo and/or name) is displayed in the first color); and the music extended reality experience corresponds to a second color, such that representation 724 is displayed in the second color (e.g., a background portion of representation 724, a border of representation 724, and/or an identifier of representation 724 is displayed in the second color). In this way, a user is able to quickly recognize the order in which the extended reality experiences are stacked based on the colors of representations 720, 721, 724, and/or 726.

In FIG. 7D4 representation 720 is displayed at a first display position (e.g., at the top of the stack) indicating that a selection input (e.g., a press of button 704c or other selection input) would result in an extended reality experience corresponding to representation 720 being displayed (e.g., would result in camera extended reality experience 714 being displayed). At FIG. 7D4, HMD X700 detects user input 727. In FIG. 7D4, user input 727 is a button press of button X704a. In some embodiments, a button press of button X704a indicates a request to navigate and/or scroll in a first direction (e.g., rotate the stack forward), and a button press of button X704b indicates a request to navigate and/or scroll in a second direction (e.g., rotate the stack backwards). Furthermore, in some embodiments, user input 727 is a different type of input, such as a gesture or other action taken by a user. For example, in some embodiments, user input 727 includes, for example, a user performing a gesture (e.g., an air gesture) while wearing HMD X700, pressing a button while wearing HMD X700, rotating a rotatable input mechanism while wearing HMD X700, providing a gaze-based gesture (e.g., looking at an object and/or moving his or her gaze in a particular manner), and/or any combination of the forgoing. For example, in some embodiments, rotation of a rotatable input mechanism in a first direction (e.g., rotation in a clockwise direction) (in some embodiments, rotation of the rotatable input mechanism while looking at the stack) indicates a request to navigate and/or scroll in a second direction (e.g., rotate the stack forward), and rotation of the rotatable input mechanism in a third direction (e.g., rotation in a counterclockwise direction) (in some embodiments, rotation of the rotatable input mechanism while looking at the stack) indicates a request to navigate and/or scroll in a fourth direction (e.g., rotate the stack backwards).

Any of the features, components, and/or parts, including the arrangements and configurations thereof shown in FIGS. 1B-1P can be included, either alone or in any combination, in HMD X700. For example, in some embodiments, HMD X700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module X702 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, HMD X700 includes a sensor that includes any of the features, components, and/or parts of any of sensors 190, sensors 306, image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, HMD X700 includes one or more input devices, which include any of the features, components, and/or parts of any of first button 1-128, button 11.1.1-114, second button 1-132, and or dial or button 1-328, either alone or in any combination. In some embodiments, HMD X700 includes one or more audio output components (e.g., electronic component 1-112) for generating audio feedback (e.g., audio output X714-3), optionally generated based on detected events and/or user inputs detected by the HMD X700.

At FIG. 7E, in response to user input 727, electronic device 700 ceases display of representation 720 at the top of the stack, and now displays representation 724 (which was second in the stack in FIG. 7D1) at the top of the stack. Representation 724 is representative of a music extended reality experience, and displays objects 728a-728d overlaid on background 728e and surrounded by border 723. Objects 728a-728d are representative of objects that would be displayed in the music extended reality experience if the user selects the music extended reality experience for display. Accordingly, representation 724 provides the user with a preview of what the music extended reality experience would look like. At FIG. 7E, electronic device 700 detects user input 729. In FIG. 7E, user input 729 is a button press of button 704a. As discussed above, in some embodiments, user input 729 is a different type of input, such as a gesture or other action taken by a user. For example, in some embodiments, electronic device 700 is a head-mounted system, and user input 729 includes, for example, a user performing a gesture (e.g., an air gesture) while wearing electronic device 700, pressing a button while wearing electronic device 700, rotating a rotatable input mechanism while wearing electronic device 700, providing a gaze-based gesture (e.g., looking at an object and/or moving his or her gaze in a particular manner), and/or any combination of the forgoing.

At FIG. 7F, in response to user input 729, electronic device 700 ceases display of representation 724 at the top of the stack, and now displays representation 726 (which was second in the stack in FIG. 7E) at the top of the stack. In some embodiments, had user input 729 been a request to rotate the stack in the opposite direction (e.g., a button press of button 704b), electronic device 700 would re-display representation 720 at the top of the stack (and representation 724 second in the stack, as in FIG. 7D1). In FIG. 7F, representation 726 is representative of a translate extended reality experience, and includes objects 730a-730d overlaid on background 730 and surrounded by border 725. In some embodiments, object 730a is an identifier that identifies the translate extended reality experience (e.g., via a logo and/or a name), and objects 730b-730d are representative of selectable objects that would be displayed in the translate extended reality experience. In some embodiments, objects 730b-730d are representative of selectable objects (as will be described below with reference to FIG. 7J), but are not themselves individually selectable to perform any function. At FIG. 7F, electronic device 700 detects user input 732. In FIG. 7F, user input 732 is a touch-screen swipe gesture with a downward direction. However, in some embodiments, user input 732 is a different type of user input, such as a gesture or other action taken by a user. For example, in some embodiments, electronic device 700 is a head-mounted system, and user input 732 includes, for example, a user performing a gesture (e.g., an air gesture) while wearing electronic device 700, pressing a button while wearing electronic device 700, rotating a rotatable input mechanism while wearing electronic device 700, providing a gaze-based gesture (e.g., looking at an object and/or moving his or her gaze in a particular manner), and/or any combination of the forgoing.

At FIG. 7G, in response to user input 732, electronic device 700 displays system control user interface 734, which includes selectable objects 736a-736h. Object 736a is selectable to selectively engage or disengage a “do not disturb” or sleep focus state in which notifications received by electronic device 700 are suppressed. Object 736b is selectable to selectively turn WiFi on or off. Object 736c is selectable to selectively engage or disengage an airplane mode. Object 736d is selectable to selectively turn a flashlight on or off. Object 736e is selectable to initiate a process for streaming audio and/or video content to an external device. Object 736f is selectable to selectively engage or disengage a silent mode. Object 736g is selectable to modify a volume setting of electronic device 700. Object 736h is selectable to modify a brightness of electronic device 700. In some embodiments, electronic device 700 is a head-mounted system, and option 736h is selectable to modify a passthrough brightness setting and/or a passthrough opacity setting of electronic device 700. At FIG. 7G, electronic device 700 detects user input 736. In FIG. 7G, user input 736 is a tap input on touch-sensitive display 702. However, in some embodiments, user input 736 is a different type of user input, such as a gesture or other action taken by a user. For example, in some embodiments, electronic device 700 is a head-mounted system, and user input 736 includes, for example, a user performing a gesture (e.g., an air gesture) while wearing electronic device 700, pressing a button while wearing electronic device 700, rotating a rotatable input mechanism while wearing electronic device 700, providing a gaze-based gesture (e.g., looking at an object and/or moving his or her gaze in a particular manner), and/or any combination of the forgoing.

At FIG. 7H, in response to user input 736, electronic device 700 ceases display of system control user input 734. At FIG. 7H, electronic device 700 displays representation 726 at the top of the stack of representations, and while displaying representation 736 at the top of the stack of representations, electronic device 700 detects user input 740 (e.g., a selection input). In FIG. 7H, user input 740 is a button press input of button 704c. However, in some embodiments, user input 740 is a different type of user input, such as a gesture or other action taken by a user. For example, in some embodiments, electronic device 700 is a head-mounted system, and user input 740 includes, for example, a user performing a gesture (e.g., an air gesture) while wearing electronic device 700, pressing a button while wearing electronic device 700, rotating a rotatable input mechanism while wearing electronic device 700, providing a gaze-based gesture (e.g., looking at an object and/or moving his or her gaze in a particular manner), and/or any combination of the forgoing.

At FIG. 7I, in response to user input 740, electronic device 700 ceases display of representations 721 (e.g., ceases display of the stack of representations), and displays an animation in which representation 726 appears to move towards the user. For example, in FIG. 7I, representation 726 (including objects 730a-730b and border 725) grows larger. Furthermore, in FIG. 7I, background 730e goes from opaque to transparent to show three-dimensional environment 712 behind representation 736.

At FIG. 7J, electronic device 700 completes the animation of representation 721 growing larger, and now replaces display of representation 721 with display of translate extended reality experience 742. In some embodiments, in transitioning from display of representation 721 to display of translated extended reality experience 742, electronic device 700 displays crossfading of objects 730a-730d with corresponding objects 744a-744d. Furthermore, in FIG. 7J, three-dimensional environment 712 is no longer visually de-emphasized (as indicated by the transition from dotted lines in FIG. 7I to solid lines in FIG. 7J).

Translate extended reality experience 742 includes object 744a, which identifies the extended reality experience (e.g., using a logo and/or a name), and objects 744b-744d that are selectable to perform various tasks. For example, in some embodiments, object 744b is selectable to engage a microphone so that a user is able to provide a spoken and/or verbal input for translation into a different language; object 744c is selectable to translate visual content captured by one or more cameras (e.g., input sensors 706); and object 744d is selectable to cause electronic device 700 to read a translation aloud (e.g., play audio content that reads a translation aloud). In FIG. 7J, translation extended reality experience 742 also includes object 746, which indicates that electronic device 700 has detected visual content that can be translated. In FIG. 7J, a menu has moved into the view of electronic device 700 (e.g., moved into the view of one or more cameras), and object 746 indicates that the menu includes text that can be translated into a different language. At FIG. 7J, electronic device 700 detects user input 748 while also detecting that the user is looking at object 746 (e.g., as indicated by gaze indication 710). In FIG. 7J, user input 748 is a tap input via touch-sensitive display 702. However, in some embodiments, user input 748 is a different type of user input, such as a gesture or other action taken by a user. For example, in some embodiments, electronic device 700 is a head-mounted system, and user input 748 includes, for example, a user performing a gesture (e.g., an air gesture) while wearing electronic device 700, pressing a button while wearing electronic device 700, rotating a rotatable input mechanism while wearing electronic device 700, providing a gaze-based gesture (e.g., looking at an object and/or moving his or her gaze in a particular manner), and/or any combination of the forgoing.

At FIG. 7K, in response to user input 748 (e.g., in response to user input 748 while the user is gazing at object 746), electronic device 700 displays translations 750a-750e. Translations 750a-750e are displayed overlaid on three-dimensional environment 712. In some embodiments, objects 744a-744d are viewpoint-locked objects, such that even as the user changes a viewpoint of electronic device 700 (e.g., by moving and/or turning electronic device 700), objects 744a-744d do not move around display 702; and translations 750a-750e are environment-locked (or world-locked) objects, such that when the user changes a viewpoint of electronic device 700, translations 750a-750e are moved around display 702 (and/or moved off of display 702) based on how things in three-dimensional environment 712 move. For example, translation 750a is “locked” onto the word “MENU” and moves with the word “MENU” around display 702, and translation 750b is “locked” onto the words “GARDEN SALAD” and moves with the words “GARDEN SALAD” around display 702.

Additional descriptions regarding FIGS. 7A-7K are provided below in reference to method 800 and method 900 described with respect to FIGS. 7A-7K.

FIG. 8 is a flow diagram of an exemplary method 800 for navigating extended reality experiences, in accordance with some embodiments. In some embodiments, method 800 is performed at a computer system (e.g., computer system 101 in FIG. 1A) (e.g., 700 and/or X700) (e.g., a smart phone, a smart watch, a tablet, a wearable device, and/or head-mounted device) that is in communication with one or more display generation components (e.g., 702 and/or X702) (e.g., a visual output device, a 3D display, a display having at least a portion that is transparent or translucent on which images can be projected (e.g., a see-through display), a projector, a heads-up display, and/or display controller) and one or more input devices (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; and/or a biometric sensor (e.g., a fingerprint sensor, a face identification sensor, and/or an iris identification sensor)). In some embodiments, method 800 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 800 are, optionally, combined and/or the order of some operations is, optionally, changed.

In some embodiments, the computer system (e.g., 700 and/or X700) concurrently displays (802), via the one or more display generation components (e.g., 702 and/or X702), in a three-dimensional environment (e.g., 712) (e.g., a virtual three-dimensional environment, a virtual passthrough three-dimensional environment, and/or an optical passthrough three-dimensional environment), representations of a plurality of augmented reality experiences (e.g., 720, 721, 724, and/or 726) (e.g., augmented reality user interfaces and/or augmented reality applications) (e.g., displays the representations of the plurality of augmented reality experiences overlaid on the three-dimensional environment, and/or displays the representations of the plurality of augmented reality experiences concurrently with the three-dimensional environment), including: a first representation of a first augmented reality experience (804) (e.g., 720, 721, 724, and/or 726); and a second representation of a second augmented reality experience (806) (e.g., 720, 721, 724, and/or 726) that is different from the first augmented reality experience, wherein the second representation is different from the first representation. While concurrently displaying (808), in the three-dimensional environment (e.g., 712), the representations of the plurality of augmented reality experiences (e.g., 720, 721, 724, and/or 726), the computer system receives (810), via the one or more input devices (e.g., 702, 704a-704c, and/or 706), a first user input (e.g., 727, 729, and/or 740) (e.g., one or more user inputs and/or a first set of user inputs) (e.g., one or more mechanical inputs (e.g., button press and/or rotation of physical input mechanism), one or more touch inputs, one or more gestures, one or more air gestures, and/or one or more gaze inputs). In response to receiving the first user input (812), the computer system ceases display (814) of the representations of one or more of the plurality of augmented reality experiences (e.g., 720, 721, 724, and/or 726); and in accordance with a determination that the first user input corresponds to selection of the first representation of the first augmented reality experience (816), the computer system displays (818), via the one or more display generation components, in the three-dimensional environment, the first augmented reality experience (e.g., 714 and/or 742) (and, in some embodiments, without displaying the second augmented reality experience) (e.g., displays the first augmented reality experience applied to the three-dimensional environment, displays the first augmented reality experience overlaid on the three-dimensional environment, and/or displays the first augmented reality experience concurrently with the three-dimensional environment).

In some embodiments, in response to receiving the first user input (e.g., 727, 729, and/or 740), and in accordance with a determination that the first user input corresponds to selection of the second representation of the second augmented reality experience (e.g., 720, 721, 724, and/or 726), the computer system displays, via the one or more display generation components, in the three-dimensional environment (e.g., 712) (e.g., applied to the three-dimensional environment and/or concurrently with the three-dimensional environment), the second augmented reality experience (e.g., 714 and/or 742) (and, in some embodiments, without displaying the first augmented reality experience). In some embodiments, the computer system (e.g., 700 and/or X700) is a head-mounted system. In some embodiments, the three-dimensional environment (e.g., 712) is an optical passthrough environment (e.g., the physical, real environment) that is visible to the user through transparent display generation components (e.g., transparent optical lens displays) on which the representations of the plurality of augmented reality experiences (e.g., 720, 721, 724, and/or 726), the first augmented reality experience (e.g., 714 and/or 742), and/or the second augmented reality experience (e.g., 714 and/or 742) are displayed. In some embodiments, the three-dimensional environment (e.g., 712) is a virtual three-dimensional environment that is displayed by one or more display generation components (e.g., 702). In some embodiments, the three-dimensional environment is a virtual passthrough environment (e.g., a virtual passthrough environment that is a virtual representation of the user's physical, real-world environment (e.g., as captured by one or more cameras that are in communication with the computer system)) that is displayed by one or more display generation components (e.g., 702 and/or X702). Concurrently displaying representations of a plurality of augmented reality experiences allows a user to switch between different augmented reality experiences with fewer user inputs, thereby reducing the number of user inputs required to perform an operation. Displaying the first augmented reality experience in accordance with a determination that the first user input corresponds to selection of the first representation of the first augmented reality experience provides the user with visual feedback about the state of the system (e.g., that the system has detected the first user input that corresponds to selection of the first representation of the first augmented reality experience), thereby providing improved visual feedback to the user.

In some embodiments, the representations of the plurality of augmented reality experiences (e.g., 720, 721, 724, and/or 726) are displayed on one or more additive light displays (e.g., see-through displays that display one or more elements while a real-world background is visible to the user behind the displayed elements); and the three-dimensional environment (e.g., 712) is an optical passthrough environment (e.g., the physical, real environment) that is visible to a user through the one or more additive light displays (e.g., behind and or through the displayed representations of the plurality of augmented reality experiences). Concurrently displaying representations of a plurality of augmented reality experiences allows a user to switch between different augmented reality experiences with fewer user inputs, thereby reducing the number of user inputs required to perform an operation.

In some embodiments, in response to receiving the first user input (e.g., 727, 729, and/or 740), and in accordance with a determination that the first user input corresponds to selection of the second representation of the second augmented reality experience (e.g., 720, 721, 724, and/or 726), the computer system displays, via the one or more display generation components, in the three-dimensional environment (e.g., 712), the second augmented reality experience (e.g., 714 and/or 742). In some embodiments, displaying the first augmented reality experience (e.g., 714 and/or 742) includes displaying a first set of interactive elements (e.g., objects 716a-716e correspond to augmented reality experience 714, and objects 744a-744d correspond to augmented reality experience 742) (e.g., one or more interactive elements) (e.g., one or more selectable options, selectable buttons, and/or affordances) (in some embodiments, displaying the first set of interactive elements overlaid on the three-dimensional environment); displaying the second augmented reality experience (e.g., 714 and/or 742) includes displaying a second set of interactive elements (e.g., objects 716a-716e correspond to augmented reality experience 714, and objects 744a-744d correspond to augmented reality experience 742) (e.g., one or more interactive elements) (e.g., one or more selectable options, selectable button, and/or affordances) different from the first set of interactive elements (e.g., without displaying the first set of interactive elements) (in some embodiments, displaying the second set of interactive elements overlaid on the three-dimensional environment); the first representation of the first augmented reality experience (e.g., 720 and/or 726) includes representations of the first set of interactive elements (e.g., representation 720 includes objects 722a-722e representative of objects 716a-716e; and representation 726 includes objects 730a-730d representative of objects 744a-744d) (in some embodiments, representations of the first set of interactive elements overlaid on a first representative background (e.g., a visual region and/or displayed region that is representative of the three-dimensional environment (e.g., representative of a passthrough environment, an optical passthrough environment, and/or a virtual passthrough environment))); and the second representation of the second augmented reality experience (e.g., 720 and/or 726) includes representations of the second set of interactive elements (e.g., representation 720 includes objects 722a-722e representative of objects 716a-716e; and representation 726 includes objects 730a-730d representative of objects 744a-744d) (in some embodiments, representations of the second set of interactive elements overlaid on a second representative background) different from the representations of the first set of interactive elements. Displaying representations of the augmented reality experiences that provide the user with a simplified preview of the augmented reality experience enhances the operability of the computer system by helping the user to provide proper inputs and reducing user mistakes when operating/interacting with the computer system.

In some embodiments, displaying the first augmented reality experience (e.g., 714 and/or 742) includes displaying the first set of interactive elements (e.g., 716a-716e, and/or 744a-744d) overlaid on a passthrough environment (e.g., 712) (e.g., an optical passthrough environment and/or a virtual passthrough environment); displaying the second augmented reality experience (e.g., 714 and/or 742) includes displaying the second set of interactive elements (e.g., 716a-7164 and/or 744a-744d) overlaid on the passthrough environment (e.g., 712); the first representation of the first augmented reality experience (e.g., 720 and/or 726) includes first placeholder background content (e.g., 722f, 728e, and/or 730e) representative of the passthrough environment (e.g., placeholder content that is not a passthrough environment and/or is a representation of a passthrough environment) (e.g., an image, a virtual three-dimensional environment, a solid color, and/or a visual pattern) (in some embodiments, the representations of the first set of interactive elements are overlaid on the first placeholder background content); and the second representation of the second augmented reality experience (e.g., 720 and/or 726) includes second placeholder background content (e.g., 722f, 728e, and/or 730e) representative of the passthrough environment (e.g., placeholder content that is not a passthrough environment and/or is a representation of a passthrough environment) (e.g., an image, a virtual three-dimensional environment, a solid color, and/or a visual pattern) (in some embodiments, the representations of the second set of interactive elements are overlaid on the second placeholder background content) (e.g., second placeholder background content different from the first placeholder background content or the same as the first placeholder background content). Displaying representations of the augmented reality experiences that provide the user with a simplified preview of the augmented reality experience enhances the operability of the computer system by helping the user to provide proper inputs and reducing user mistakes when operating/interacting with the computer system.

In some embodiments, the representations of the first set of interactive elements (e.g., 722a-722e, 728a-728d, and/or 730a-730d) are non-interactive (e.g., cannot be individually selected and/or otherwise individually interacted with by a user) (in some embodiments, one or more interactive elements of the first set of interactive elements (e.g., 716a-716e and/or 744a-744d) are selectable to perform a respective corresponding action (e.g., a first interactive element of the first set of interactive elements is selectable to perform a first action, and a second interactive element of the first set of interactive elements is selectable to perform a second action), and the representations of the first set of interactive elements (e.g., 722a-722e, 728a-728d, and/or 730a-730d) are not selectable (e.g., are not individually selectable) to perform the respective corresponding actions (e.g., a representation of the first interactive element is not selectable to perform the first action and a representation of the second interactive element is not selectable to perform the second action and/or the representations of the first and second interactive elements are not individually selectable); and/or the computer system is configured to distinguish between selection of a first interactive element (e.g., 716a-716e and/or 744a-744d) and a second interactive element (e.g., 716a-716e and/or 744a-744d) of the first set of interactive elements (e.g., 716a-716e and/or 744a-744d), but is not configured to distinguish between selection of a representation of the first interactive element (e.g., 722a-722e, 728a-728d, and/or 730a-730d) and a representation of the second interactive element (e.g., 722a-722e, 728a-728d, and/or 730a-730d)); and the representations of the second set of interactive elements (e.g., 722a-722e, 728a-728d, and/or 730a-730d) are non-interactive. Displaying representations of the augmented reality experiences that provide the user with a simplified preview of the augmented reality experience enhances the operability of the computer system by helping the user to provide proper inputs and reducing user mistakes when operating/interacting with the computer system.

In some embodiments, at least a portion of the first representation of the first augmented reality experience (e.g., 720, 721, 724, and/or 726) is displayed in a first color corresponding to the first augmented reality experience (e.g., 714 and/or 742) (e.g., corresponding uniquely to the first augmented reality experience and/or corresponding to the first augmented reality experience without corresponding to the second augmented reality experience); and at least a portion of the second representation of the second augmented reality experience (e.g., 720, 721, 724, and/or 726) is displayed in a second color corresponding to the second augmented reality experience (e.g., 714 and/or 742) (e.g., corresponding uniquely to the second augmented reality experience and/or corresponding to the second augmented reality experience without corresponding to the first augmented reality experience), wherein the second color is different from the first color. In some embodiments, the first representation of the first augmented reality experience does not include the second color, and the second representation of the second augmented reality experience does not include the first color. Displaying representations of the augmented reality experiences in different colors that correspond uniquely to different augmented reality experiences allows the user to more easily select a particular augmented reality experience, which enhances the operability of the computer system by helping the user to provide proper inputs and reducing user mistakes when operating/interacting with the computer system.

In some embodiments, the first representation of the first augmented reality experience (e.g., 720, 721, 724, and/or 726) includes a first identifier (e.g., 722a, 728a, and/or 730a) (e.g., a first icon, a first set of text (e.g., name and/or other text identifier), and/or a first color) corresponding to the first augmented reality experience (e.g., corresponding uniquely to the first augmented reality experience and/or corresponding to the first augmented reality experience without corresponding to the second augmented reality experience or other augmented reality experiences that are available via the computer system); the second representation of the second augmented reality experience (e.g., 720, 721, 724, and/or 726) includes a second identifier (e.g., 722a, 728, and/or 730a) (e.g., a second icon, a second set of text (e.g., name and/or other text identifier), and/or a second color) different from the first identifier and corresponding to the second augmented reality experience (e.g., corresponding uniquely to the second augmented reality experience and/or corresponding to the second augmented reality experience without corresponding to the first augmented reality experience); displaying the first augmented reality experience (e.g., 714 and/or 742) includes displaying the first identifier (e.g., 716a and/or 744a) as part of the first augmented reality experience (e.g., without displaying the second identifier); and displaying the second augmented reality experience (e.g., 714 and/or 742) includes displaying the second identifier (e.g., 716a and/or 744a) as part of the second augmented reality experience (e.g., without displaying the first identifier). Displaying representations of the augmented reality experiences with different identifiers that correspond uniquely to different augmented reality experiences allows the user to more easily select a particular augmented reality experience, which enhances the operability of the computer system by helping the user to provide proper inputs and reducing user mistakes when operating/interacting with the computer system.

In some embodiments, in response to receiving the first input (e.g., 718, 727, 729, and/or 740): in accordance with a determination that the first user input corresponds to selection of the first representation of the first augmented reality experience (e.g., 720, 721, 724, and/or 726): prior to displaying the first augmented reality experience (e.g., 714 and/or 742), the computer system displays, via the one or more display generation components, a first animation in which the first representation of the first augmented reality experience moves toward a viewpoint of a user of the computer system (e.g., FIGS. 7H-7J, representation 726 moves towards the viewpoint of the user until augmented reality experience 742 is displayed) (e.g., in which the first representation of the first augmented reality experience grows larger and/or appears to move closer to the user's viewpoint). In some embodiments, in response to receiving the first user input, and in accordance with a determination that the first user input corresponding to selection of the second representation of the second augmented reality experience: prior to displaying the second augmented reality experience, the computer system displays, via the one or more display generation components, a second animation in which the second representation of the second augmented reality experience moves toward a viewpoint of the user of the computer system. Displaying an animation in which the first representation of the first augmented reality experience moves toward a viewpoint of the user provides the user with visual feedback about the state of the system (e.g., that the system is transitioning into the first augmented reality experience), thereby providing improved visual feedback to the user.

In some embodiments, the first representation of the first augmented reality experience (e.g., 720, 721, 724, and/or 726) includes a first border that surrounds (e.g., partially and/or completely surrounds) the representations of the first set of interactive elements (e.g., 722a-722e, 728a-728d, and/or 730a-730d); the second representation of the second augmented reality experience (e.g., 720, 721, 724, and/or 726) includes a second border (e.g., different from and/or separate from the first border) that surrounds (e.g., partially and/or completely surrounds) the representations of the second set of interactive elements (e.g., 722a-722e, 728a-728d, and/or 730a-730d); and displaying the first animation includes displaying the first border moving toward the viewpoint of the user of the computer system until the first border is no longer displayed (e.g., FIGS. 7H-7J, the border surrounding representation 726 moves towards the viewpoint of the user until augmented reality experience 742 is displayed) (e.g., until the first border moves out of a display area of the computer system and/or outside a portion of the display area of the computer system that is visible to the user) (e.g., increasing the size of the first border until the first border is no longer displayed by the computer system and/or is outside of a portion of the display area of the computer system that is visible to the user). In some embodiments, in response to receiving the first user input, and in accordance with a determination that the first user input corresponding to selection of the second representation of the second augmented reality experience: prior to displaying the second augmented reality experience, the computer system displays, via the one or more display generation components, a second animation in which the second representation of the second augmented reality experience moves toward a viewpoint of the user of the computer system, wherein displaying the second animation includes displaying the second border moving toward the viewpoint of the user of the computer system until the second border is no longer displayed. Displaying an animation in which the first representation of the first augmented reality experience, including a border of the first representation, moves toward a viewpoint of the user provides the user with visual feedback about the state of the system (e.g., that the system is transitioning into the first augmented reality experience), thereby providing improved visual feedback to the user.

In some embodiments, in response to receiving the first input (e.g., 718, 727, 729, and/or 740): in accordance with a determination that the first user input corresponds to selection of the first representation of the first augmented reality experience: the computer system displays, via the one or more display generation components, crossfading of the representations of the first set of interactive elements (e.g., 730a-730d) with the first set of interactive elements (e.g., 744a-744d) (e.g., during display of and/or after displaying the first animation). In some embodiments, in response to receiving the first input: in accordance with a determination that the first user input corresponds to selection of the second representation of the second augmented reality experience: the computer system displays, via the one or more display generation components, crossfading of the representations of the second set of interactive elements with the second set of interactive elements. Displaying crossfading of the representations of the first set of interactive elements with the first set of interactive elements provides the user with visual feedback about the state of the system (e.g., that the system is transitioning into the first augmented reality experience), thereby providing improved visual feedback to the user.

In some embodiments, in response to receiving the first input (e.g., 718, 727, 729, and/or 740): in accordance with a determination that the first user input corresponds to selection of the first representation of the first augmented reality experience: the computer system ceases display of the representations of the first set of interactive elements (e.g., 730a-7330d); and displays, via the one or more display generation components, the first set of interactive elements (e.g., 744a-744d). Displaying replacement of the representations of the first set of interactive elements with the first set of interactive elements provides the user with visual feedback about the state of the system (e.g., that the system is transitioning into the first augmented reality experience), thereby providing improved visual feedback to the user.

In some embodiments, prior to receiving the first user input, and while concurrently displaying, in the three-dimensional environment (e.g., 712), the representations of the plurality of augmented reality experiences (e.g., 720, 721, 724, and/or 726), the computer system displays, via the one or more display generation components, the first representation of the first augmented reality experience (e.g., 720, 721, 724, and/or 726) at a first display position (e.g., representation 720 in FIG. 7D1) (and, in some embodiments, concurrently displays the second representation of the second augmented reality experience at a second display position different from the first display position (e.g., representation 724 in FIG. 7D1)) (in some embodiments, the first display position is representative of a currently selected and/or currently in focus object). While displaying the first representation of the first augmented reality experience at the first display position, the computer system receives, via the one or more input devices, a second user input (e.g., 727 and/or 729) (e.g., one or more user inputs and/or a first set of user inputs) (e.g., one or more touch inputs, one or more gestures, one or more air gestures, and/or one or more gaze inputs) corresponding to a request to navigate from the first representation of the first augmented reality experience (e.g., 720, 721, 724, and/or 726) to the second representation of the second augmented reality experience (e.g., 720, 721, 724, and/or 726). In response to receiving the second user input (e.g., 727 and/or 729), the computer system ceases display of the first representation of the first augmented reality experience at the first display position (e.g., in FIGS. 7D1-7E, in response to user input 727, electronic device 700 ceases display of representation 720 at the front position of the stack; and in FIGS. 7E-7F, in response to user input 729, electronic device 700 ceases display of representation 724 at the front position of the stack) (and, in some embodiments, while maintaining display of at least a portion of the first representation of the first augmented reality experience); and displays, via the one or more display generation components, the second representation of the second augmented reality experience at the first display position (e.g., in FIG. 7E, representation 724 is displayed at the front position of the stack, and in FIG. 7F, representation 726 is displayed at the front position of the stack). Displaying navigation from the first representation of the first augmented reality experience to the second representation of the second augmented reality experience in response to the second user input provides the user with visual feedback about the state of the system (e.g., that the system has detected the second user input), thereby providing improved visual feedback to the user.

In some embodiments, concurrently displaying the representations of the plurality of augmented reality experiences (e.g., 720, 721, 724, and/or 726) includes displaying the representations of the plurality of augmented reality experiences in a stack, wherein the first representation of the first augmented reality experience is stacked on top of the second representation of the second augmented reality experience (e.g., first representation of the first augmented reality experience lays on top of and/or partially obscures the second representation of the second augmented reality experience). Displaying representations of the augmented reality experiences in a stack that the user can navigate through allows the user to more easily select a particular augmented reality experience, which enhances the operability of the computer system by helping the user to provide proper inputs and reducing user mistakes when operating/interacting with the computer system.

In some embodiments, prior to receiving the first user input, and while concurrently displaying, in the three-dimensional environment, the representations of the plurality of augmented reality experiences including concurrently displaying the first representation of the first augmented reality experience and the second representation of the second augmented reality experience, the computer system receives, via the one or more input devices, a third user input (e.g., 727 and/or 729) (e.g., one or more user inputs and/or a first set of user inputs) (e.g., one or more touch inputs, one or more gestures, one or more air gestures, and/or one or more gaze inputs) corresponding to a request to navigate through the representations of the plurality of augmented reality experiences. In response to receiving the third user input, the computer system ceases display of the first representation of the first augmented reality experience while maintaining display of the second representation of the second augmented reality experience (e.g., in FIGS. 7D1-7E, in response to user input 727, electronic device 700 ceases display of representation 720 while maintaining display of representations 724 and/or 726; and/or in FIGS. 7E-7F, in response to user input 729, electronic device 700 ceases display of representation 724 while maintaining display of representation 726). Displaying representations of the augmented reality experiences in a stack that the user can navigate through allows the user to more easily select a particular augmented reality experience, which enhances the operability of the computer system by helping the user to provide proper inputs and reducing user mistakes when operating/interacting with the computer system.

In some embodiments, the determination that the first user input corresponds to selection of the first representation of the first augmented reality experience comprises a determination that the first user input is a selection input that includes: a gaze input directed toward the first representation of the first augmented reality experience (e.g., in FIG. 7H, gaze indication 710 indicates that the user is looking at representation 726) (e.g., a user gaze directed toward a selectable object; a user gaze directed toward a respective representation of the representations of the plurality of augmented reality experience and/or a user gaze corresponding to and/or identifying a particular augmented reality experience); and a hardware press input (e.g., 740) detected while the gaze input is directed toward the first representation of the first augmented reality experience (e.g., a press of a hardware button and/or depression of a depressible input mechanism (e.g., a rotatable and depressible input mechanism)) (e.g., a hardware press input that occurs concurrently with the gaze input). In some embodiments, in response to receiving the first user input, and in accordance with a determination that the first user input is not a selection input (e.g., in accordance with a determination that the first user input does not include a gaze input directed toward the first representation of the first augmented reality experience and/or a hardware press input while the gaze input is directed toward the first representation of the first augmented reality experience), the computer system forgoes displaying the first augmented reality experience. In some embodiments, in response to receiving the first user input, and in accordance with a determination that the first user input is not a selection input, the computer system forgoes ceasing display of the representations of one or more of the plurality of augmented reality experiences (e.g., the computer system maintains display of the representations of one or more of the plurality of augmented reality experiences). In some embodiments, ceasing display of the representations of one or more of the plurality of augmented reality experiences is performed in accordance with a determination that the first user input is a selection input. In some embodiments, the first user input includes: a first gaze input (e.g., a user gaze directed toward a respective representation of the representations of the plurality of augmented reality experience and/or a user gaze corresponding to and/or identifying a particular augmented reality experience); and a hardware press input (e.g., a press of a hardware button and/or depression of a depressible input mechanism (e.g., a rotatable and depressible input mechanism)). In some embodiments, the first user input includes a first gaze input and a hardware press input that occur concurrently (e.g., a hardware press input while the user gazes at a particular object and/or a hardware press input while the user gazes at a respective representation of the representations of the plurality of augmented reality experiences). Allowing a user to select a particular augmented reality experience with a gaze and hardware press input enhances the operability of the computer system by helping the user to provide proper inputs and reducing user mistakes when operating/interacting with the computer system.

In some embodiments, the determination that the first user input corresponds to selection of the first representation of the first augmented reality experience comprises a determination that the first user input is a selection input that includes: a voice input indicative of a user request to select a selectable object (e.g., a voice input identifying a particular selectable object; and/or a voice input identifying a respective augmented reality experience of the plurality of augmented reality experiences and/or a respective representation of the representations of the plurality of augmented reality experiences) (e.g., in FIG. 7D1 (and/or in FIG. 7B), the user states “apply the translate extended reality experience” and, in response to the user voice input, electronic device 700 and/or HMD X700 displays the translate extended reality experience, as shown in FIGS. 7I-7J). In some embodiments, in response to receiving the first user input, and in accordance with a determination that the first user input is not a selection input (e.g., in accordance with a determination that the first user input does not include a voice input indicative of a user request to select a selectable object), the computer system forgoes displaying the first augmented reality experience (e.g., the computer system continues to display the stack of representations shown in FIG. 7D1). In some embodiments, in response to receiving the first user input, and in accordance with a determination that the first user input is not a selection input, the computer system forgoes ceasing display of the representations of one or more of the plurality of augmented reality experiences (e.g., the computer system maintains display of the representations of one or more of the plurality of augmented reality experiences). In some embodiments, ceasing display of the representations of one or more of the plurality of augmented reality experiences is performed in accordance with a determination that the first user input is a selection input. In some embodiments, the first user input includes: a first voice input (e.g., a voice input identifying a respective augmented reality experience of the plurality of augmented reality experiences and/or a respective representation of the representations of the plurality of augmented reality experiences). In some embodiments, the first user input includes a first voice input and a first gaze input (e.g., a user gaze directed toward a respective representation of the representations of the plurality of augmented reality experiences) (e.g., in FIG. 7H, a user voice input stating “display this extended reality experience” while looking at representation 726). In some embodiments, the first user input includes a first voice input that occurs concurrently with the first gaze input (e.g., a voice input while the user gazes at a particular object and/or a voice input while the user gazes at a respective representation of the representations of the plurality of augmented reality experiences). Allowing a user to select a particular augmented reality experience with a voice input enhances the operability of the computer system by helping the user to provide proper inputs and reducing user mistakes when operating/interacting with the computer system.

In some embodiments, the determination that the first user input corresponds to selection of the first representation of the first augmented reality experience comprises a determination that the first user input is a selection input that includes: a gaze input (e.g., gaze indication 720 in FIG. 7H) directed toward the first representation of the first augmented reality experience (e.g., 726) (e.g., a user gaze directed toward a selectable object; a user gaze directed toward a respective representation of the representations of the plurality of augmented reality experience and/or a user gaze corresponding to and/or identifying a particular augmented reality experience) that meets a first set of gaze duration criteria (e.g., a user gaze directed toward a selectable object and is maintained on the selectable object for a threshold duration of time (e.g., without interruption and/or with less than a threshold amount of interruption); and/or a user gaze directed toward a respective representation of the representations of the plurality of augmented reality experience and is maintained on the respective representation for a threshold duration of time (e.g., without interruption and/or with less than a threshold amount of interruption)).

In some embodiments, in response to receiving the first user input, and in accordance with a determination that the first user input is not a selection input (e.g., in accordance with a determination that the first user input does not include a gaze input directed toward the first representation of the first augmented reality experience that meets the first set of gaze duration criteria either because the gaze input is not directed toward the first representation of the first augmented reality experience or because the gaze input moves away from the first representation of the first augmented reality experience before the first set of gaze duration criteria has been met), the computer system forgoes displaying the first augmented reality experience (e.g., in some embodiments, in FIG. 7H, if the user maintains his or her gaze on representation 726 for a threshold duration of time, electronic device 700 and/or HMD X700 displays translate extended reality experience 742 as shown in FIGS. 7I-7J, but if the user does not maintain his or her gaze on representation 726 for the threshold duration of time, electronic device 700 maintains display of representations 726, 721 in FIG. 7H). In some embodiments, in response to receiving the first user input, and in accordance with a determination that the first user input is not a selection input, the computer system forgoes ceasing display of the representations of one or more of the plurality of augmented reality experiences (e.g., the computer system maintains display of the representations of one or more of the plurality of augmented reality experiences) (e.g., maintains display of representations 721, 726 in FIG. 7H). In some embodiments, ceasing display of the representations of one or more of the plurality of augmented reality experiences is performed in accordance with a determination that the first user input is a selection input. In some embodiments, the first user input includes a first gaze input (e.g., 710 in FIG. 7H) that meets a first set of gaze duration criteria (e.g., a user gaze directed toward a respective representation of the representations of the plurality of augmented reality experience and is maintained on the respective representation for a threshold duration of time (e.g., without interruption and/or with less than a threshold amount of interruption)). In some embodiments, the determination that the first user input corresponds to selection of the first representation of the first augmented reality experiences includes a determination that the user has gazed at the first representation of the first augmented reality experience for a threshold duration of time (e.g., without interruption and/or with less than a threshold amount of interruption) (e.g., in FIG. 7H, the user has gazed at representation 726 for a threshold duration of time). Allowing a user to select a particular augmented reality experience with a gaze and dwell input enhances the operability of the computer system by helping the user to provide proper inputs and reducing user mistakes when operating/interacting with the computer system.

In some embodiments, while concurrently displaying the representations of the plurality of augmented reality experiences, the computer system displays, via the one or more display generation components, one or more setting controls (e.g., 736a-736h), including a first setting control corresponding to a first setting of the computer system (in some embodiments, the computer system concurrently displays a second setting control corresponding to a second setting of the computer system different from the first setting). While displaying the one or more setting controls, the computer system receives, via the one or more input devices, a first settings input corresponding to the first setting of the computer system (e.g., a user input in FIG. 7G selecting one of settings options 736a-736h and/or modifying a setting). In response to receiving the first settings input, the computer system modifies the first setting from a first value to a second value different from the first value. While concurrently displaying the representations of the plurality of augmented reality experiences and while the first setting is set to the second value, the computer system receives, via the one or more input devices, a third user input (e.g., 740) (e.g., one or more user inputs and/or a third set of user inputs) (e.g., one or more touch inputs, one or more gestures, one or more air gestures, and/or one or more gaze inputs). In response to receiving the third user input: in accordance with a determination that the third user input corresponds to selection of the first representation of the first augmented reality experience (e.g., 720, 724, and/or 726), the computer system displays, via the one or more display generation components, in the three-dimensional environment, the first augmented reality experience (e.g., 714 and/or 742) while maintaining the first setting at the second value; and in accordance with a determination that the first user input corresponds to selection of the second representation of the second augmented reality experience (e.g., 720, 724, and/or 726), the computer system displays, via the one or more display generation components, in the three-dimensional environment, the second augmented reality experience (e.g., 714 and/or 742) while maintaining the first setting at the second value. Displaying the one or more settings controls to modify one or more device settings, and maintaining those settings between different augmented reality experiences allows the user to modify device settings with fewer user inputs, thereby reducing the number of user inputs required to perform an operation.

In some embodiments, the first setting is a passthrough tinting setting (e.g., option 736h) (e.g., a setting that controls how much masking and/or darkening is applied to the three-dimensional environment (e.g., a passthrough background, an optical passthrough background, and/or a virtual passthrough background)); the first value corresponds to a first amount of tinting (e.g., a first amount of masking and/or darkening; and/or a first brightness) applied to the three-dimensional environment; and the second value corresponds to a second amount of tinting (e.g., a second amount of masking and/or darkening; and/or a second brightness) applied to the three-dimensional environment different from the first amount of tinting. Displaying settings controls to modify passthrough tinting, and maintaining passthrough tinting settings between different augmented reality experiences allows the user to modify passthrough tinting settings with fewer user inputs, thereby reducing the number of user inputs required to perform an operation.

In some embodiments, the first setting is a volume setting (e.g., option 736g); the first value corresponds to a first volume; and the second value corresponds to a second volume different from the first volume. Displaying settings controls to modify volume, and maintaining volume settings between different augmented reality experiences allows the user to modify volume settings with fewer user inputs, thereby reducing the number of user inputs required to perform an operation.

In some embodiments, while concurrently displaying the representations of the plurality of augmented reality experiences and the one or more setting controls, the computer system displays, via the one or more display generation components, device status information (e.g., wifi level indication and/or battery level indication at the top right of display 702 and/or display module X702 in FIGS. 7D1-7H) indicative of the status of one or more characteristics of the computer system (e.g., wi-fi network name, wi-fi signal strength, computer system battery level, computer system location tracking indicator, microphone recording indicator, camera recording indicator, and/or volume slider). Displaying the device status information provides the user with visual feedback about the state of the system (e.g., information about the status of one or more characteristics of the computer system), thereby providing improved visual feedback to the user.

In some embodiments, the representations of the plurality of augmented reality experiences (e.g., 720, 721, 724, and/or 726) are viewpoint-locked objects that stay in a respective region of a field of view of a user of the computer system as the viewpoint of the user shifts relative to the three-dimensional environment (e.g., as the viewpoint of the user shifts and background three-dimensional environment 712 moves, representations 720, 721, 724, and/or 726 do not move). Displaying the representations of the plurality of augmented reality experiences as viewpoint-locked objects enhances the operability of the computer system by helping the user to provide proper inputs and reducing user mistakes when operating/interacting with the computer system by keeping the representations of the plurality of augmented reality experiences within the user's view.

In some embodiments, concurrently displaying the representations of the plurality of augmented reality experiences comprises concurrently displaying the representations of the plurality of augmented reality experiences in a first orientation in which the representations of the plurality of augmented reality experiences are aligned to gravity (e.g., in FIG. 7D1, representations 720, 721, 724, and/or 726 are displayed in an orientation such that a bottom surface of representations 720, 721, 724, and/or 726 is directed towards the ground) (e.g., each representation has a bottom portion and a top portion, and the bottom portion is displayed closer to the ground and/or the center of the Earth than the top portion). In some embodiments, while concurrently displaying the representations of the plurality of augmented reality experiences, the computer system detects a change in orientation of the viewpoint of the user (e.g., rotation of electronic device 700 which, for example, causes representations 720, 721, 724, and/or 726 to no longer be aligned to gravity (e.g., the bottom of representations 720, 721, 724, and/or 726 are no longer directed towards the ground)) (e.g., detecting rotation and/or movement of the user's head and/or detecting rotation and/or movement of a headset and/or other wearable device (e.g., a wearable device worn on the user's head)). In response to detecting the change in orientation of the viewpoint of the user: the computer system rotates the representations of the plurality of augmented reality experiences (e.g., 720, 721, 724, and/or 726) from the first orientation to a second orientation (e.g., a second orientation different from the first orientation) based on the change in orientation of the viewpoint of the user to continue to align the representations of the plurality of augmented reality experiences to gravity (e.g., the representations of the plurality of augmented reality experiences are displayed in such a manner that the representations of the plurality of augmented reality experiences remain aligned to gravity (e.g., each representation has a bottom portion and a top portion, and the bottom portion remains closer to the ground and/or the center of the Earth than the top portion, even as the user moves and/or rotates his or her field of view)). In some embodiments, the representations of the plurality of augmented reality experiences are aligned to gravity (e.g., the representations of the plurality of augmented reality experiences are displayed in such a manner that the representations of the plurality of augmented reality experiences remain aligned to gravity (e.g., each representation has a bottom portion and a top portion, and the bottom portion remains closer to the ground and/or the center of the Earth than the top portion, even as the user moves and/or rotates his or her field of view)). In some embodiments, when the computer system detects rotation of the computer system, the computer system rotates the representations of the plurality of augmented reality experiences based on the rotation of the computer system such that a bottom portion of the representations remains closer to the ground and/or the center of the Earth than a top portion of the representations. Displaying the representations of the plurality of augmented reality experiences as viewpoint-locked objects that are aligned to gravity enhances the operability of the computer system by helping the user to provide proper inputs and reducing user mistakes when operating/interacting with the computer system by keeping the representations of the plurality of augmented reality experiences within the user's view and in a consistent alignment, even as the user moves and/or the computer system moves.

In some embodiments, rotating the representations of the plurality of augmented reality experiences (e.g., 720, 721, 724, and/or 726) from the first orientation to the second orientation comprises: at a first time subsequent to detecting the change in orientation of the viewpoint of the user, displaying, via the one or more display generation components, the representations of the plurality of augmented reality experiences in the first orientation, wherein at the first time, the representations of the plurality of augmented reality experiences are not aligned to gravity due, at least in part, to the change in orientation of the viewpoint of the user (e.g., representations 720, 721, 724, and/or 726 are displayed with a bottom edge of the representations not directed towards the ground); and at a second time subsequent to the first time, displaying, via the one or more display generation components, the representations of the plurality of augmented reality experiences in the second orientation to align the representations of the plurality of augmented reality experiences to gravity (e.g., as representations 720, 721, 724, and/or 726 are shown in FIG. 7D1). In some embodiments, the computer system displays gradual rotation of the representations of the plurality of augmented reality experiences from the first orientation to the second orientation over time. In some embodiments, at a third time subsequent to the first time and prior to the second time, the computer system displays, via the one or more display generation components, the representations of the plurality of augmented reality experiences in a third orientation different from the first orientation and the second orientation, wherein the third orientation is between the first orientation and the second orientation (e.g., is at an angle between an angle of the first orientation and an angle of the second orientation). In some embodiments, the representations of the plurality of augmented reality experiences exhibit lazy follow behavior (e.g., behavior which reduces or delays motion of the representations of the plurality of augmented reality experiences relative to detected physical movement of the user (e.g., relative to detected physical movement of the head of the user) and/or relative to detected physical movement of the computer system). Displaying the representations of the plurality of augmented reality experiences as viewpoint-locked objects that exhibit lazy follow behavior provides the user with visual feedback about the state of the system (e.g., that the system is intentionally moving the representations of the plurality of augmented reality experiences as the head of the user moves), thereby providing improved visual feedback to the user.

In some embodiments, displaying the first augmented reality experience (e.g., 742) includes concurrently displaying a first set of objects (e.g., 744a-744d, 750a-750e), including a first object (e.g., 744a-744d) and a second object (e.g., 750a-750e), and wherein: the first object is a viewpoint-locked object (e.g., 744a-744d are viewpoint locked objects); and the second object is an environment-locked object (e.g., 750a-750e are environment-locked objects). In some embodiments, the second augmented reality experience includes a second set of objects, including a third object and a fourth object, wherein the third object is a viewpoint-locked object and the fourth object is an environment-locked object. Displaying certain objects in an AR experience as viewpoint-locked objects and other objects as environment-locked objects enhances the operability of the computer system by helping the user to provide proper inputs and reducing user mistakes when operating/interacting with the computer system.

In some embodiments, the computer system displays, via the one or more display generation components, in the three-dimensional environment (e.g., 712), the first augmented reality experience (e.g., 714 in FIG. 7B). While displaying the first augmented reality experience (e.g., 714 in FIG. 7B), the computer system receives, via the one or more input devices, a first voice input (e.g., an input that includes user input from a user's voice and/or user input spoken by a user) indicative of a user request to change from the first augmented reality experience to the second augmented reality experience (e.g., “switch to the next AR experience” and/or “switch to the camera AR view”). In response to receiving the first voice input, the computer system ceases display of the first augmented reality experience (e.g., ceases display of experience 714); and displays, via the one or more input devices, in the three-dimensional environment (e.g., 712), the second augmented reality experience (e.g., 742 in FIG. 7J). Allowing a user to switch between different augmented reality experiences using voice input enhances the operability of the computer system by helping the user to provide proper inputs and reducing user mistakes when operating/interacting with the computer system. Allowing a user to switch between different augmented reality experiences using voice input allows a user to switch between different augmented reality experiences with fewer user inputs, thereby reducing the number of user inputs required to perform an operation.

In some embodiments, while the computer system is in a sleep state (e.g., FIG. 7A) (e.g., an off state, a locked state, and/or a dormant state), the computer system receives, via the one or more input devices, a first wake input (e.g., 708) (e.g., one or more user inputs and/or a first set of user inputs) (e.g., one or more mechanical inputs (e.g., button press and/or rotation of physical input mechanism), one or more touch inputs, one or more gestures, one or more air gestures, and/or one or more gaze inputs) corresponding to a request to transition the computer system from a sleep state to a wake state. In response to receiving the first wake input (and, in some embodiments, in accordance with a determination that the first wake input meets a first set of wake criteria (e.g., unlock criteria, user authentication criteria, and/or biometric authentication criteria)), the computer system displays, via the one or more display generation components, the first augmented reality experience (e.g., 714 and/or 742) (e.g., without displaying the second augmented reality experience and/or the representations of the plurality of augmented reality experiences). In some embodiments, the first augmented reality experience represents a default augmented reality experience that is displayed upon the computer system transitioning from the sleep state to the wake state. Automatically displaying the first augmented reality experience when the computer system transitions from the sleep state to the wake state allows a user to access the first augmented reality experience with fewer user inputs, thereby reducing the number of user inputs required to perform an operation.

In some embodiments, while the computer system is in a sleep state (e.g., FIG. 7A) (e.g., an off state, a locked state, and/or a dormant state), the computer system receives, via the one or more input devices, a first wake input (e.g., 708) (e.g., one or more user inputs and/or a first set of user inputs) (e.g., one or more mechanical inputs (e.g., button press and/or rotation of physical input mechanism), one or more touch inputs, one or more gestures, one or more air gestures, and/or one or more gaze inputs) corresponding to a request to transition the computer system from a sleep state to a wake state. In response to receiving the first wake input (and, in some embodiments, in accordance with a determination that the first wake input meets a first set of wake criteria (e.g., unlock criteria, user authentication criteria, and/or biometric authentication criteria)), the computer system displays, via the one or more display generation components, the representations of the plurality of augmented reality experiences (e.g., 720, 721, 724, and/or 726 in FIG. 7D1) (e.g., without displaying the first augmented reality experience and/or the second augmented reality experience). In some embodiments, an AR experience switcher user interface that includes the representations of the plurality of augmented reality experiences represents a default user interface that is displayed upon the computer system transitioning from the sleep state to the wake state. Automatically displaying the representations of the plurality of augmented reality experiences when the computer system transitions from the sleep state to the wake state allows a user to access the representations of the plurality of augmented reality experiences with fewer user inputs, thereby reducing the number of user inputs required to perform an operation.

In some embodiments, the plurality of augmented reality experiences includes one or more of: a camera augmented reality experience (e.g., 714) (e.g., an augmented reality experience that includes a shutter button that is selectable to capture more photos and/or videos using one or more cameras of the computer system (e.g., one or more photos and/or videos of the environment surrounding the computer system)) (e.g., an augmented reality experience in which a user is able to capture one or more photos and/or videos of the user's surrounding environment); a translate augmented reality experience (e.g., 742) (e.g., an augmented reality experience that includes one or more options that are selectable to translate text captured by one or more cameras of the computer system (e.g., translate text that is in the environment surrounding the computer system)) (e.g., an augmented reality experience in which a user is able to translate content in the user's environment from a first language to a second language); a reading augmented reality experience (e.g., an augmented reality experience that displays books, articles, and/or other text content) (e.g., an augmented reality experience in which a user is able to read content (e.g., books and/or articles)); a music augmented reality experience (e.g., an augmented reality experience that includes one or more selectable options that are selectable to output audio content (e.g., music and/or other audio content)) (e.g., an augmented reality experience in which a user is able to listen to music and/or other audio content); a navigation augmented reality experience (e.g., an augmented reality experience that displays navigation instructions to a geographic location) (e.g., an augmented reality experience in which a user is able to receive navigation instructions to a geographic location); a photos augmented reality experience (e.g., an augmented reality experience that displays one or more selectable objects and/or user interfaces for navigating through photo and/or video content in a media library) (e.g., an augmented reality experience in which a user is able to navigate through and/or view photo and/or video content in a media library); a video messaging augmented reality experience (e.g., an augmented reality experience that includes one or more selectable options that are selectable to initiate and/or terminate a video conference and/or a video call with one or more contacts) (e.g., an augmented reality experience in which a user is able to participate in a video conference and/or video call with one or more contacts); and/or a workout augmented reality experience (e.g., an augmented reality experience that displays one or more workout metrics and/or physical activity metrics corresponding to a user; and/or an augmented reality experience that displays workout instructions (e.g., a workout video and/or demonstration)) (e.g., an augmented reality experience in which a user is able to track workout and/or physical activity metrics; and/or an augmented reality experience in which the user is able to view workout instructions (e.g., a workout video and/or demonstration)). Concurrently displaying representations of a plurality of augmented reality experiences allows a user to switch between different augmented reality experiences with fewer user inputs, thereby reducing the number of user inputs required to perform an operation.

In some embodiments, aspects/operations of methods 800, 900, 1100, 1300, and/or 1500 may be interchanged, substituted, and/or added between these methods. For example, in some embodiments, the augmented reality experience in method 800 is the extended reality experience in methods 900 and/or 1100. In another example, in some embodiments, the virtual content in method 1500 includes virtual content pertaining to the augmented reality experiences in method 800 and/or the extended reality experiences in methods 900 and/or 1100. In yet another example, in some embodiments, the computer system in method 1300 is the computer system in any one of methods 800, 900, 1100, and/or 1500. For brevity, these details are not repeated here.

FIG. 9 is a flow diagram of an exemplary method 900 for navigating extended reality experiences, in accordance with some embodiments. In some embodiments, method 900 is performed at a computer system (e.g., computer system 101 in FIG. 1A; 700; and/or HMD X700) (e.g., a smart phone, a smart watch, a tablet, a wearable device, and/or head-mounted device) that is in communication with one or more display generation components (e.g., a visual output device, a 3D display, a display having at least a portion that is transparent or translucent on which images can be projected (e.g., a see-through display), a projector, a heads-up display, and/or display controller) and one or more input devices (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; and/or a biometric sensor (e.g., a fingerprint sensor, a face identification sensor, and/or an iris identification sensor)). In some embodiments, method 900 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 900 are, optionally, combined and/or the order of some operations is, optionally, changed.

In some embodiments, the computer system (e.g., 700 and/or HMD X700) receives (900), via a first physical control (e.g., 704a-704c and/or X704a-X704c) (e.g., a physical button, a rotatable input mechanism, a depressible input mechanism, and/or a rotatable and depressible input mechanism) (e.g., a first physical control of the one or more input devices), a first sequence of one or more user inputs (e.g., 718, 727, 729, and/or 740) (e.g., one or more depressions of a depressible input mechanism, one or more rotations of a rotatable input mechanism, and/or one or more depressions and/or rotations of a rotatable and depressible input mechanism). In response to receiving the first sequence of one or more user inputs (904): in accordance with a determination that the first sequence of one or more user inputs has a first magnitude (906) (e.g., amount of movement, speed of movement, and/or duration of input/movement), the computer system displays (908), via the one or more display generation components (e.g., 702 and/or X702), in a three-dimensional environment (e.g., 712), a first extended reality experience (e.g., 714 and/or 742) (e.g., from FIG. 7D1, if the first sequence of one or more user inputs includes only one depression of button 704a and/or button X704a prior to user input 740, computer system 700 and/or HMD X700 displays a extended reality experience corresponding to representation 724 (e.g., a music extended reality experience); and if the first sequence of one or more user inputs includes two depressions of button 704a and/or button X704a prior to user input 740 (as shown in FIGS. 7D1-7J), computer system 700 and/or HMD X700 displays extended reality experience 742 (e.g., a translate extended reality experience)) (e.g., a first extended reality user interface and/or a first extended reality application) (e.g., displaying the first extended reality experience applied to the three-dimensional environment, displaying the first extended reality experience overlaid on the three-dimensional environment, and/or displaying the first extended reality experience concurrently with the three-dimensional environment); and in accordance with a determination that the first sequence of one or more user inputs has a second magnitude (910) (e.g., amount of movement, speed of movement, and/or duration of input/movement) different from the first magnitude, the computer system displays (912), via the one or more display generation components, in the three-dimensional environment, a second extended reality experience (e.g., 714 and/or 742) different from the first extended reality experience (e.g., from FIG. 7D1, if the first sequence of one or more user inputs includes only one depression of button 704a and/or button X704a prior to user input 740, computer system 700 and/or HMD X700 displays an extended reality experience corresponding to representation 724 (e.g., a music extended reality experience); and if the first sequence of one or more user inputs includes two depressions of button 704a and/or button X704a prior to user input 740 (as shown in FIGS. 7D1-7J), computer system 700 and/or HMD X700 displays extended reality experience 742 (e.g., a translate extended reality experience)).

In some embodiments, in response to receiving the first sequence of one or more user inputs: in accordance with a determination that the first user input has the second magnitude and a first direction (e.g., button 704a and/or X704a corresponds to a first direction and button 704b and/or X704b corresponds to a second direction), the computer system displays, via the one or more display generation components, in the three-dimensional environment, a third extended reality experience different from the first extended reality experience (and, in some embodiments, different from the second extended reality experience). In some embodiments, in response to receiving the first sequence of one or more user inputs: in accordance with a determination that the first user input has the first magnitude and a second direction (e.g., button 704a and/or X704a corresponds to a first direction and button 704b and/or X704b corresponds to a second direction), the computer system displays, via the one or more display generation components, in the three-dimensional environment, a fourth extended reality experience different from the first extended reality experiences (and, in some embodiments, different from the second and/or third extended reality experiences). In some embodiments, the computer system is a head-mounted system. In some embodiments, the three-dimensional environment (e.g., 712) is an optical passthrough environment (e.g., the physical, real environment) that is visible to the user through transparent display generation components (e.g., transparent optical lens displays) on which the first extended reality experience (e.g., 714 and/or 742) and the second extended reality experience (e.g., 714 and/or 742) are displayed. In some embodiments, the three-dimensional environment (e.g., 712) is a virtual three-dimensional environment that is displayed by one or more display generation components. In some embodiments, the three-dimensional environment is a virtual passthrough environment (e.g., a virtual passthrough environment that is a virtual representation of the user's physical, real-world environment (e.g., as captured by one or more cameras that are in communication with the computer system)) that is displayed by one or more display generation components. Displaying a first extended reality experience in response to one or more user inputs of a first magnitude on a physical control, and displaying a second extended reality experience in response to one or more user inputs of a second magnitude on the physical control allows a user to switch between different extended reality experiences with fewer user inputs, thereby reducing the number of user inputs required to perform an operation. Displaying the first extended reality experience in accordance with a determination that the first sequence of one or more user inputs has a first magnitude, and displaying the second extended reality experience in accordance with a determination that the first sequence of one or more user inputs has a second magnitude provides the user with visual feedback about the state of the system (e.g., that the system has detected the first user input has a first magnitude or a second magnitude), thereby providing improved visual feedback to the user.

In some embodiments, subsequent to receiving the first sequence of one or more user inputs, the computer system (e.g., 700 and/or X700) receives, via the first physical control (e.g., 704a, 704b, 704c, X704a, X704b, and/or X704c), a second sequence of one or more user inputs (e.g., 718, 727, 729, and/or 740) (e.g., one or more depressions of a depressible input mechanism, one or more rotations of a rotatable input mechanism, and/or one or more depressions and/or rotations of a rotatable and depressible input mechanism). In response to receiving the second sequence of one or more user inputs: in accordance with a determination that the second sequence of one or more user inputs has a first direction (e.g., depression of button 704a and/or X704a corresponds to a first direction and depression of button 704b and/or X704b corresponds to a second direction; and/or rotation of a rotatable input mechanism in a first direction) (e.g., a direction of movement and/or a direction of input), the computer system displays, via the one or more display generation components (e.g., 702 and/or X702), in the three-dimensional environment (e.g., 712), a third extended reality experience (e.g., 714 and/or 742) (e.g., a third extended reality user interface and/or a third extended reality application) (e.g., displaying the third extended reality experience applied to the three-dimensional environment, displaying the third extended reality experience overlaid on the three-dimensional environment, and/or displaying the third extended reality experience concurrently with the three-dimensional environment); and in accordance with a determination that the second sequence of one or more user inputs has a second direction different from the first (e.g., depression of button 704a corresponds to a first direction and depression of button 704b corresponds to a second direction; and/or rotation of a rotatable input mechanism in a second direction), the computer system displays, via the one or more display generation components (e.g., 702 and/or X702), in the three-dimensional environment (e.g., 712), a fourth extended reality experience (e.g., 714 and/or 742) different from the third extended reality experience. In some embodiments, displaying the third extended reality experience comprises displaying a first set of visual content (e.g., objects 716a-716e in FIG. 7B and/or objects 744a-744d in FIG. 7J) overlaid on the three-dimensional environment (e.g., 712); and displaying the fourth extended reality experience comprises displaying a second set of visual content different from the first set of visual content overlaid on the three-dimensional environment. In some embodiments, displaying the third extended reality experience includes displaying a first set of selectable objects (e.g., objects 716a-716e in FIG. 7B and/or objects 744a-744d in FIG. 7J), and displaying the fourth extended reality experience includes displaying a second set of selectable objects different from the first set of selectable objects. In some embodiments, the third extended reality experience corresponds to a first color, and displaying the third extended reality experience includes displaying a first set of elements that are displayed in the first color; and the fourth extended reality experience corresponds to a second color, and displaying the fourth extended reality experience includes displaying a second set of elements that are displayed in the second color. In some embodiments, the third extended reality experience does not include the second color and/or the fourth extended reality experience does not include the first color. In some embodiments, the third extended reality experience corresponds to a first experience name (e.g., camera, translate, music, or another extended reality experience) and displaying the third extended reality experience includes displaying the first experience name; and the fourth extended reality experience corresponds to a second experience name different from the first experience name, and displaying the fourth extended reality experience includes displaying the second experience name. In some embodiments, the third extended reality experience corresponds to a first experience logo, and displaying the third extended reality experience includes displaying the first experience logo; and the fourth extended reality experience corresponds to a second experience logo different from the first experience logo, and displaying the fourth extended reality experience includes displaying the second experience logo. Displaying a third extended reality experience in response to one or more user inputs of a first direction on a physical control, and displaying a fourth extended reality experience in response to one or more user inputs of a second direction on the physical control allows a user to switch between different extended reality experiences with fewer user inputs, thereby reducing the number of user inputs required to perform an operation.

In some embodiments, the computer system displays, via the one or more display generation components (e.g., 702 and/or X702), a representation of the first extended reality experience (e.g., 720, 721, 724, and/or 726) in a first manner (e.g., at the top of a stack of representations of extended reality experiences, such as representation 720 in FIG. 7D1, representation 724 in FIG. 7E, and/or representation 726 in FIG. 7F) (e.g., at a first display position and/or with a first set of visual characteristics (e.g., brightness, color, and/or saturation)) indicating that a selection input would cause the first extended reality experience to be displayed (e.g., without causing the second extended reality experience to be displayed and/or any other extended reality experience to be displayed) (and, in some embodiments, concurrently displays a representation of the second extended reality experience in a second manner different from the first manner (e.g., at a second display position different from the first display position and/or with a second set of visual characteristics different from the first set of visual characteristics) (e.g., a second manner indicating that a selection input would not cause the second extended reality experience to be displayed)). While displaying the representation of the first extended reality experience in the first manner, the computer system receives, via the first physical control (e.g., 704a, 704b, 704c, X704a, X704b, and/or X704c), a second sequence of one or more user inputs (e.g., 727 and/or 729) (e.g., one or more depressions of a depressible input mechanism, one or more rotations of a rotatable input mechanism, and/or one or more depressions and/or rotations of a rotatable and depressible input mechanism). In response to receiving the second sequence of one or more user inputs, the computer system ceases display of the representation of the first extended reality experience in the first manner (e.g., from FIGS. 7D1-7E, in response to user input 727, electronic device 700 and/or HMD X700 ceases display of representation 720 at the top of the stock; and from FIGS. 7E-7F, in response to user input 729, electronic device 700 and/or HMD X700 ceases display of representation 724 at the top of the stack) (e.g., ceases display of the representation of the first extended reality experience and/or displays the representation of the first extended reality experience in a second manner different from the first manner); and displays, via the one or more display generation components, a representation of the second extended reality experience in the first manner (e.g., from FIGS. 7D1-7E, in response to user input 727, electronic device 700 and/or HMD X700 displays representation 724 at the top of the stack; and from FIGS. 7E-7F, in response to user input 729, electronic device 700 and/or HMD X700 displays representation 726 at the top of the stack). Providing feedback about which extended reality experience is currently selected and/or would be selected if a selection input was received enhances the operability of the computer system by helping the user to provide proper inputs and reducing user mistakes when operating/interacting with the computer system.

In some embodiments, while displaying the representation of the second extended reality experience in the first manner (e.g., representation 720 in FIG. 7D1; representation 724 in FIG. 7E; and/or representation 726 in FIG. 7F), the computer system receives, via the first physical control, a third sequence of one or more user inputs (e.g., 727 and/or 729) (e.g., one or more depressions of a depressible input mechanism, one or more rotations of a rotatable input mechanism, and/or one or more depressions and/or rotations of a rotatable and depressible input mechanism). In response to receiving the third sequence of one or more user inputs: in accordance with a determination that the third sequence of one or more user inputs has a third direction (e.g., button 704a and/or X704a corresponds to a first direction and button 704b and/or X704b corresponds to a second direction) (e.g., a direction of movement and/or a direction of input), the computer system scrolls representations of a plurality of extended reality experiences (e.g., 720, 721, 724, and/or 726) (e.g., including a representation of the first extended reality experience and/or a representation of the second extended reality experience) in a fourth direction (e.g., a fourth direction corresponding to user input in the third direction); and in accordance with a determination that the third sequence of one or more user inputs has a fifth direction different from the third direction, the computer system scrolls the representations of the plurality of extended reality experiences (e.g., 720, 721, 724, and/or 726) in a sixth direction different from the fourth direction (e.g., a sixth direction corresponding to user input in the fifth direction) (e.g., selection of button 704a causes scrolling of representations 720, 721, 724, and/or 726 in a first direction, and selection of button 704b causes scrolling of representations 720, 7211, 724, and/or 726 in a second direction). In some embodiments, a user provides the scrolling user input via a rotatable input mechanism, such that rotation of the rotatable input mechanism in a first direction causes rotation of the representations 720, 721, 724, and/or 726 in a second direction, and rotation of the rotatable input mechanism in a third direction causes rotation of the representations 720, 721, 724, and/or 726 in a fourth direction. Displaying scrolling of representations of extended reality experiences based on the direction of user input, and providing feedback about which extended reality experience is currently selected and/or would be selected if a selection input was received enhances the operability of the computer system by helping the user to provide proper inputs and reducing user mistakes when operating/interacting with the computer system.

In some embodiments, while displaying the representation of the second extended reality experience in the first manner (e.g., representation 720 in FIG. 7D1; representation 724 in FIG. 7E; and/or representation 726 in FIG. 7F), the computer system receives, via the first physical control (e.g., 704a, 704b, 704c, X704a, X704b, and/or X704c), a fourth sequence of one or more user inputs (e.g., 727 and/or 729) (e.g., one or more depressions of a depressible input mechanism, one or more rotations of a rotatable input mechanism, and/or one or more depressions and/or rotations of a rotatable and depressible input mechanism). In response to receiving the fourth sequence of one or more user inputs: in accordance with a determination that the fourth sequence of one or more user inputs has a third magnitude (e.g., the number of depressions of button 704a, 704b, X704a, and/or X704b; and/or an amount of rotation of a rotatable input mechanism), the computer system scrolls representations of a plurality of extended reality experiences (e.g., including a representation of the first extended reality experience and/or a representation of the second extended reality experience) by a first amount (e.g., advancing the representations of the plurality of extended reality experience by a first number of representations) (e.g., a first amount corresponding to a user input of the third magnitude); and in accordance with a determination that the fourth sequence of one or more user inputs has a fourth magnitude different from the third magnitude, scrolling the representations of the plurality of extended reality experiences by a second amount (e.g., advancing the representations of the plurality of extended reality experience by a second number of representations) (e.g., a second amount corresponding to a user input of the fourth magnitude) different from the first amount. Displaying scrolling of representations of extended reality experiences based on the magnitude of user input, and providing feedback about which extended reality experience is currently selected and/or would be selected if a selection input was received enhances the operability of the computer system by helping the user to provide proper inputs and reducing user mistakes when operating/interacting with the computer system.

In some embodiments, receiving, via the first physical control (e.g., 704a, 704b, 704c, X704a, X704b, and/or X704c), the first sequence of one or more user inputs (e.g., 718, 727, 729, and/or 740) includes: receiving, via the first physical control, a first input (e.g., 718) (e.g., one or more depressions of a depressible input mechanism, one or more rotations of a rotatable input mechanism, and/or one or more depressions and/or rotations of a rotatable and depressible input mechanism) corresponding to a request to exit a currently displayed extended reality experience (e.g., a first input that is received while displaying a first respective extended reality experience, and corresponding to a request to exit the first respective extended reality experience (e.g., cease displaying the first respective extended reality experience)) (in some embodiments, the first input corresponds to a request to display an experience switcher user interface (in some embodiments, the experience switcher user interface includes representations of a plurality of extended reality experiences)); and receiving, via the first physical control, a second input (e.g., 740) (e.g., one or more depressions of a depressible input mechanism, one or more rotations of a rotatable input mechanism, and/or one or more depressions and/or rotations of a rotatable and depressible input mechanism) corresponding to a request to select (e.g., identify and/or choose) a next extended reality experience for display (e.g., a second input corresponding to a request to display a second respective extended reality experience). Switching from one extended reality experience to a different extended reality experience in response to one or more user inputs on the physical control allows a user to switch between different extended reality experiences with fewer user inputs, thereby reducing the number of user inputs required to perform an operation.

In some embodiments, in response to receiving the first input (e.g., 718) corresponding to a request to exit a currently displayed extended reality experience (e.g., 714 in FIG. 7B), the computer system displays, via the one or more display generation components, a first animation (e.g., FIGS. 7B-7D1 and/or 7D2-7D4) in which a representation of the currently displayed extended reality experience (e.g., 720 in FIG. 7C and/or 7D3 is a representation of extended reality experience 714 of FIG. 7B and/or 7D2) moves away from a viewpoint of a user of the computer system (e.g., in which the representation of the currently displayed extended reality experience becomes smaller and/or appears to move further away from the user's viewpoint). Displaying an animation in which the representation of the currently displayed extended reality experience moves away from a viewpoint of the user provides the user with visual feedback about the state of the system (e.g., that the system is exiting the currently displayed extended reality experience), thereby providing improved visual feedback to the user.

In some embodiments, receiving, via the first physical control, the first sequence of one or more user inputs further includes: subsequent to receiving the first input and prior to receiving the second input, receiving, via the first physical control (e.g., 704a, 704b, 704c, X704a, X704b, and/or X704c), a navigation input (e.g., 727 and/or 729; and/or rotation of a rotatable input mechanism) (e.g., a scrolling input and/or a movement input) (e.g., navigation from a representation of a first respective extended reality experience of a plurality of extended reality experiences to a second respective extended reality experience of the plurality of extended reality experiences); and the first input (e.g., 718) includes a press input on the first physical control (e.g., 704a, X704a, and/or a press input on a rotatable and depressible input mechanism) (e.g., pressing of and/or depression of the first physical control). Switching from one extended reality experience to a different extended reality experience in response to one or more user inputs on the physical control allows a user to switch between different extended reality experiences with fewer user inputs, thereby reducing the number of user inputs required to perform an operation.

In some embodiments, the navigation input (e.g., 727 and/or 729) includes rotation of the first physical control (e.g., rotation of a rotatable input mechanism). Switching from one extended reality experience to a different extended reality experience in response to one or more user inputs on the physical control allows a user to switch between different extended reality experiences with fewer user inputs, thereby reducing the number of user inputs required to perform an operation.

In some embodiments, displaying the first extended reality experience (e.g., 714 and/or 742) includes concurrently displaying a first set of objects (e.g., 716a-716e, 744a-744d, and/or 746), including a first object and a second object, and wherein: the first object is a viewpoint-locked object; and the second object is an environment-locked object. In some embodiments, the second extended reality experience includes a second set of objects, including a third object and a fourth object, wherein the third object is a viewpoint-locked object and the fourth object is an environment-locked object. Displaying certain objects in an XR experience as viewpoint-locked objects and other objects as environment-locked objects enhances the operability of the computer system by helping the user to provide proper inputs and reducing user mistakes when operating/interacting with the computer system.

In some embodiments, while the computer system is in a low power state (e.g., FIG. 7A) (e.g., a sleep state, an off state, a locked state, and/or a dormant state), the computer system receives, via the one or more input devices, a first wake input (e.g., 708) (e.g., one or more user inputs and/or a first set of user inputs) (e.g., one or more mechanical inputs (e.g., button press and/or rotation of physical input mechanism), one or more touch inputs, one or more gestures, one or more air gestures, and/or one or more gaze inputs) corresponding to a request to transition the computer system from the low power state to a higher power state (e.g., a wake state). In response to receiving the first wake input (and, in some embodiments, in accordance with a determination that the first wake input meets a first set of wake criteria (e.g., unlock criteria, user authentication criteria, and/or biometric authentication criteria)), the computer system displays, via the one or more display generation components, the first extended reality experience (e.g., 714 in FIG. 7B) (e.g., without displaying the second extended reality experience). In some embodiments, the computer system, when in the low power state, utilizes less power (e.g., electrical power and/or battery power) than when the computer system is in the high power state. For example, the computer system utilizes less power in the low power state by operating one or more display generation components at a lower brightness, de-activating and/or turning off one or more sensors, operating one or more sensors at a decreased level of sensitivity, de-activating one or more processors, and/or operating one or more processors at a lower power level (e.g., decreasing processor speed and/or efficiency for decreased power usage). In some embodiments, the first extended reality experience represents a default extended reality experience that is displayed upon the computer system transitioning from the low power state to the higher power state. Automatically displaying the first extended reality experience when the computer system transitions from the sleep state to the wake state allows a user to access the first extended reality experience with fewer user inputs, thereby reducing the number of user inputs required to perform an operation.

In some embodiments, while the computer system is in a low power state (e.g., FIG. 7A) (e.g., a sleep state, an off state, a locked state, and/or a dormant state), the computer system receives, via the one or more input devices, a first wake input (e.g., 708) (e.g., one or more user inputs and/or a first set of user inputs) (e.g., one or more mechanical inputs (e.g., button press and/or rotation of physical input mechanism), one or more touch inputs, one or more gestures, one or more air gestures, and/or one or more gaze inputs) corresponding to a request to transition the computer system from the low power state to a high power state (e.g., a wake state). In response to receiving the first wake input (and, in some embodiments, in accordance with a determination that the first wake input meets a first set of wake criteria (e.g., unlock criteria, user authentication criteria, and/or biometric authentication criteria)), the computer system concurrently displays, via the one or more display generation components, representations of a plurality of extended reality experiences (e.g., 720, 721, 724, and/or 726) (e.g., without displaying the first extended reality experience and/or the second extended reality experience), including concurrently displaying: a representation of the first extended reality experience; and a representation of the second extended reality experience separate from the representation of the first extended reality experience. In some embodiments, an experience switcher user interface that includes the representations of the plurality of extended reality experiences represents a default user interface that is displayed upon the computer system transitioning from the low power state to the high power state. In some embodiments, the computer system, when in the low power state, utilizes less power (e.g., electrical power and/or battery power) than when the computer system is in the high power state. For example, the computer system utilizes less power in the low power state by operating one or more display generation components at a lower brightness, de-activating and/or turning off one or more sensors, operating one or more sensors at a decreased level of sensitivity, de-activating one or more processors, and/or operating one or more processors at a lower power level (e.g., decreasing processor speed and/or efficiency for decreased power usage). Automatically displaying the representations of the plurality of extended reality experiences when the computer system transitions from the sleep state to the wake state allows a user to access the representations of the plurality of extended reality experiences with fewer user inputs, thereby reducing the number of user inputs required to perform an operation.

In some embodiments, the computer system receives, via the first physical control (e.g., 704a-704c, X704a-X704c, and/or a rotatable input mechanism), a fourth sequence of one or more user inputs (e.g., one or more depressions of a depressible input mechanism, one or more rotations of a rotatable input mechanism, and/or one or more depressions and/or rotations of a rotatable and depressible input mechanism). In response to receiving the fourth sequence of one or more user inputs, the computer system modifies a volume setting of the computer system (e.g., increasing and/or decreasing the volume of the computer system). Allowing a user to use the same physical control to adjust volume and also to switch between extended reality experiences enhances the operability of the computer system by decreasing the number of physical controls on the computer system.

In some embodiments, the computer system receives, via the first physical control (e.g., 704a-704c, X704a-X704c, and/or a rotatable input mechanism), a fifth sequence of one or more user inputs (e.g., one or more depressions of a depressible input mechanism, one or more rotations of a rotatable input mechanism, and/or one or more depressions and/or rotations of a rotatable and depressible input mechanism). In response to receiving the fifth sequence of one or more user inputs, modifying a passthrough tinting setting (e.g., a setting that controls how much masking and/or darkening is applied to the three-dimensional environment (e.g., a passthrough background, an optical passthrough background, and/or a virtual passthrough background)) of the computer system. Allowing a user to use the same physical control to adjust passthrough tinting and also to switch between extended reality experiences enhances the operability of the computer system by decreasing the number of physical controls on the computer system.

In some embodiments, aspects/operations of methods 800, 900, 1100, 1300, and/or 1500 may be interchanged, substituted, and/or added between these methods. For example, in some embodiments, the augmented reality experience in method 800 is the extended reality experience in methods 900 and/or 1100. In another example, in some embodiments, the virtual content in method 1500 includes virtual content pertaining to the augmented reality experiences in method 800 and/or the extended reality experiences in methods 900 and/or 1100. In yet another example, in some embodiments, the computer system in method 1300 is the computer system in any one of methods 800, 900, 1100, and/or 1500. For brevity, these details are not repeated here.

FIGS. 10A-10G illustrate examples of techniques for providing suggestions pertaining to extended reality experiences. FIG. 11 is a flow diagram of an exemplary method 1100 for providing suggestions pertaining to extended reality experiences. The user interfaces in FIGS. 10A-10G are used to illustrate the processes described below, including the processes in FIG. 11.

FIG. 10A depicts electronic device 700, which is a smartphone that includes touch-sensitive display 702, buttons 704a-704c, and one or more input sensors 706 (e.g., one or more cameras, eye gaze trackers, hand movement trackers, and/or head movement trackers). In some embodiments described below, electronic device 700 is a smartphone. In some embodiments, electronic device 700 is a tablet, a wearable device, a wearable smartwatch device, a head-mounted system (e.g., a headset), or other computer system that includes and/or is in communication with one or more display devices (e.g., display screen, projection device, or the like). Electronic device 700 is a computer system (e.g., computer system 101 in FIG. 1A).

In FIG. 10A, electronic device 700 displays camera extended reality experience 714 (e.g., an augmented reality experience and/or a virtual reality experience), which was discussed above with reference to FIGS. 7A-7K. Camera extended reality experience 714 is displayed overlaid on three-dimensional environment 712. As discussed above, in some embodiments, three-dimensional environment 712 is displayed by a display (as depicted in FIG. 10A). In some embodiments, three-dimensional environment 712 includes a virtual environment or an image (or video) of a physical environment captured by one or more cameras (e.g., one or more cameras that are part of input sensors 706 and/or one or more cameras that are not shown in FIG. 10A). In some embodiments, three-dimensional environment 712 is visible to a user behind camera extended reality experience 714, but is not displayed by a display. For example, in some embodiments, three-dimensional environment 712 is a physical environment that is visible to a user (e.g., through a transparent display) behind extended reality experience 712 without being displayed by a display.

At FIG. 10B1, electronic device 700 detects audio content that is being played (e.g., via one or more microphones and/or input sensors 706) in the physical environment surrounding electronic device 700. Electronic device 700 determines that the audio content is a song, and identifies the song and the artist. In response to detecting the audio content that is being played in the environment of electronic device 700, electronic device 700 displays suggestion 1000. Suggestion 1000 corresponds to a music extended reality experience, and is selectable by a user to display the music extended reality experience. For example, in the depicted embodiments, selection of suggestion 1000 causes the detected song to be added to a playlist within the music extended reality experience. In some embodiments, selection of suggestion 1000 causes electronic device 700 to cease display of camera extended reality experience 714 and display the music extended reality experience. In some embodiments, selection of suggestion 1000 causes electronic device 700 to display the music extended reality experience while maintaining display of camera extended reality experience 714 (e.g., display the two extended reality experiences concurrently and/or portions of the two extended reality experiences concurrently).

In some embodiments, the techniques and user interface(s) described in FIGS. 10A-10G are provided by one or more of the devices described in FIGS. 1A-1P. For example, FIG. 10B2 illustrates an embodiment in which suggestion 1000 described in FIG. 10B1 is displayed on display module X702 of head-mounted device (HMD) X700. In some embodiments, device X700 includes a pair of display modules that provide stereoscopic content to different eyes of the same user. For example, HMD X700 includes display module X702 (which provides content to a left eye of the user) and a second display module (which provides content to a right eye of the user). In some embodiments, the second display module displays a slightly different image than display module X702 to generate the illusion of stereoscopic depth.

At FIG. 10B2, HMD X700 detects audio content that is being played (e.g., via one or more microphones and/or input sensors 706) in the physical environment surrounding HMD X700. HMD X700 determines that the audio content is a song, and identifies the song and the artist. In response to detecting the audio content that is being played in the environment of HMD X700, HMD X700 displays suggestion 1000. Suggestion 1000 corresponds to a music extended reality experience, and is selectable by a user to display the music extended reality experience. For example, in the depicted embodiments, selection of suggestion 1000 causes the detected song to be added to a playlist within the music extended reality experience. In some embodiments, selection of suggestion 1000 causes HMD X700 to cease display of camera extended reality experience 714 and display the music extended reality experience. In some embodiments, selection of suggestion 1000 causes HMD X700 to display the music extended reality experience while maintaining display of camera extended reality experience 714 (e.g., display the two extended reality experiences concurrently and/or portions of the two extended reality experiences concurrently).

Any of the features, components, and/or parts, including the arrangements and configurations thereof shown in FIGS. 1B-1P can be included, either alone or in any combination, in HMD X700. For example, in some embodiments, HMD X700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module X702 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, HMD X700 includes a sensor that includes any of the features, components, and/or parts of any of sensors 190, sensors 306, image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, HMD X700 includes one or more input devices, which include any of the features, components, and/or parts of any of first button 1-128, button 11.1.1-114, second button 1-132, and or dial or button 1-328, either alone or in any combination. In some embodiments, HMD X700 includes one or more audio output components (e.g., electronic component 1-112) for generating audio feedback (e.g., audio output X714-3), optionally generated based on detected events and/or user inputs detected by the HMD X700.

In FIG. 10C, the user has not yet selected suggestion 1000, but the viewpoint of electronic device 700 has changed, as indicated by movement of three-dimensional environment 712 from FIGS. 10B1-10C. In some embodiments, suggestion 1000 is displayed as a viewpoint-locked object, such that even as the viewpoint of electronic device 700 changes, suggestion 1000 is displayed in the same position on display 702. In some embodiments, electronic device 700 is a head-mounted system, and is worn on the head of a user such that movement of the user's head (e.g., changing of the viewpoint of the user) also causes corresponding changes in the viewpoint of electronic device 700. In some such embodiments, suggestion 1000 is displayed as a viewpoint-locked object such that even as the viewpoint of the user changes (and the viewpoint of electronic device 700 also changes due to electronic device 700 being mounted to the user's head), suggestion 1000 continues to be displayed on the same region of one or more display generation components. In some embodiments, suggestion 1000 is displayed as an object that is aligned to gravity. For example, in FIGS. 10B1-10C, suggestion 1000 is displayed in an orientation that is aligned to gravity because the bottom edge of suggestion 1000 and/or the bottom portions of letters in suggestion 1000 are directed towards the ground (and/or the center of the Earth), and the top edge of suggestion 1000 and/or the top portions of letters in suggestion 1000 are directed towards the sky. In some embodiments, as the orientation of electronic device 700 and/or the orientation of the viewpoint of the user changes (e.g., electronic device 700 is rotated and/or the head of the user rotates while electronic device 700 is mounted to the user's head), suggestion 1000 is rotated in a corresponding manner so that suggestion 1000 continues to remain aligned to gravity.

At FIG. 10D, electronic device 700 detects that a threshold amount of time has passed without user interaction with suggestion 1000 (e.g., without the user selecting suggestion 1000). In response to this determination, electronic device 700 ceases display of suggestion 1000.

At FIG. 10E, three-dimensional environment 712 has changed to now show a menu. For example, electronic device 700 has been moved and/or objects have been moved in front of electronic device 700 such that electronic device 700 is now pointed at a menu. Electronic device 700 detects, based on visual content captured by one or more cameras (e.g., input sensors 706), text that can be translated (e.g., the text on the menu). In response to this determination, electronic device 700 displays suggestion 1004, which is selectable to display a translate extended reality experience (e.g., at least a portion of a translate extended reality experience), including a translation of the menu text to a different language. In FIG. 10E, electronic device 700 detects that the user is looking at suggestion 1004 (as indicated by gaze indication 710) (e.g., via input sensors 706), and detects user input 1006. In the depicted embodiment, user input 1006 is a button press input via button 704c. However, in some embodiments, user input 1006 is a different type of input, such as a gesture or other action taken by a user. For example, in some embodiments, electronic device 700 is a head-mounted system, and user input 1006 includes, for example, a user performing a gesture (e.g., an air gesture) while wearing electronic device 700, pressing a button while wearing electronic device 700, rotating a rotatable input mechanism while wearing electronic device 700, providing a gaze-based gesture (e.g., looking at an object and/or moving his or her gaze in a particular manner), and/or any combination of the forgoing.

At FIG. 10F, in response to user input 1006 (e.g., in response to detecting user input 1006 while the user is gazing at suggestion 1004), electronic device 700 ceases display of suggestion 1004, and displays translation objects 1008a-1008e which are part of a translation extended reality experience (e.g., translation extended reality experience 742 of FIGS. 7A-7K). In the depicted embodiment, translation objects 1008a-1008e are displayed while maintaining display of camera extended reality experience 714, such that at least a portion of the translation extended reality experience is displayed concurrently with at least a portion of camera extended reality experience 714. In some embodiments, in response to user input 1006, electronic device 700 replaces display of camera extended reality experience 714 with the translation extended reality experience (e.g., translation extended reality experience 742 of FIGS. 7A-7K). In some embodiments, translation objects 1008a-1008e are environment-locked objects (or world-locked objects) that move on display 702 based on movement of the corresponding menu text. In some embodiments, objects 716a-716e of camera extended reality experience 714 are viewpoint locked objects that maintain their display positions even as the viewpoint of the user and/or electronic device 700 changes.

FIG. 10G illustrates another example scenario, in which the user is walking outside, and three-dimensional environment 712 shows the user and/or electronic device 700 on a sidewalk. In various embodiments, based on various contextual criteria (e.g., based on the user's location and/or the location of electronic device 700, based on the day of the week, and/or based on the time of day), electronic device 700 determines that the user may be going to work. In response to this determination, electronic device 700 displays suggestion 1010, which corresponds to a navigation extended reality experience. In some embodiments, suggestion 1010 is selectable to display the navigation extended reality experience which, in some embodiments, displays navigation instructions overlaid on three-dimensional environment 712.

Additional descriptions regarding FIGS. 10A-10G are provided below in reference to method 1100 described with respect to FIGS. 10A-10G.

FIG. 11 is a flow diagram of an exemplary method 11100 for providing suggestions pertaining to extended reality experiences, in accordance with some embodiments. In some embodiments, method 1100 is performed at a computer system (e.g., 700 and/or X700) (e.g., computer system 101 in FIG. 1A) (e.g., a smart phone, a smart watch, a tablet, a wearable device, and/or head-mounted device) that is in communication with one or more display generation components (e.g., 702 and/or X702) (e.g., a visual output device, a 3D display, a display having at least a portion that is transparent or translucent on which images can be projected (e.g., a see-through display), a projector, a heads-up display, and/or display controller) and one or more input devices (e.g., 702, 704a-704c, 706, X702, X704a-X704c, and/or X706) (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; and/or a biometric sensor (e.g., a fingerprint sensor, a face identification sensor, and/or an iris identification sensor)). In some embodiments, the method 1100 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1100 are, optionally, combined and/or the order of some operations is, optionally, changed.

In some embodiments, while a view of a three-dimensional environment (e.g., 712) in which the computer system (e.g., 700 and/or X700) is located is visible (1102) (e.g., within a field of view of the computer system and/or via one or more cameras of the computer system), the computer system detects (1104), via the one or more input devices (e.g., 706 and/or X706), a first set of conditions in the three-dimensional environment (e.g., a physical environment within which the computer system is located and/or surrounding the computer system). In some embodiments, the first set of conditions includes one or more of: a first location (e.g., detecting that the computer system is located at a first location), a first time, a first date, a first set of visual conditions (e.g., a first set of items within a field of view of the user and/or within a field of view of one or more cameras of the computer system); and/or a first set of audio conditions (e.g., a first set of audio content that is received and/or detected by the computer system from the environment of the computer system). In some embodiments, detecting the first set of conditions in the environment of the computer system includes detecting a change in conditions in the environment of the computer system from a second set of conditions to the first set of conditions. In response to detecting the first set of conditions in the three-dimensional environment (1106): the computer system displays (1108), via the one or more display generation components (e.g., 702 and/or X702) and concurrently with at least a portion of the view of the three-dimensional environment (e.g., 712) of the computer system, a first suggestion (e.g., 1000, 1004, and/or 1010) that corresponds to a first augmented reality experience, wherein the first augmented reality experience is selected (e.g., based on the first set of conditions) from a plurality of augmented reality experiences available to be displayed by the computer system (e.g., without displaying a suggestion corresponding to a second augmented reality experience of the plurality of augmented reality experiences).

In some embodiments, the first augmented reality experience corresponds to a first application. In some embodiments, while displaying the first suggestion, the computer system receives, via the one or more input devices, a first user input (e.g., 1006 and/or 710) (e.g., one or more user inputs and/or a first set of user inputs) (e.g., one or more touch inputs, one or more gestures, one or more air gestures, and/or one or more gaze inputs) corresponding to selection of the first suggestion; and in response to receiving the first user input, the computer system displays, via the one or more display generation components, the first augmented reality experience (e.g., 714 and/or 1008a-1008e). In some embodiments, the computer system detects a second set of conditions in an environment of the computer system different from the first set of conditions; and in response to detecting the second set of conditions in the environment of the computer system, the computer system displays a second suggestion (e.g., 1000, 1004, and/or 1010) that corresponds to a second augmented reality experience different from the first augmented reality experience and that is selected from the plurality of augmented reality experiences based on the second set of conditions (e.g., without displaying the first suggestion and/or a suggestion corresponding to the first augmented reality experience).

In some embodiments, the computer system is a head-mounted system. In some embodiments, the three-dimensional environment (e.g., 712) is an optical passthrough environment (e.g., the physical, real environment) that is visible to the user through transparent display generation components (e.g., transparent optical lens displays) on which the first suggestion and/or the first augmented reality experience are displayed. In some embodiments, the three-dimensional environment (e.g., 712) of the computer system is an optical passthrough environment, and the first suggestion is displayed concurrently with at least a portion of the view of the three-dimensional environment of the computer system by displaying the first suggestion while at least a portion of the three-dimensional environment of the computer system is visible through one or more transparent displays on which the first suggestion is displayed. In some embodiments, the three-dimensional environment (e.g., 712) is a virtual three-dimensional environment that is displayed by one or more display generation components. In some embodiments, the three-dimensional environment (e.g., 712) is a virtual passthrough environment (e.g., a virtual passthrough environment that is a virtual representation of the user's physical, real-world environment (e.g., as captured by one or more cameras that are in communication with the computer system)) that is displayed by one or more display generation components. Displaying the first suggestion that corresponds to the first augmented reality experience in response to detecting the first set of conditions in the three-dimensional environment allows a user to activate a relevant augmented reality experience with fewer user inputs, thereby reducing the number of user inputs required to perform an operation. Displaying the first suggestion that corresponds to the first augmented reality experience in response to detecting the first set of conditions in the three-dimensional environment provides the user with visual feedback about the state of the system (e.g., that the system has detected the first set of conditions in the three-dimensional environment), thereby providing improved visual feedback to the user.

In some embodiments, while a view of a second three-dimensional environment (e.g., 712) (e.g., the same as the three-dimensional environment and/or different from the three-dimensional environment) is visible (e.g., within a field of view of the computer system and/or via one or more cameras of the computer system), the computer system detects, via the one or more input devices (e.g., 706 and/or X706), one or more objects in the second three-dimensional environment (e.g., in FIG. 10E, electronic device 700 and/or HMD X700 detects menu text) (e.g., one or more objects identified in video content captured by one or more cameras of the computers system and/or one or more objects identified by the computer system (e.g., based on automated image recognition and/or automated object recognition)). In response to detecting the first set of objects in the second three-dimensional environment: in accordance with a determination that the one or more objects in the second three-dimensional environment include a first set of objects, the computer system displays, via the one or more display generation components and concurrently with at least a portion of the view of the second three-dimensional environment (e.g., 712), a second suggestion (e.g., 1000, 1004, and/or 1010) that corresponds to a second augmented reality experience; and in accordance with a determination that the one or more objects in the second three-dimensional environment include a second set of objects different from the first set of objects, the computer system displays, via the one or more display generation components and concurrently with at least a portion of the view of the second three-dimensional environment, (e.g., 712) a third suggestion (e.g., 1000, 1004, and/or 1010) that corresponds to a third augmented reality experience that is different from the second augmented reality experience (e.g., without displaying the second suggestion that corresponds to the second augmented reality experience). Automatically displaying suggestions for augmented reality experiences based on objects detected in the three-dimensional environment and/or based on the user's location allows a user to activate a relevant augmented reality experience with fewer user inputs, thereby reducing the number of user inputs required to perform an operation.

In some embodiments, the first augmented reality experience (e.g., 714, and/or 1008a-1008e) is selected from the plurality of augmented reality experiences available to be displayed by the computer system based on audio content received (e.g., detected and/or measured) by the computer system (e.g., in FIGS. 10B1-10C, electronic device 700 and/or HMD X700 displays suggestion 1000 corresponding to a music extended reality experience based on music playing nearby) (e.g., audio content received by one or more microphones of the computer system and/or audio content that is received from the environment in which the computer system is located). Automatically displaying the first suggestion that corresponds to the first augmented reality experience based on audio content detected in the environment of the computer system allows a user to activate a relevant augmented reality experience with fewer user inputs, thereby reducing the number of user inputs required to perform an operation.

In some embodiments, the three-dimensional environment (e.g., 712) is a passthrough environment (e.g., an optical passthrough environment and/or a virtual passthrough environment); and the first suggestion (e.g., 1000, 1004, and/or 1010) that corresponds to the first augmented reality experience is overlaid on the passthrough environment. Displaying the first suggestion that corresponds to the first augmented reality experience overlaid on the three-dimensional environment in response to detecting the first set of conditions in the three-dimensional environment allows a user to activate a relevant augmented reality experience with fewer user inputs, thereby reducing the number of user inputs required to perform an operation.

In some embodiments, while displaying the first suggestion (e.g., 1000, 1004, and/or 1010) that corresponds to the first augmented reality experience, the computer system receives, via the one or more input devices, an acceptance user input (e.g., 1006 and/or 710) (e.g., corresponding to a user request to display the first augmented reality experience (e.g., one or more user inputs and/or a set of user inputs) (e.g., one or more user gaze inputs, one or more user hand inputs (e.g., hand movements, hand gestures, and/or air gestures), and/or one or more physical control inputs (e.g., one or more button presses, one or more depressions of a depressible input mechanism, one or more rotations of a rotatable input mechanism, and/or one or more rotations and/or depressions of a rotatable and depressible input mechanism))). In response to receiving the acceptance user input, the computer system displays, via the one or more display generation components and concurrently with at least a portion of the view of the three-dimensional environment (e.g., 712) of the computer system, the first augmented reality experience (e.g., in response to user input 1006, electronic device 700 and/or HMD X700 displays objects 1008a-1008e corresponding to a translate extended reality experience) (in some embodiments, the computer system displays the first augmented reality experience overlaid on the at least a portion of the view of the three-dimensional environment of the computer system).

In some embodiments, the computer system (e.g., 700 and/or X700) is a head-mounted system. In some embodiments, the three-dimensional environment (e.g., 712) is an optical passthrough environment (e.g., the physical, real environment) that is visible to the user through transparent display generation components (e.g., transparent optical lens displays) on which the first augmented reality experience is displayed. In some embodiments, the three-dimensional environment (e.g., 712) of the computer system is an optical passthrough environment, and the first augmented reality experience (e.g., 714 and/or 1008a-1008e) is displayed concurrently with at least a portion of the view of the three-dimensional environment of the computer system by displaying the first augmented reality experience while at least a portion of the three-dimensional environment of the computer system is visible through one or more transparent displays on which the first augmented reality experience is displayed. In some embodiments, the three-dimensional environment (e.g., 712) is a virtual three-dimensional environment that is displayed by one or more display generation components (e.g., 702 and/or X702). In some embodiments, the three-dimensional environment (e.g., 712) is a virtual passthrough environment (e.g., a virtual passthrough environment that is a virtual representation of the user's physical, real-world environment (e.g., as captured by one or more cameras that are in communication with the computer system)) that is displayed by one or more display generation components. Displaying the first suggestion that allows a user to display a first augmented reality experience allows a user to activate a relevant augmented reality experience with fewer user inputs, thereby reducing the number of user inputs required to perform an operation.

In some embodiments, the acceptance user input includes a first gaze input (e.g., 710 in FIG. 10E) corresponding to the first suggestion (e.g., a user gaze directed to and/or positioned on the first suggestion). In some embodiments, the acceptance user input includes a first gaze input that meets a first set of gaze duration criteria (e.g., a user gaze directed toward the first suggestion and is maintained on the first suggestion for a threshold duration of time (e.g., without interruption and/or with less than a threshold amount of interruption)). In some embodiments, while displaying the first suggestion (e.g., 1004) that corresponds to the first augmented reality experience, the computer system receives a user input (e.g., 1006 and/or 710 in FIG. 10E) (e.g., one or more user gaze inputs, one or more user hand inputs (e.g., hand movements, hand gestures, and/or air gestures), and/or one or more physical control inputs (e.g., one or more button presses, one or more depressions of a depressible input mechanism, one or more rotations of a rotatable input mechanism, and/or one or more rotations and/or depressions of a rotatable and depressible input mechanism)). In response to receiving the user input: in accordance with a determination that the user input includes a gaze input corresponding to the first suggestion (e.g., 710 in FIG. 10E) (in some embodiments, in accordance with a determination that the user input includes a gaze input corresponding to the first suggestion that satisfies gaze threshold criteria (e.g., the gaze corresponding to the first suggestion is maintained for a threshold duration of time)), the computer system displays, via the one or more display generation components and concurrently with at least a portion of the view of the three-dimensional environment (e.g., 712) of the computer system, the first augmented reality experience (e.g., in FIG. 10F, in response to user input 1006 and gaze input 710 in FIG. 10E, electronic device 700 and/or HMD X700 displays objects 1008a-1008e corresponding to a translate extended reality experience); in accordance with a determination that the user input does not include a gaze input corresponding to the first suggestion (e.g., if in FIG. 10E, the user does not look at object 1004) (in some embodiments, in accordance with a determination that the user input does not include a gaze input corresponding to the first suggestion that satisfies gaze threshold criteria), the computer system forgoes displaying the first augmented reality experience. Enabling a user to display the first augmented reality experience based on a gaze input allows a user to activate a relevant augmented reality experience with fewer user inputs, thereby reducing the number of user inputs required to perform an operation.

In some embodiments, the acceptance user input includes a first hand input (e.g., 1006 and/or an air gesture) (e.g., a user input from the user's hand (e.g., a touch input, a gesture, and/or an air gesture)) corresponding to the first suggestion (e.g., a hand input indicative of selection of the first suggestion and/or directed towards the first suggestion). In some embodiments, the acceptance user input includes a gaze input (e.g., 710 in FIG. 10E) and a hand input (e.g., 1006 and/or an air gesture) (e.g., a hand input that occurs concurrently with the gaze input; and/or a hand input that takes place and/or is detected while a gaze of the user is directed toward the first suggestion). In some embodiments, while displaying the first suggestion (e.g., 1004) that corresponds to the first augmented reality experience, the computer system receives a user input (e.g., 710 and/or 1006 in FIG. 10E) (e.g., one or more user gaze inputs, one or more user hand inputs (e.g., hand movements, hand gestures, and/or air gestures), and/or one or more physical control inputs (e.g., one or more button presses, one or more depressions of a depressible input mechanism, one or more rotations of a rotatable input mechanism, and/or one or more rotations and/or depressions of a rotatable and depressible input mechanism)). In response to receiving the user input: in accordance with a determination that the user input includes a hand input (e.g., 1006) corresponding to the first suggestion (in some embodiments, in accordance with a determination that the user input includes a gaze input (e.g., 710 in FIG. 10E) and a hand input (e.g., 1006) corresponding to the first suggestion (e.g., 1004)), the computer system displays, via the one or more display generation components and concurrently with at least a portion of the view of the three-dimensional environment of the computer system, the first augmented reality experience (e.g., objects 1008a-1008e); in accordance with a determination that the user input does not include a hand input corresponding to the first suggestion (in some embodiments, in accordance with a determination that the user input does not include a gaze input and a hand input corresponding to the first suggestion), the computer system forgoes displaying the first augmented reality experience. Enabling a user to display the first augmented reality experience based on a hand input allows a user to activate a relevant augmented reality experience with fewer user inputs, thereby reducing the number of user inputs required to perform an operation.

In some embodiments, the acceptance user input includes a physical control input (e.g., 1006) (e.g., depression of a button, movement of a movable physical input mechanism, and/or depression of a depressible physical input mechanism) via a physical input mechanism (e.g., 704c) (e.g., a button, a rotatable input mechanism, and/or a rotatable and depressible input mechanism). In some embodiments, the acceptance user input includes a physical control input (e.g., 1006) and a gaze input (e.g., 710 in FIG. 10E) (e.g., a physical control input that occurs concurrently with the gaze input; and/or a physical control input that takes place and/or is detected while a gaze of the user is directed toward the first suggestion). In some embodiments, while displaying the first suggestion (e.g., 1004) that corresponds to the first augmented reality experience, the computer system receives a user input (e.g., 710 and/or 1006 in FIG. 10E) (e.g., one or more user gaze inputs, one or more user hand inputs (e.g., hand movements, hand gestures, and/or air gestures), and/or one or more physical control inputs (e.g., one or more button presses, one or more depressions of a depressible input mechanism, one or more rotations of a rotatable input mechanism, and/or one or more rotations and/or depressions of a rotatable and depressible input mechanism)). In response to receiving the user input: in accordance with a determination that the user input includes a physical control input (e.g., 1006) corresponding to the first suggestion (e.g., 1004) (in some embodiments, in accordance with a determination that the user input includes a gaze input (e.g., 710 in FIG. 10E) and a physical control input (e.g., 1006) corresponding to the first suggestion), the computer system displays, via the one or more display generation components and concurrently with at least a portion of the view of the three-dimensional environment (e.g., 712) of the computer system, the first augmented reality experience (e.g., objects 1008a-1008e); in accordance with a determination that the user input does not include a physical control input corresponding to the first suggestion (in some embodiments, in accordance with a determination that the user input does not include a gaze input and a physical control input corresponding to the first suggestion), the computer system forgoes displaying the first augmented reality experience. Enabling a user to display the first augmented reality experience based on a physical control input allows a user to activate a relevant augmented reality experience with fewer user inputs, thereby reducing the number of user inputs required to perform an operation.

In some embodiments, while displaying the first augmented reality experience (e.g., 714), the computer system receives, via a first physical control (e.g., 704a-704c and/or X704a-X704c) (e.g., a physical button, a rotatable input mechanism, a depressible input mechanism, and/or a rotatable and depressible input mechanism) (e.g., a first physical control of the one or more input devices), a first sequence of one or more user inputs (e.g., user inputs 718, 727, 729, and 740 in FIGS. 7B-7H) (e.g., one or more depressions of a depressible input mechanism, one or more rotations of a rotatable input mechanism, and/or one or more depressions and/or rotations of a rotatable and depressible input mechanism). In response to receiving the first sequence of one or more user inputs: the computer system ceases display of the first augmented reality experience; and displays, via the one or more display generation components and concurrently with at least a portion of the view of the three-dimensional environment of the computer system, a second augmented reality experience different from the first augmented reality experience (e.g., user inputs 718, 727, 729, and 740 in FIGS. 7B-7H result in electronic device 700 ceasing display of camera extended reality experience 714 and displaying translate extended reality experience 742) (in some embodiments, the computer system displays the second augmented reality experience overlaid on the at least a portion of the view of the three-dimensional environment of the computer system).

In some embodiments, the computer system (e.g., 700 and/or X700) is a head-mounted system. In some embodiments, the three-dimensional environment (e.g., 712) is an optical passthrough environment (e.g., the physical, real environment) that is visible to the user through transparent display generation components (e.g., transparent optical lens displays) on which the first augmented reality experience (e.g., 714) is displayed. In some embodiments, the three-dimensional environment (e.g., 712) of the computer system is an optical passthrough environment, and the second augmented reality experience (e.g., 742) is displayed concurrently with at least a portion of the view of the three-dimensional environment of the computer system by displaying the second augmented reality experience while at least a portion of the three-dimensional environment of the computer system is visible through one or more transparent displays on which the second augmented reality experience is displayed. In some embodiments, the three-dimensional environment (e.g., 712) is a virtual three-dimensional environment that is displayed by one or more display generation components (e.g., 702 and/or X702). In some embodiments, the three-dimensional environment (e.g., 712) is a virtual passthrough environment (e.g., a virtual passthrough environment that is a virtual representation of the user's physical, real-world environment (e.g., as captured by one or more cameras that are in communication with the computer system)) that is displayed by one or more display generation components (e.g., 702 and/or X702). Enabling a user to switch between augmented reality experiences with one or more user inputs on a physical control allows a user to switch between augmented reality experiences with fewer user inputs, thereby reducing the number of user inputs required to perform an operation.

In some embodiments, while displaying the first suggestion (e.g., 1000, 1004, and/or 1010), the computer system determines that a first set of dismissal criteria are met, wherein the first set of dismissal criteria includes a first criterion that is met when the first suggestion has been displayed for a threshold duration of time without a user of the computer system providing a user input that accepts the first suggestion (e.g., FIGS. 10B1-10D) (e.g., a user input that selects the first suggestion and/or a user input that corresponds to a request to display the first augmented reality experience and/or an augmented reality experience corresponding to the first suggestion). In response to determining that the first set of dismissal criteria are met, the computer system ceases display of the first suggestion (e.g., in FIGS. 10C-10D, electronic device 700 ceases display of suggestion 1000). In some embodiments, while displaying the first suggestion, the computer system determines that the first set of dismissal criteria are not met. In response to determining that the first set of dismissal criteria are not met, the computer system maintains display of the first suggestion (e.g., in FIGS. 10B1-10C, electronic device 700 maintains display of suggestion 1000). Automatically ceasing display of the first suggestion when the first set of dismissal criteria are met allows a user to cease display of the first suggestion with fewer user inputs, thereby reducing the number of user inputs required to perform an operation.

In some embodiments, the first set of conditions are detected while a second augmented reality experience different from the first augmented reality experience is displayed (e.g., in FIGS. 10B1-10D, camera extended reality experience 714 is displayed). In some embodiments, displaying the first suggestion that corresponds to the first augmented reality experience comprises: displaying the first suggestion (e.g., 1000) that corresponds to the first augmented reality experience while maintaining display of the second augmented reality experience (e.g., 714 in FIGS. 10B1-10D). In some embodiments, the first augmented reality experience corresponds to a first application (e.g., suggestion 1000 corresponds to a music application), and the second augmented reality experience corresponds to a second application different from the first application (e.g., camera extended reality experience 714 corresponds to a camera application). Displaying the first suggestion that corresponds to the first augmented reality experience in response to detecting the first set of conditions in the three-dimensional environment allows a user to activate a relevant augmented reality experience with fewer user inputs, thereby reducing the number of user inputs required to perform an operation.

In some embodiments, while displaying the first suggestion (e.g., 1000, 1004, and/or 1010) that corresponds to the first augmented reality experience, the computer system receives, via the one or more input devices, a second acceptance user input (e.g., 1006 and/or 710 in FIG. 10E) (e.g., corresponding to a user request to display the first augmented reality experience) (e.g., one or more user inputs and/or a set of user inputs) (e.g., one or more user gaze inputs, one or more user hand inputs (e.g., hand movements, hand gestures, and/or air gestures), and/or one or more physical control inputs (e.g., one or more button presses, one or more depressions of a depressible input mechanism, one or more rotations of a rotatable input mechanism, and/or one or more rotations and/or depressions of a rotatable and depressible input mechanism)). In response to receiving the second acceptance user input, the computer system ceases display of the second augmented reality experience (e.g., in some embodiments, in FIG. 10F, electronic device 700 ceases display of camera extended reality experience 714); and displays, via the one or more display generation components and concurrently with at least a portion of the view of the three-dimensional environment (e.g., 712) of the computer system, the first augmented reality experience (e.g., objects 1008a-1008e and/or translate extended reality experience 742) (in some embodiments, the computer system displays the first augmented reality experience overlaid on the at least a portion of the view of the three-dimensional environment of the computer system). Displaying the first suggestion that allows a user to switch from the second augmented reality experience to the first augmented reality experience allows a user to switch to a relevant augmented reality experience with fewer user inputs, thereby reducing the number of user inputs required to perform an operation.

In some embodiments, while displaying the first suggestion (e.g., 1000, 1004, and/or 1010) that corresponds to the first augmented reality experience, the computer system receives, via the one or more input devices, a third acceptance user input (e.g., 1006 and/or 710 in FIG. 10E) (e.g., corresponding to a user request to display the first augmented reality experience) (e.g., one or more user inputs and/or a set of user inputs) (e.g., one or more user gaze inputs, one or more user hand inputs (e.g., hand movements, hand gestures, and/or air gestures), and/or one or more physical control inputs (e.g., one or more button presses, one or more depressions of a depressible input mechanism, one or more rotations of a rotatable input mechanism, and/or one or more rotations and/or depressions of a rotatable and depressible input mechanism)). In response to receiving the third acceptance user input, the computer system displays, via the one or more display generation components (e.g., 702 and/or X702) and concurrently with at least a portion of the view of the three-dimensional environment (e.g., 712) of the computer system, the first augmented reality experience (e.g., 1008a-1008e) (in some embodiments, displays the first augmented reality experience overlaid on the at least a portion of the view of the three-dimensional environment of the computer system) while maintaining display of the second augmented reality experience (e.g., 714) (e.g., concurrently displays the first augmented reality experience and the second augmented reality experience with at least a portion of the view of the three-dimensional environment of the computer system). Displaying the first suggestion that allows a user to concurrently display the second augmented reality experience and the first augmented reality experience allows a user to activate a relevant augmented reality experience with fewer user inputs, thereby reducing the number of user inputs required to perform an operation.

In some embodiments, displaying the first suggestion (e.g., 1000, 1004, and/or 1010) comprises displaying the first suggestion in a first display region of the one or more display generation components. In some embodiments, while displaying the first suggestion (e.g., 1000, 1004, and/or 1010) in the first display region of the one or more display generation components, the computer system detects a change in the viewpoint of the user (e.g., detecting rotation and/or movement of the user's head and/or detecting rotation and/or movement of a headset and/or other wearable device (e.g., a wearable device worn on the user's head)) from being directed in a first direction (e.g., the user's face is directed in the first direction and/or a first camera of the computer system is directed in the first direction) to being directed in a second direction different from the first direction (e.g., the user's face is directed in the second direction different and/or a first camera of the computer system is directed in the second direction) (e.g., in FIGS. 10B1-10C, the viewpoint of electronic device 700 and/or HMD X700 moves, as indicated by movement of three-dimensional environment 712; in some embodiments, in which electronic device 700 is a head-mounted system, moving of the viewpoint of electronic device 700 and/or HMD X700 is indicative of a change in the viewpoint of the user because the user is wearing electronic device 700 on his or her head). Subsequent to detecting the change in the viewpoint of the user from being directed in the first direction to being directed in the second direction, and while the viewpoint of the user is directed in the second direction (e.g., FIG. 10C), the computer system displays, via the one or more display generation components, the first suggestion in the first display region of the one or more display generation components (e.g., from FIGS. 10B1-10C, even as the viewpoint of electronic device 700 and/or HMD X700 moves, suggestion 1000 is maintained in the same position on display 702) (e.g., the first suggestion continues to be displayed in the first region of the one or more display generation components even as the viewpoint of the user moves). In some embodiments, the first suggestion is a viewpoint-locked object that stays in a respective region of a field of view of a user of the computer system as a viewpoint of the user shifts relative to the three-dimensional environment. Displaying the first suggestion as a viewpoint-locked object enhances the operability of the computer system by helping the user to provide proper inputs and reducing user mistakes when operating/interacting with the computer system by keeping the first suggestion within the user's view.

In some embodiments, displaying the first suggestion comprises displaying the first suggestion in a first orientation in which the first suggestion is aligned to gravity (e.g., in FIG. 10B1 and/or 10B2, suggestion 1000 is displayed in an orientation that aligns suggestion 1000 to gravity, as the bottom of letters are directed towards the ground, and the tops of the letters are directed towards the sky) (e.g., the first suggestion has a bottom portion and a top portion, and the bottom portion is displayed closer to the ground and/or the center of the Earth than the top portion). While displaying the first suggestion in the first orientation, the computer system detects a change in orientation of the viewpoint of the user (e.g., detecting rotation and/or movement of the user's head and/or detecting rotation and/or movement of a headset and/or other wearable device (e.g., a wearable device worn on the user's head)) (e.g., the user rotates electronic device 700 and/or HMD X700, and/or, in embodiments in which electronic device 700 and/or HMD X700 is a head-mounted system, the user rotates his or her head while electronic device 700 and/or HMD X700 is mounted to the user's head). In response to detecting the change in orientation of the viewpoint of the user, the computer system rotates the first suggestion from the first orientation to a second orientation (e.g., a second orientation different from the first orientation) based on the change in orientation of the viewpoint of the user to continue to align the first suggestion to gravity (e.g., in FIG. 7B, if the user rotates electronic device 700 (or if the user mounts electronic device 700 to his or her head and rotates his or her head)), suggestion 1000 is rotated to maintain suggestion 1000 in an orientation that is aligned to gravity (e.g., bottoms of letters are pointed towards the ground and tops of letters are pointed towards the sky) (e.g., the first suggestion is displayed in such a manner that the first suggestion remains aligned to gravity (e.g., the first suggestion has a bottom portion and a top portion, and the bottom portion remains closer to the ground and/or the center of the Earth than the top portion, even as the user moves and/or rotates his or her field of view)). In some embodiments, the first suggestion is aligned to gravity (e.g., the first suggestion is displayed in such a manner that the first suggestion remains aligned to gravity (e.g., the first suggestion has a bottom portion and a top portion, and the bottom portion remains closer to the ground and/or the center of the Earth than the top portion, even as the user moves and/or rotates his or her field of view)). In some embodiments, when the computer system detects rotation of the computer system, the computer system rotates the first suggestion based on the rotation of the computer system such that a bottom portion of the first suggestion remains closer to the ground and/or the center of the Earth than a top portion of the first suggestion. Displaying the first suggestion as a viewpoint-locked object that is aligned to gravity enhances the operability of the computer system by helping the user to provide proper inputs and reducing user mistakes when operating/interacting with the computer system by keeping the first suggestion within the user's view and in a consistent alignment, even as the user moves and/or the computer system moves.

In some embodiments, rotating the first suggestion from the first orientation to the second orientation comprises: at a first time subsequent to detecting the change in orientation of the viewpoint of the user, displaying, via the one or more display generation components, the first suggestion in the first orientation, wherein at the first time, the first suggestion is not aligned to gravity due, at least in part, to the change in orientation of the viewpoint of the user; and at a second time subsequent to the first time, displaying, via the one or more display generation components, the first suggestion in the second orientation to align the first suggestion to gravity. In some embodiments, the computer system displays gradual rotation of the first suggestion from the first orientation to the second orientation over time. In some embodiments, at a third time subsequent to the first time and prior to the second time, the computer system displays, via the one or more display generation components, the first suggestion in a third orientation different from the first orientation and the second orientation, wherein the third orientation is between the first orientation and the second orientation (e.g., is at an angle between an angle of the first orientation and an angle of the second orientation). In some embodiments, the first suggestion exhibits lazy follow behavior (e.g., behavior which reduces or delays motion of the first suggestion relative to detected physical movement of the user (e.g., relative to detected physical movement of the head of the user) and/or relative to detected physical movement of the computer system). Displaying the first suggestion as a viewpoint-locked object that exhibits lazy follow behavior provides the user with visual feedback about the state of the system (e.g., that the system is intentionally moving the first suggestion as the head of the user moves), thereby providing improved visual feedback to the user.

In some embodiments, aspects/operations of methods 800, 900, 1100, 1300, and/or 1500 may be interchanged, substituted, and/or added between these methods. For example, in some embodiments, the augmented reality experience in method 800 is the extended reality experience in methods 900 and/or 1100. In another example, in some embodiments, the virtual content in method 1500 includes virtual content pertaining to the augmented reality experiences in method 800 and/or the extended reality experiences in methods 900 and/or 1100. In yet another example, in some embodiments, the computer system in method 1300 is the computer system in any one of methods 800, 900, 1100, and/or 1500. For brevity, these details are not repeated here.

FIGS. 12A-12K illustrate examples of techniques for gaze-based interactions.

FIG. 13 is a flow diagram of an exemplary method 1300 for gaze-based interactions. The user interfaces in FIGS. 12A-12K are used to illustrate the processes described below, including the processes in FIG. 13.

FIG. 12A depicts electronic device 700, which is a smartphone that includes touch-sensitive display 702 and one or more input sensors 706 (e.g., one or more cameras, eye gaze trackers, hand movement trackers, and/or head movement trackers). In some embodiments described below, electronic device 700 is a smartphone. In some embodiments, electronic device 700 is a tablet, a wearable device, a wearable smartwatch device, a head-mounted system (e.g., a headset), or other computer system that includes and/or is in communication with one or more display devices (e.g., display screen, projection device, or the like). Electronic device 700 is a computer system (e.g., computer system 101 in FIG. 1A).

At FIG. 12A, electronic device 700 displays lock screen user interface 1200 indicative of electronic device 700 being in a locked state. At FIG. 12A, electronic device also displays object 1202. In FIG. 12A, electronic device 700 detects (e.g., via one or more cameras, eye gaze trackers, and/or input sensors 706) that the user is not gazing at object 1202, as indicated by gaze indication 710. As discussed above, gaze indication 710 is provided for a better understanding of the described techniques and is optionally not a part of the user interface of the described device (e.g., is not displayed by electronic device 700). At FIG. 12B, electronic device 700 detects (e.g., via one or more cameras, eye gaze trackers, and/or input sensors 706) that the user is now looking at object 1202.

At FIG. 12C, in response to the determination that the user is looking at object 1202, electronic device 700 ceases display of object 1202, and displays instruction 1204 and gaze target 1206. As shown in FIG. 12C, instruction 1204 is displayed at the same position that object 1202 was displayed. At FIG. 12D, electronic device 700 detects (e.g., via one or more cameras, eye gaze trackers, and/or input sensors 706) that the user is looking at gaze target 1206.

At FIG. 12E, in response to the determination that the user looking at gaze target 1206, electronic device 700 displays movement of gaze target 1206 to the right. Furthermore, in FIG. 12E, electronic device 700 detects that the user's gaze is tracking the movement of gaze target 1206. In FIG. 12E, in response to determining that the user's gaze is tracking the movement of gaze target 1206, electronic device 700 outputs audio output 1208. In some embodiments, as gaze target 1206 moves to the right, and as the user continues to track the movement of gaze target 1206 with his or her gaze, audio output 1208 gets gradually louder.

FIG. 12F displays a first scenario in which the user continuously (or substantially continuously) tracks the movement of gaze target 1206 to the bottom right corner of display 702. In response to a determination that the user has successfully tracked the movement of gaze target 1206 with his or her gaze to a destination position, electronic device 700 outputs second audio output 1209 to indicate that the user has successfully tracked movement of gaze target 1206 with his or her gaze. At FIG. 12G1, in response to determining that the user has successfully tracked movement of gaze target 1206 with his or her gaze to a destination gaze target position, electronic device 700 transitions from the locked state to an unlocked state, and replaces display of lock screen user interface 1200 with a new user interface, which is a music extended reality experience 1210 overlaid on three-dimensional environment 712. In some embodiments, three-dimensional environment 712 is displayed by a display (as depicted in FIG. 12G1). In some embodiments, three-dimensional environment 712 includes a virtual environment or an image (or video) of a physical environment captured by one or more cameras (e.g., one or more cameras that are part of input sensors 706 and/or one or more cameras that are not shown in FIG. 12G1). In some embodiments, three-dimensional environment 712 is visible to a user behind extended reality experience 1210, but is not displayed by a display. For example, in some embodiments, three-dimensional environment 712 is a physical environment that is visible to a user (e.g., through a transparent display) behind extended reality experience 1210 without being displayed by a display.

In some embodiments, the techniques and user interface(s) described in FIGS. 12A-12K are provided by one or more of the devices described in FIGS. 1A-1P. For example, FIGS. 12G2-12G7 illustrate an embodiment in which object 1202, instruction 1204, and gaze target 1206 are display module X702 of head-mounted device (HMD) X700. In some embodiments, device X700 includes a pair of display modules that provide stereoscopic content to different eyes of the same user. For example, HMD X700 includes display module X702 (which provides content to a left eye of the user) and a second display module (which provides content to a right eye of the user). In some embodiments, the second display module displays a slightly different image than display module X702 to generate the illusion of stereoscopic depth.

At FIG. 12G2, HMD X700 detects (e.g., via one or more cameras, eye gaze trackers, and/or input sensors 706) that the user is now looking at object 1202.

At FIG. 12G3, in response to the determination that the user is looking at object 1202, HMD X700 ceases display of object 1202, and displays instruction 1204 and gaze target 1206. As shown in FIG. 12G3, instruction 1204 is displayed at the same position that object 1202 was displayed. At FIG. 12G4, HMD X700 detects (e.g., via one or more cameras, eye gaze trackers, and/or input sensors X706) that the user is looking at gaze target 1206.

At FIG. 12G5, in response to the determination that the user looking at gaze target 1206, HMD X700 displays movement of gaze target 1206 to the right. Furthermore, in FIG. 12G5, HMD X700 detects that the user's gaze is tracking the movement of gaze target 1206. In FIG. 12G5, in response to determining that the user's gaze is tracking the movement of gaze target 1206, HMD X700 outputs audio output 1208. In some embodiments, as gaze target 1206 moves to the right, and as the user continues to track the movement of gaze target 1206 with his or her gaze, audio output 1208 gets gradually louder.

FIG. 12G6 displays a first scenario in which the user continuously (or substantially continuously) tracks the movement of gaze target 1206 to the bottom right corner of display 702. In response to a determination that the user has successfully tracked the movement of gaze target 1206 with his or her gaze to a destination position, HMD X700 outputs second audio output 1209 to indicate that the user has successfully tracked movement of gaze target 1206 with his or her gaze. At FIG. 12G7, in response to determining that the user has successfully tracked movement of gaze target 1206 with his or her gaze to a destination gaze target position, HMD X700 transitions from the locked state to an unlocked state, and replaces display of lock screen user interface 1200 with a new user interface, which is a music extended reality experience 1210 overlaid on three-dimensional environment 712. In some embodiments, three-dimensional environment 712 is displayed by a display (as depicted in FIG. 12G7). In some embodiments, three-dimensional environment 712 includes a virtual environment or an image (or video) of a physical environment captured by one or more cameras (e.g., one or more cameras that are part of input sensors X706 and/or one or more cameras that are not shown in FIG. 12G7). In some embodiments, three-dimensional environment 712 is visible to a user behind extended reality experience 1210, but is not displayed by a display. For example, in some embodiments, three-dimensional environment 712 is a physical environment that is visible to a user (e.g., through a transparent display) behind extended reality experience 1210 without being displayed by a display.

Any of the features, components, and/or parts, including the arrangements and configurations thereof shown in FIGS. 1B-1P can be included, either alone or in any combination, in HMD X700. For example, in some embodiments, HMD X700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module X702 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, HMD X700 includes a sensor that includes any of the features, components, and/or parts of any of sensors 190, sensors 306, image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, HMD X700 includes one or more input devices, which include any of the features, components, and/or parts of any of first button 1-128, button 11.1.1-114, second button 1-132, and or dial or button 1-328, either alone or in any combination. In some embodiments, HMD X700 includes one or more audio output components (e.g., electronic component 1-112) for generating audio feedback (e.g., audio output X714-3), optionally generated based on detected events and/or user inputs detected by the HMD X700.

FIG. 12H depicts a second scenario in which the user fails to continuously (or substantially continuously) track movement of gaze target 1206 all the way to its destination position in the bottom right corner of display 702. In FIG. 12H, electronic device 700 detects (e.g., via one or more cameras, one or more gaze trackers, and/or input sensors 706) that, before gaze target 1206 reaches its destination position, the user has stopped tracking the movement of gaze target 1206 with his or her gaze. In response to this determination, electronic device 700 ceases output of audio output 1208, and ceases movement of gaze target 1206 to the right. In some embodiments, electronic device 700 ceases movement of gaze target 1206 altogether. In some embodiments, electronic device 700 moves gaze target 1206 to the left back to its original position (e.g., as shown in FIG. 12D).

At FIG. 12I, electronic device 700 detects that the user has not looked at gaze target 1206 for greater than a threshold duration of time. In response to this determination, electronic device 700 ceases display of instruction 1204 and gaze target 1206, and re-displays object 1202.

FIG. 12J depicts an alternate embodiment, in which gaze target 1214 is displayed moving along track 1216. Track 1216 provides the user with an indication of the initial position of gaze target 1214 as well as the intended destination position of gaze target 1214 (e.g., at the far right of track 1216). FIG. 12K depicts gaze target 1214 continuing to move along track 1216, and approaching its final destination position.

Additional descriptions regarding FIGS. 12A-12K are provided below in reference to method 1300 described with respect to FIGS. 12A-12K.

FIG. 13 is a flow diagram of an exemplary method 1300 for gaze-based interactions, in accordance with some embodiments. In some embodiments, method 1300 is performed at a computer system (e.g., 700) (e.g., computer system 101 in FIG. 1A) (e.g., a smart phone, a smart watch, a tablet, a wearable device, and/or head-mounted device) that is in communication with one or more display generation components (e.g., 702) (e.g., a visual output device, a 3D display, a display having at least a portion that is transparent or translucent on which images can be projected (e.g., a see-through display), a projector, a heads-up display, and/or display controller) and one or more input devices (e.g., 702, 704a-704c, and/or 706) (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; and/or a biometric sensor (e.g., a fingerprint sensor, a face identification sensor, and/or an iris identification sensor)). In some embodiments, the method 1300 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1300 are, optionally, combined and/or the order of some operations is, optionally, changed.

In some embodiments, the computer system (e.g., 700 and/or X700) detects (1302), via the one or more input devices (e.g., 706), a gaze of a user (e.g., 710) corresponding to a first display position of the one or more display generation components (e.g., FIG. 12B) (e.g., detecting that the user is gazing (e.g., looking) at the first display position and/or detecting that a position and/or orientation of the user's eyes (e.g., irises and/or pupils) correspond to the first display position). In response to detecting the gaze of the user corresponding to the first display position of the one or more display generation components (1304), the computer system displays (1306), via the one or more display generation components (e.g., 702 and/or X702), a first object (e.g., 1206). In some embodiments, the first object is displayed at the first display position. In some embodiments, the first object is displayed at a second display position different from the first display position. While displaying the first object, the computer system detects (1308) that a first set of criteria are met. In some embodiments, the first set of criteria includes a criterion that is met when the computer system detects that the user is looking at the first object. In some embodiments, the first object is displayed at a second display position different from the first display position, and the first set of criteria includes a criterion that is met when a user gaze corresponding to the second display position is detected (e.g., a criterion that is met when it is detected that the user is looking at the first object). In response to detecting that the first set of criteria are met (1310), the computer system displays (1312), via the one or more display generation components, movement of the first object (e.g., movement of 1206 in FIGS. 12D-12F) (e.g., from the first display position to a second display position or from a second display position to a third display position). Subsequent to displaying movement of the first object (1314): in accordance with a determination that the gaze of the user meets a second set of criteria indicative of gaze tracking of the movement of the first object, the computer system performs (1316) a first operation (e.g., FIGS. 12F-12H, electronic device 700 and/or HMD X700 transitions from a locked state to an unlocked state); and in accordance with a determination that the gaze of the user does not meet the second set of criteria indicative of gaze tracking of the movement of the first object, the computer system forgoes performing (1318) the first operation (e.g., FIGS. 12H-12I, electronic device 700 forgoes transitioning from the locked state to the unlocked state).

In some embodiments, the second set of criteria includes a criterion that is met when the gaze of the user moves in a manner that is consistent with the movement of the first object (e.g., FIGS. 12D-12F). In some embodiments, the second set of criteria includes a criterion that is met when the gaze of the user tracks the movement of the first object (e.g., FIGS. 12D-12F). In some embodiments, the second set of criteria includes a criterion that is met when the gaze of the user remains on the first object during movement of the first object (e.g., FIGS. 12D-12F). In some embodiments, the first operation includes one or more of: unlocking the computer system; authorizing a first transaction (e.g., a payment transaction and/or a non-payment transaction); displaying a first user interface. In some embodiments, the computer system is a head-mounted system. In some embodiments, detecting the gaze of the user corresponding to the first display position of the one or more display generation components comprises detecting the gaze of the user corresponding to the first display position of the one or more display generation components while at least a portion of the computer system is worn on the body of the user (e.g., on the head of the user). Performing the first operation in accordance with a determination the gaze of the user meets a second set of criteria indicative of gaze tracking of the movement of the first object allows a user to perform the first operation with fewer user inputs, thereby reducing the number of user inputs required to perform an operation. Performing the first operation in accordance with a determination the gaze of the user meets a second set of criteria indicative of gaze tracking of the movement of the first object provides the user with visual feedback about the state of the system (e.g., that the system has detected the gaze of the user meets the second set of criteria), thereby providing improved visual feedback to the user.

In some embodiments, prior to detecting the gaze of the user corresponding to the first display position of the one or more display generation components, the computer system displays, via the one or more display generation components, an initial object (e.g., 1202) different from the first object (e.g., 1206) at the first display position. Displaying the initial object at the first display position enhances the operability of the computer system by helping the user to provide proper inputs and reducing user mistakes when operating/interacting with the computer system by suggesting that the user should look at the first display position.

In some embodiments, in response to detecting the gaze of the user corresponding to the first display position of the one or more display generation components (e.g., FIG. 12B) (in some embodiments, in response to detecting the gaze of the user corresponding to the first display position for a threshold duration of time), the computer system changes an appearance of the initial object (e.g., from FIGS. 12B-12C, electronic device 700 and/or HMD X700 changes initial object 1202 into text 1204) (e.g., changing the shape, color, brightness, opacity, saturation, and/or size of the initial object) (in some embodiments, the computer system ceases display of the initial object and/or replaces display of the initial object with a different object). Changing an appearance of the initial object in response to detecting the gaze of the user corresponding to the first display position provides the user with visual feedback about the state of the system (e.g., that the system has detected the gaze of the user at the first display position), thereby providing improved visual feedback to the user.

In some embodiments, the initial object (e.g., 1202) is persistently displayed while the first object (e.g., 1206) is not displayed (e.g., the initial object is persistently displayed while the first object is not displayed and the computer system is on and/or while the computer system is in a locked state). Persistently displaying the initial object at the first display position enhances the operability of the computer system by helping the user to provide proper inputs and reducing user mistakes when operating/interacting with the computer system by suggesting that the user should look at the first display position.

In some embodiments, the initial object (e.g., 1202) is displayed at the first display position in response to detecting a gaze of the user corresponding to a first display region (e.g., detecting that the user is gazing at and/or within the first display region) of the one or more display generation components, wherein the first display region is larger than the first display position and includes the first display position (e.g., in some embodiments, object 1202 is displayed in response to the gaze of the user getting close to and/or approaching the bottom left corner of display 702 and/or X702). In some embodiments, the initial object is displayed in response to the user looking at a first display region of the one or more display generation components, and the first object is displayed in response to the user looking at the first display position of the one or more display generation components. Displaying the initial object at the first display position in response to detecting the gaze of the user corresponding to the first display region provides the user with visual feedback about the state of the system (e.g., that the system has detected the gaze of the user corresponding to the first display region), thereby providing improved visual feedback to the user.

In some embodiments, in response to detecting the gaze of the user corresponding to the first display position of the one or more display generation components, the computer system displays, via the one or more display generation components, and concurrently with the first object (e.g., 1206), a first instruction (e.g., 1204) (e.g., a text instruction and/or visual instruction) instructing the user to look at the first object (e.g., “look at the circle” and/or “follow the circle with your gaze”). Displaying an instruction for the user to look at the first object enhances the operability of the computer system by helping the user to provide proper inputs and reducing user mistakes when operating/interacting with the computer system.

In some embodiments, the first set of criteria includes a first criterion that is met when the computer system detects a user gaze (e.g., 710) corresponding to (e.g., directed to and/or located at) the first display position (e.g., bottom left corner of display 702 and/or X702) for a threshold duration of time (e.g., 0.25 seconds, 0.5 seconds, 0.75 seconds, and/or 1 second) (e.g., without interruption and/or with less than a threshold amount of interruption). Moving the first object based on a determination that the user has been looking at the first display position for a threshold duration of time ensures that the user is likely to see the movement of the first object, which enhances the operability of the computer system by helping the user to provide proper inputs and reducing user mistakes when operating/interacting with the computer system.

In some embodiments, the first set of criteria includes a second criterion that is met when the computer system detects a user gaze (e.g., 710) corresponding to (e.g., directed to and/or located at) the first object (e.g., 1206) (in some embodiments, for a threshold duration of time (e.g., 0.25 seconds, 0.5 seconds, 0.75 seconds, and/or 1 second) (e.g., without interruption and/or with less than a threshold amount of interruption)). Moving the first object based on a determination that the user is looking at the first object ensures that the user is likely to see the movement of the first object, which enhances the operability of the computer system by helping the user to provide proper inputs and reducing user mistakes when operating/interacting with the computer system.

In some embodiments, while displaying the first object (e.g., 1206), the computer system detects that the gaze of the user (e.g., 710) is directed to a display region of the one or more display generation components that does not correspond to the first display position or the first object (e.g., FIG. 12H) (e.g., the user is looking at a display region that does not include the first display position or the first object and/or the user is not looking at the first display position or the first object). In response to detecting that the gaze of the user is directed to a display region of the one or more display generation components that does not correspond to the first display position or the first object, the computer system ceases display of the first object (e.g., FIGS. 12H-12I). Ceasing display of the first object when the user stops looking at the first display position or the first object suggests to the user that the user should look at the first object, which enhances the operability of the computer system by helping the user to provide proper inputs and reducing user mistakes when operating/interacting with the computer system.

In some embodiments, displaying movement of the first object (e.g., 1206 in FIGS. 12D-12F) includes displaying movement of the first object at a first predetermined rate of movement (e.g., a constant rate of movement and/or a rate of movement that is determined independent of the gaze of the user). Displaying movement of the first object suggests to the user that the user should look at the first object, which enhances the operability of the computer system by helping the user to provide proper inputs and reducing user mistakes when operating/interacting with the computer system.

In some embodiments, displaying movement of the first object (e.g., 1206 in FIGS. 12D-12F) includes displaying movement of the first object at a first rate of movement (e.g., a constant rate of movement and/or a variable rate of movement), wherein the first rate of movement is determined based on the gaze of the user (e.g., 710 in FIGS. 12D-12F) (e.g., the rate of movement of the object changes based on how smoothly the user tracks the first object with their gaze and/or based on the rate of movement of the user's gaze (e.g., the first object moves at a constant rate and/or default rate if the gaze of the user tracks the movement of the first object, the first object moves faster if the gaze of the user moves ahead of the first object, and/or the first object moves slower if the gaze of the user falls behind the movement of the first object)). Displaying movement of the first object suggests to the user that the user should look at the first object, which enhances the operability of the computer system by helping the user to provide proper inputs and reducing user mistakes when operating/interacting with the computer system.

In some embodiments, the second set of criteria includes a second criterion that is met when movement of the gaze of the user (e.g., 710 in FIGS. 12D-12F) meets similarity criteria relative to the movement of the first object (e.g., 1206 in FIGS. 12D-12F) (e.g., acceleration, speed of movement, and/or path of movement of the gaze of the user satisfies similarity criteria and/or thresholds relative to the acceleration, speed of movement, and/or path of movement of the first object). Performing the first operation in accordance with a determination the gaze of the user meets a second set of criteria indicative of gaze tracking of the movement of the first object allows a user to perform the first operation with fewer user inputs, thereby reducing the number of user inputs required to perform an operation.

In some embodiments, the second set of criteria includes a smooth movement criterion that is met when movement of the gaze of the user (e.g., 710 in FIGS. 12D-12F) meets smoothness criteria indicative of smoothness of the movement of the gaze of the user (e.g., movement that includes acceleration that is less than a threshold acceleration; movement of the gaze of the user that stays within a predefined display region of the one or more display generation components; movement of the gaze of the user that stays within a predefined path of movement; and/or movement of the gaze of the user is smoother than a threshold value). Performing the first operation in accordance with a determination the gaze of the user meets a second set of criteria indicative of gaze tracking of the movement of the first object allows a user to perform the first operation with fewer user inputs, thereby reducing the number of user inputs required to perform an operation.

In some embodiments, determination of whether the movement of the gaze of the user (e.g., 710 in FIGS. 12D-12F) meets the smooth movement criterion excludes saccades (e.g., one or more abrupt, rapid, small, and/or involuntary eye movements) (e.g., movement of the user's gaze away from the first object that have a duration less than a threshold duration of time). Ignoring saccades when evaluating the movement of the gaze of the user enhances the operability of the computer system by helping the user to provide proper inputs and reducing user mistakes when operating/interacting with the computer system.

In some embodiments, displaying movement of the first object (e.g., 1206 in FIGS. 12D-12F) includes displaying movement of the first object from an initial position (e.g., 1206 in FIG. 12D) to a destination position (e.g., 1206 in FIG. 12F); and the second set of criteria includes a third criterion that is met when the gaze of the user (e.g., 710) moves to (e.g., reaches and/or arrives at) the destination position (e.g., 710 in FIG. 12F). Performing the first operation in accordance with a determination the gaze of the user meets a second set of criteria indicative of gaze tracking of the movement of the first object allows a user to perform the first operation with fewer user inputs, thereby reducing the number of user inputs required to perform an operation.

In some embodiments, while displaying movement of the first object (e.g., 1206 in FIGS. 12D-12F), the computer system displays, via the one or more display generation components and concurrently with the movement of the first object, a destination indication indicative of the destination position (e.g., track 1216 in FIG. 12J) (e.g., displaying a visual indication at the destination position and/or displaying a movement track along which the first object moves and that ends at the destination position). Displaying the destination indication indicative of the destination position enhances the operability of the computer system by helping the user to provide proper inputs and reducing user mistakes when operating/interacting with the computer system.

In some embodiments, while displaying movement of the first object (e.g., 1206 in FIGS. 12D-12F), and prior to the first object arriving at the destination position, the computer system detects, via the one or more input devices, a gaze of the user (e.g., 710) corresponding to the destination position (e.g., detecting that the gaze of the user has moved to and/or has arrived at the destination position). In response to detecting the gaze of the user corresponding to the destination position (and, optionally, prior to the first object arriving at the destination position), the computer system performs the first operation (e.g., in FIGS. 12F-12G7, unlocking the computer system). Performing the first operation in accordance with a determination the gaze of the user meets a second set of criteria indicative of gaze tracking of the movement of the first object allows a user to perform the first operation with fewer user inputs, thereby reducing the number of user inputs required to perform an operation.

In some embodiments, the second set of criteria includes a fourth criterion that is met when the gaze of the user (e.g., 710) moves to (e.g., reaches and/or arrives at) the destination position (e.g., bottom right corner of display 702 and/or end of track 1216 in FIG. 12J) and is maintained at the destination position for a threshold duration of time (e.g., without interruption and/or without a threshold amount of interruption). In some embodiments, the determination that the gaze of the user meets the second set of criteria comprises a determination that the gaze of the user (e.g., 710) moves to the destination position and is maintained at the destination position for the threshold duration of time. In some embodiments, the determination that the gaze of the user does not meet the second set of criteria comprises a determination that the gaze of the user does not move to the destination position and/or a determination that the gaze of the user is not maintained at the destination position for the threshold duration of time. In some embodiments, subsequent to displaying movement of the first object: in accordance with a determination that the gaze of the user moves to the destination position and is maintained at the destination position for the threshold duration of time, the computer system performs the first operation; and in accordance with a determination that the gaze of the user does not move to the destination position and/or in accordance with a determination that the gaze of the user is not maintained at the destination position for the threshold duration of time, the computer system forgoes performing the first operation. Performing the first operation in accordance with a determination the gaze of the user meets a second set of criteria indicative of gaze tracking of the movement of the first object allows a user to perform the first operation with fewer user inputs, thereby reducing the number of user inputs required to perform an operation.

In some embodiments, displaying movement of the first object (e.g., 1206 in FIGS. 12D-12F) comprises displaying movement of the first object from an initial position (e.g., 1206 in FIG. 12D) to a destination position (e.g., 1206 in FIG. 12F). In accordance with a determination that the gaze of the user does not meet the second set of criteria indicative of gaze tracking of the movement of the first object, the computer system displays the first object at the initial position (e.g., moving the first object back to the initial position) (e.g., in FIG. 12H, electronic device 700 moves object 1206 back to its initial position, as shown in FIG. 12D). Moving the first object back to its initial position in accordance with a determination that the gaze of the user does not meet the second set of criteria provides the user with visual feedback about the state of the system (e.g., that the system has detected the gaze of the user does not meet the second set of criteria), thereby providing improved visual feedback to the user.

In some embodiments, performing the first operation comprises transitioning the computer system from a locked state (e.g., FIG. 12F) (e.g., a state in which one or more features, functions, and/or pieces of content of the computer system are locked and/or inaccessible) to an unlocked state (e.g., FIG. 12G1) (e.g., a state in which the one or more features, functions, and/or pieces of content of the computer system that were previous locked and/or inaccessible in the locked stated are now accessible). Unlocking the computer system in accordance with a determination the gaze of the user meets a second set of criteria indicative of gaze tracking of the movement of the first object allows a user to unlock the computer system with fewer user inputs, thereby reducing the number of user inputs required to perform an operation.

In some embodiments, while displaying movement of the first object (e.g., 1206 in FIGS. 12D-12F): in accordance with a determination that the gaze of the user meets progression criteria indicative of progression towards meeting the second set of criteria (e.g., in accordance with a determination that the gaze of the user tracks the movement of the first object with a threshold level of accuracy), the computer system provides a first audio output (e.g., 1208) (e.g., outputting an audio output and/or outputting one or more sounds) (e.g., a continuous audio output and/or a period audio output). In some embodiments, while displaying movement of the first object: in accordance with a determination that the gaze of the user does not meet the progression criteria indicative of progression towards meeting the second set of criteria, the computer system forgoes providing the first audio output (e.g., in FIG. 12H, electronic device 700 does not output audio output 1208). Providing an audio output when the gaze of the user meets the progression criteria provides feedback about the state of the system (e.g., that the system has detected the gaze of the user meets the progression criteria), thereby providing improved feedback to the user.

In some embodiments, subsequent to displaying movement of the first object (e.g., 1206 in FIGS. 12D-12F): in accordance with a determination that the gaze of the user meets a second set of criteria indicative of gaze tracking of the movement of the first object, the computer system provides a second audio output (e.g., 1209) (e.g., outputting an audio output and/or outputting one or more sounds) indicative of the gaze of the user meeting the second set of criteria. In some embodiments, subsequent to displaying movement of the first object: in accordance with a determination that the gaze of the user does not meet the second set of criteria indicative of gaze tracking of the movement of the first object, the computer system forgoes providing the second audio output (e.g., in FIG. 12H, electronic device 700 does not output audio output 1209). Providing an audio output when the gaze of the user meets the second set of criteria provides feedback about the state of the system (e.g., that the system has detected the gaze of the user meets the second set of criteria), thereby providing improved feedback to the user.

While displaying movement of the first object (e.g., 1206 in FIGS. 12D-12F) and subsequent to providing the first audio output (e.g., 1208) (e.g., while providing the first audio output) (e.g., subsequent to a determination that the gaze of the user meets the progression criteria indicative of progression towards meeting the second set of criteria): in accordance with a determination that the gaze of the user no longer meets the progression criteria indicative of progression towards meeting the second set of criteria (e.g., in accordance with a determination that the gaze of the user no longer tracks the movement of the first object with a threshold level of accuracy), ceasing output of the first audio output (e.g., in FIG. 12H, electronic device 700 does not output audio output 1208) (or, in some embodiments, decreasing a volume of the first audio output and/or outputting a third audio output different from the first audio output). In some embodiments, while displaying movement of the first object (e.g., 1206 in FIGS. 12D-12F) and subsequent to providing the first audio output (e.g., 1208): in accordance with a determination that the gaze of the user continues to meet the progression criteria indicative of progression towards meeting the second set of criteria, continuing to provide the first audio output (e.g., maintaining the first audio output). Ceasing the first audio output when the gaze of the user does not meet the progression criteria provides feedback about the state of the system (e.g., that the system has detected the gaze of the user does not meet the progression criteria), thereby providing improved feedback to the user.

In some embodiments, aspects/operations of methods 800, 900, 1100, 1300, and/or 1500 may be interchanged, substituted, and/or added between these methods. For example, in some embodiments, the augmented reality experience in method 800 is the extended reality experience in methods 900 and/or 1100. In another example, in some embodiments, the virtual content in method 1500 includes virtual content pertaining to the augmented reality experiences in method 800 and/or the extended reality experiences in methods 900 and/or 1100. In yet another example, in some embodiments, the computer system in method 1300 is the computer system in any one of methods 800, 900, 1100, and/or 1500. For brevity, these details are not repeated here.

FIGS. 14A-14L illustrate examples of techniques for interacting with virtual content. FIG. 15 is a flow diagram of an exemplary method 1500 for interacting with virtual content. The user interfaces in FIGS. 14A-14L are used to illustrate the processes described below, including the processes in FIG. 15.

FIG. 14A depicts electronic device 700, which is a smartphone that includes touch-sensitive display 702, buttons 704a-704c, and one or more input sensors 706 (e.g., one or more cameras, eye gaze trackers, hand movement trackers, and/or head movement trackers). In some embodiments described below, electronic device 700 is a smartphone. In some embodiments, electronic device 700 is a tablet, a wearable device, a wearable smartwatch device, a head-mounted system (e.g., a headset), or other computer system that includes and/or is in communication with one or more display devices (e.g., display screen, projection device, or the like). Electronic device 700 is a computer system (e.g., computer system 101 in FIG. 1A).

In FIG. 14A, electronic device 700 displays translate extended reality experience 742 (e.g., an augmented reality experience and/or a virtual reality experience), which was discussed above with reference to FIGS. 7A-7K. Translate extended reality experience 742 is displayed overlaid on three-dimensional environment 712, which in FIG. 14A shows a menu. Translate extended reality experience 742 includes objects 744a-744d, and also includes translation objects 750a-750e, which represent translations of text in the menu of three-dimensional environment 712. In some embodiments, three-dimensional environment 712 is displayed by a display (as depicted in FIG. 14A). In some embodiments, three-dimensional environment 712 includes a virtual environment or an image (or video) of a physical environment captured by one or more cameras (e.g., one or more cameras that are part of input sensors 706 and/or one or more cameras that are not shown in FIG. 14A). In some embodiments, three-dimensional environment 712 is visible to a user behind translate extended reality experience 742, but is not displayed by a display. For example, in some embodiments, three-dimensional environment 712 is a physical environment that is visible to a user (e.g., through a transparent display) behind extended reality experience 712 without being displayed by a display.

In FIG. 14A, electronic device 700 also displays object 1400a (e.g., a current time indication), object 1400b (e.g., a wifi strength indication), and object 1400c (e.g., a battery level indication). In some embodiments, objects 1400a-1400c correspond to a system user interface and/or a system application (e.g., an operating system), while objects 744a-744d and 750a-750e correspond to the translate extended reality experience (e.g., a translation application). In FIG. 14A, electronic device 700 detects gesture 1404 performed by user 1402, in which user 1402 swipes his hand 1406 in front of electronic device 700 from right to left (e.g., from the user's perspective). In some embodiments, gesture 1404 corresponds to a request to clear (e.g., cease display of) some or all virtual content. In some embodiments, in response to gesture 1404 and in accordance with a determination that gesture 1404 satisfies one or more criteria, electronic device 700 clears some or all virtual content that is displayed, as will be described in greater detail below. In some embodiments, the one or more criteria includes a criterion that requires that gesture 1404 be performed a threshold distance away from the face of the user and/or a threshold distance away from electronic device 700. For example, in some embodiments, electronic device 700 is a head-mounted system, and it is possible that detection of gestures that are too close to the user's face could result in false positives (e.g., if the user is wiping his or her mouth or the user is scratching his or her face). In some embodiments, the one or more criteria includes a criterion that requires that gesture 1404 be performed within a threshold distance of the user's face and/or within a threshold distance of electronic device 700. For example, in some embodiments, electronic device 700 is a head-mounted system, and the user performs certain gestures away from the user's head (e.g., in front of the user's torso or waist), and the user performs certain gestures in front of the user's face. Accordingly, in some embodiments, the one or more criteria includes criterion that require that gesture 1404 be performed at least a first threshold distance away from the user's face (e.g., a minimum distance requirement) but also within a second threshold distance from the user's face (e.g., a maximum distance requirement).

At FIG. 14B, electronic device 700 displays the user's hand 1406 via display 702 (e.g., because the user's hand 1406 is being filmed and/or captured by one or more cameras of electronic device 700). In response to gesture 1404, electronic device 700 displays movement of objects 744a-744d and 750a-750e (corresponding to translate extended reality experience 742) off of display 702. In FIG. 14C, as gesture 1404 continues, electronic device 700 continues to display movement of objects 744a-744d and 750a-750e off of display 702. In FIG. 14D1, as gesture 1404 further continues, electronic device 700 has completely ceased display of objects 744a-744d and 750a-750e (e.g., has completely moved them off of display 702). Furthermore, in response to completion of gesture 1404 (e.g., in response to gesture 1404 satisfying completion criteria), electronic device 700 displays indication 1408, which indicates that the user can re-display objects 744a-744d and 750a-750e with a re-display gesture, as will be described in greater detail below. In some embodiments, had the user stopped gesture 1404 before the completion criteria were satisfied (e.g., before objects 744a-744d and 750a-750e were fully moved off display 702 and/or before gesture 1404 traversed a threshold distance), electronic device 700 would have moved objects 744a-744d and 750a-750e back to their original displayed positions, as shown in FIG. 14A.

In some embodiments, electronic device 700 is a head-mounted system. In some such embodiments, objects 744a-744d and 750a-750e are virtual objects displayed by one or more display generation components of the head-mounted system, and three-dimensional environment 712 is an optical passthrough environment that is visible to the user through transparent display generation components but is not displayed by the display generation components. In some embodiments, when objects 744a-744d and 750a-750e are displayed, a user is able to see three-dimensional environment 712, but the user's view is encumbered by objects 744a-744d and 750a-750e, which are displayed on top of and/or overlaid on physical three-dimensional environment 712. Accordingly, by performing gesture 1404, a user is able to clear some and/or all the virtual content that is overlaid on optical passthrough three-dimensional environment 712 in order to more clearly see optical passthrough three-dimensional environment 712.

In some embodiments, the techniques and user interface(s) described in FIGS. 14A-14L are provided by one or more of the devices described in FIGS. 1A-1P. For example, FIG. 14D2-14D4 illustrates an embodiment in which the animation described in FIGS. 14B-14D1 is displayed on display module X702 of head-mounted device (HMD) X700. In some embodiments, device X700 includes a pair of display modules that provide stereoscopic content to different eyes of the same user. For example, HMD X700 includes display module X702 (which provides content to a left eye of the user) and a second display module (which provides content to a right eye of the user). In some embodiments, the second display module displays a slightly different image than display module X702 to generate the illusion of stereoscopic depth.

At FIG. 14D2, HMD X700 displays the user's hand 1406 via display module X702 (e.g., because the user's hand 1406 is being filmed and/or captured by one or more cameras of HMD X700). In response to gesture 1404, HMD X700 displays movement of objects 744a-744d and 750a-750e (corresponding to translate extended reality experience 742) off of display module X702. In FIG. 14D3, as gesture 1404 continues, HMD X700 continues to display movement of objects 744a-744d and 750a-750e off of display module X702. In FIG. 14D4, as gesture 1404 further continues, HMD X700 has completely ceased display of objects 744a-744d and 750a-750e (e.g., has completely moved them off of display module X702). Furthermore, in response to completion of gesture 1404 (e.g., in response to gesture 1404 satisfying completion criteria), HMD X700 displays indication 1408, which indicates that the user can re-display objects 744a-744d and 750a-750e with a re-display gesture, as will be described in greater detail below. In some embodiments, had the user stopped gesture 1404 before the completion criteria were satisfied (e.g., before objects 744a-744d and 750a-750e were fully moved off display 702 and/or before gesture 1404 traversed a threshold distance), HMD X700 would have moved objects 744a-744d and 750a-750e back to their original displayed positions, as shown in FIG. 14A.

Any of the features, components, and/or parts, including the arrangements and configurations thereof shown in FIGS. 1B-1P can be included, either alone or in any combination, in HMD X700. For example, in some embodiments, HMD X700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module X702 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, HMD X700 includes a sensor that includes any of the features, components, and/or parts of any of sensors 190, sensors 306, image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, HMD X700 includes one or more input devices, which include any of the features, components, and/or parts of any of first button 1-128, button 11.1.1-114, second button 1-132, and or dial or button 1-328, either alone or in any combination. In some embodiments, HMD X700 includes one or more audio output components (e.g., electronic component 1-112) for generating audio feedback (e.g., audio output X714-3), optionally generated based on detected events and/or user inputs detected by the HMD X700.

In FIGS. 14A-14D4, in response to gesture 1404, electronic device 700 and/or HMD X700 ceased display of objects 744a-744d and 750a-750e, corresponding to translate extended reality experience 742, but maintained display of objects 1400a-1400c, which correspond to a system application and/or an operating system. FIGS. 14E-14F depict a second example scenario in which a different subset of virtual content is cleared in response to gesture 1404, and FIGS. 14G-14H depict a third example scenario in which additional virtual content is cleared in response to gesture 1404.

At FIG. 14E, electronic device 700 detects (e.g., via one or more cameras, one or more gaze trackers, and/or input sensors 706) that the user is looking at translation objects 750a-750e (as indicated by gaze indication 710) when gesture 1404 is detected and/or initiated. In FIG. 14E, in response to a first portion of gesture 1404, and based on the determination that the user is looking at translation object 750a-750e when gesture 1404 is initiated, electronic device 700 begins moving objects 750a-750d to the left while maintaining display of objects 744a-744d and 1400a-1400c (e.g., without moving objects 744a-744d and 1400a-1400c). In FIG. 14F, in response to continuation of gesture 1404, electronic device 700 completely moves objects 750a-750e off display 702 and ceases display of objects 750a-750e while maintaining display of objects 744a-744d and 1400a-1400c. Accordingly, in the embodiment shown in FIGS. 14E-14F, a user is able to selectively clear certain subsets of displayed virtual content by looking at the virtual content the user wishes to clear, and performing gesture 1404.

FIGS. 14G-14H depict a third example scenario in which additional virtual content is cleared in response to gesture 1404. At FIG. 14G, in response to the user starting gesture 1404 (e.g., in response to a first portion of gesture 1404), electronic device 700 begins moving objects 744a-744d, 750a-750e, and 1400a-1400c from right to left. In some embodiments, three-dimensional environment 712 is not moved because three-dimensional environment 712 is background content, and objects 744a-744d, 750a-750e, and 1400a-1400c are moved based on a determination that these objects represent foreground content. In some embodiments, three-dimensional environment 712 is an optical passthrough environment, and is not displayed by a display, but rather is a physical environment that is visible to the user through one or more transparent display generation components. In some such embodiments, objects 744a-744d, 750a-750e, and 1400a-1400c represent all virtual content being displayed on display 702, and electronic device 700 moves and/or ceases display of all virtual content. At FIG. 14H, in response to continuation of gesture 1404, electronic device 700 completely moves objects 744a-744d, 750a-750e, and 1400a-1400c off of display 702 and ceases display of these objects.

At FIG. 14H, electronic device 700 displays indication 1408 which, as described above, indicates that the user is able to provide one or more user inputs and/or perform one or more gestures to re-display the virtual content that was cleared. In FIG. 14H, while indication 1408 is displayed, electronic device 700 detects (e.g., via one or more cameras and/or input sensors 706) gesture 1410, in which user 1402 swipes his hand 1406 from left to right (from the perspective of the user). At FIG. 14I, electronic device 700 displays hand 1406 as the user performs gesture 1410. In response to a first portion of gesture 1410, electronic device ceases display of indication 1408, and displays at least a subset of the cleared virtual objects moving back onto display 702 from left to right. At FIG. 14J, in response to a continuation of gesture 1410, electronic device 700 continues displaying movement of objects 744a-744d, 750a-750e, and 1400a-1400c from left to right until they arrive at their final display positions.

FIGS. 14K-14L illustrate an example scenario in accordance with various embodiments in which, after the user has cleared virtual content, the user does not re-display the virtual content within a threshold duration of time. In FIG. 14K, a threshold duration of time has elapsed after gesture 1404 (e.g., after the user has cleared virtual content). In response to detecting that the threshold duration of time has elapsed, electronic device 700 outputs audio output 1412, and displays an animation in which indication 1408 moves off of display 702. At FIG. 14L, indication 1408 is no longer displayed, indicating that the user is no longer able to re-display the virtual content that was cleared via gesture 1404. In some embodiments, when electronic device 700 is in the state shown in FIG. 14L, even if the user performs gesture 1410, electronic device 700 does not re-display the cleared virtual content.

Additional descriptions regarding FIGS. 14A-14L are provided below in reference to method 1500 described with respect to FIGS. 14A-14L.

FIG. 15 is a flow diagram of an exemplary method 1500 for interacting with virtual content, in accordance with some embodiments. In some embodiments, method 1500 is performed at a computer system (e.g., 700 and/or X700) (e.g., computer system 101 in FIG. 1A) (e.g., a smart phone, a smart watch, a tablet, a wearable device, and/or head-mounted device) that is in communication with one or more display generation components (e.g., 702 and/or X702) (e.g., a visual output device, a 3D display, a display having at least a portion that is transparent or translucent on which images can be projected (e.g., a see-through display), a projector, a heads-up display, and/or display controller) and one or more input devices (e.g., 702, 704a-704c, 706, X702, X704a-X704c, and/or X706) (e.g., a touch-sensitive surface (e.g., a touch-sensitive display); a mouse; a keyboard; a remote control; a visual input device (e.g., one or more cameras (e.g., an infrared camera, a depth camera, a visible light camera)); an audio input device; and/or a biometric sensor (e.g., a fingerprint sensor, a face identification sensor, and/or an iris identification sensor)). In some embodiments, the method 1500 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1500 are, optionally, combined and/or the order of some operations is, optionally, changed.

In some embodiments, the computer system (e.g., 700 and/or X700) displays (1502), via the one or more display generation components (e.g., 702 and/or X702), virtual content (e.g., 1400a-1400c, 742, 744a-744d, and/or 750a-750e) (e.g., an augmented reality experience and/or an extended reality experience). In some embodiments, the virtual content is displayed in a three-dimensional environment (e.g., 712) (e.g., a virtual three-dimensional environment, a virtual passthrough three-dimensional environment, and/or an optical passthrough three-dimensional environment) (e.g., is applied to the three-dimensional environment, is overlaid on the three-dimensional environment, and/or is concurrently displayed with the three-dimensional environment). While displaying the virtual content (1504), the computer system detects (1506), via the one or more input devices, a first hand gesture (e.g., 1404) (e.g., one or more hand gestures, one or more air gestures, a first set of hand gestures, and/or a first set of air gestures) in front of a face of a user of the computer system. In response to detecting the first hand gesture (1508): in accordance with a determination that the first hand gesture in front of the face of the user meets a first set of criteria (1510), the computer system ceases (1512) display of at least a portion of the virtual content (e.g., some or all of the virtual content) (e.g., in FIGS. 14D1, 14D4, 14F, and 14H, electronic device 700 and/or HMD X700 ceases display of at least a portion of the virtual content (e.g., 1400a-1400c, 742, 744a-744d, and/or 750a-750e)); and in accordance with a determination that the first hand gesture in front of the face of the user does not meet the first set of criteria (1514), the computer system maintains (1516) display of the virtual content (e.g., 1400a-1400c, 742, 744a-744d, and/or 750a-750e).

In some embodiments, the virtual content (e.g., 1400a-1400c, 742, 744a-744d, and/or 750a-750e) includes a first extended reality experience (e.g., 742, 742a-744d, and/or 750a-750e) (e.g., augmented reality experience, mixed reality experience, and/or virtual reality experience) displayed in a three-dimensional environment (e.g., 712) (e.g., applied to the three-dimensional environment, overlaid on the three-dimensional environment, and/or concurrently displayed with the three-dimensional environment), and ceasing display of at least a portion of the virtual content comprises ceasing display of the first extended reality experience. In some embodiments, the computer system (e.g., 700 and/or X700) is a head-mounted system. In some embodiments, detecting the first hand gesture (e.g., 1404) in front of a face of the user comprises detecting the first hand gesture via one or more cameras (e.g., 706 and/or X706) worn on the head of the user. In some embodiments, the virtual content (e.g., 1400a-1400c, 742, 744a-744d, and/or 750a-750e) is displayed in a three-dimensional environment (e.g., 712). In some embodiments, the three-dimensional environment is an optical passthrough environment (e.g., the physical, real environment) that is visible to the user through transparent display generation components (e.g., transparent optical lens displays) on which the virtual content is displayed. In some embodiments, the three-dimensional environment is a virtual three-dimensional environment that is displayed by one or more display generation components. In some embodiments, the three-dimensional environment is a virtual passthrough environment (e.g., a virtual passthrough environment that is a virtual representation of the user's physical, real-world environment (e.g., as captured by one or more cameras that are in communication with the computer system)) that is displayed by one or more display generation components. Ceasing display of at least a portion of the virtual content in response to detecting the first hand gesture allows a user to clear virtual content with fewer user inputs, thereby reducing the number of user inputs required to perform an operation. Ceasing display of at least a portion of the virtual content in accordance with a determination that the first hand gesture in front of the face of the user meets the first set of criteria provides the user with visual feedback about the state of the system (e.g., that the system has detected the first hand gesture and determined that the first hand gesture meets the first set of criteria), thereby providing improved visual feedback to the user.

In some embodiments, the determination that the first hand gesture (e.g., 1404) in front of the face of the user meets the first set of criteria includes a determination that a speed of the first hand gesture (e.g., speed at which the hand of the user moves) satisfies speed criteria (e.g., the speed of the first hand gesture is greater than a minimum speed and/or is less than a maximum speed). In some embodiments, the first set of criteria includes a speed criterion that is met based on a speed of movement of the first hand gesture. Determining whether the first hand gesture satisfies speed criteria enhances the operability of the computer system by helping the user to provide proper inputs and reducing user mistakes when operating/interacting with the computer system (e.g., by limiting false detection of the hand gesture and/or inadvertent detection of the hand gesture).

In some embodiments, the determination that the first hand gesture (e.g., 1404) in front of the face of the user meets the first set of criteria includes a determination that a distance of a hand of the user from the face of the user satisfies distance criteria while performing the first hand gesture (e.g., the distance of the hand of the user from the face of the user is greater than a minimum distance and/or is less than a maximum distance). In some embodiments, the first set of criteria includes a distance criterion that is met based on a distance of a hand of the user while the hand is performing the first hand gesture. Determining whether the first hand gesture satisfies distance criteria enhances the operability of the computer system by helping the user to provide proper inputs and reducing user mistakes when operating/interacting with the computer system (e.g., by limiting false detection of the hand gesture and/or inadvertent detection of the hand gesture).

In some embodiments, the first set of criteria includes a first criterion that is met when the distance of the hand (e.g., 1406) of the user from the face of the user is greater than a minimum distance threshold while performing the first hand gesture (e.g., 1404). Determining whether the first hand gesture satisfies distance criteria enhances the operability of the computer system by helping the user to provide proper inputs and reducing user mistakes when operating/interacting with the computer system (e.g., by limiting false detection of the hand gesture and/or inadvertent detection of the hand gesture).

In some embodiments, the first set of criteria includes a second criterion that is met when the distance of the hand (e.g., 1406) of the user (e.g., 1402) from the face of the user is less than a maximum distance threshold while performing the first hand gesture (e.g., 1404). Determining whether the first hand gesture satisfies distance criteria enhances the operability of the computer system by helping the user to provide proper inputs and reducing user mistakes when operating/interacting with the computer system (e.g., by limiting false detection of the hand gesture and/or inadvertent detection of the hand gesture).

In some embodiments, the determination that the first hand gesture (e.g., 1404) in front of the face of the user meets the first set of criteria includes a determination that the position of the first hand gesture (e.g., 1404) (e.g., a position within the field of view of the user and/or within the field of view of one or more cameras of the computer system) (e.g., a position of the first hand gesture relative to the computer system, relative to one or more cameras of the computer system, relative to the face of the user, and/or relative to another body part of the user) satisfies position criteria (e.g., the first hand gesture is performed within a first range of distances and/or a first range of angles relative to the computer system and/or relative to one or more cameras of the computer system; and/or the first hand gesture is not performed within a second range of distances and/or a second range of angles relative to the computer system and/or relative to one or more cameras of the computer system). In some embodiments, the first set of criteria includes a hand position criterion that is met based on a position of the hand (e.g., 1406) of the user while the hand is performing the first hand gesture (e.g., 1404). Determining whether the first hand gesture satisfies position criteria enhances the operability of the computer system by helping the user to provide proper inputs and reducing user mistakes when operating/interacting with the computer system (e.g., by limiting false detection of the hand gesture and/or inadvertent detection of the hand gesture).

In some embodiments, the determination that the first hand gesture (e.g., 1404) in front of the face of the user does not meet the first set of criteria includes a determination that the first hand gesture is performed within a first predetermined portion of a field of view of the computer system (e.g., 700 and/or X700) (e.g., based on one or more cameras of the computer system). Determining whether the first hand gesture satisfies position criteria enhances the operability of the computer system by helping the user to provide proper inputs and reducing user mistakes when operating/interacting with the computer system (e.g., by limiting false detection of the hand gesture and/or inadvertent detection of the hand gesture).

In some embodiments, the determination that the first hand gesture (e.g., 1404) in front of the face of the user meets the first set of criteria includes a determination that a direction of the first hand gesture satisfies directional criteria (e.g., the direction of the first hand gesture is in a lateral (e.g., left-to-right and/or right-to-left) direction relative to the face of the user and/or is not in a vertical (e.g., top to bottom and/or bottom to top) direction relative to the face of the user). In some embodiments, the first set of criteria includes a gesture direction criterion that is met based on a direction of movement of the hand (e.g., 1406) of the user while the hand is performing the first hand gesture (e.g., 1406). Determining whether the first hand gesture satisfies directional criteria enhances the operability of the computer system by helping the user to provide proper inputs and reducing user mistakes when operating/interacting with the computer system (e.g., by limiting false detection of the hand gesture and/or inadvertent detection of the hand gesture).

In some embodiments, the virtual content includes a virtual environment (e.g., 712) (e.g., a virtual environment within which the user and/or a representation of the user is positioned and/or a virtual environment that surrounds the user and/or a representation of the user). Ceasing display of at least a portion of the virtual content in response to detecting the first hand gesture allows a user to clear virtual content with fewer user inputs, thereby reducing the number of user inputs required to perform an operation.

In some embodiments, the virtual content (e.g., 742, 744a-744d, 750a-750d, and/or 1400a-1400c) includes virtual content that is overlaid on a three-dimensional augmented reality environment (e.g., 712) (e.g., an optical passthrough environment and/or a virtual passthrough environment) that includes one or more elements that are representative of a three-dimensional environment in which the computer system is located (e.g., is a virtual representation of the three-dimensional environment in which the computer system is located (e.g., virtual passthrough environment) or is a view of the actual three-dimensional environment in which the computer system is located through transparent display generation components (e.g., optical passthrough environment)) and, optionally includes one or more virtual elements. Ceasing display of at least a portion of the virtual content in response to detecting the first hand gesture allows a user to clear virtual content with fewer user inputs, thereby reducing the number of user inputs required to perform an operation.

In some embodiments, ceasing display of at least a portion of the virtual content (e.g., 742, 744a-744d, 750a-750d, and/or 1400a-1400c) comprises ceasing display of the virtual content (e.g., 742, 744a-744d, 750a-750d, and/or 1400a-1400c) (e.g., FIG. 14H) (e.g., all of the virtual content and/or all virtual content displayed by the one or more display generation components). Ceasing display of the virtual content in response to detecting the first hand gesture allows a user to clear virtual content with fewer user inputs, thereby reducing the number of user inputs required to perform an operation.

In some embodiments, ceasing display of at least a portion of the virtual content (e.g., 742, 744a-744d, 750a-750d, and/or 1400a-1400c) comprises ceasing display of a first portion of the virtual content (e.g., ceasing display of translation objects 750a-750e in FIG. 14F) while maintaining display of a second portion of the virtual content (e.g., maintaining display of objects 1400a-1400c and/or 744a-744d in FIG. 14F). Ceasing display of a portion of the virtual content in response to detecting the first hand gesture allows a user to clear virtual content with fewer user inputs, thereby reducing the number of user inputs required to perform an operation.

In some embodiments, ceasing display of the first portion of the virtual content while maintaining display of the second portion of the virtual content comprises: in accordance with a determination that a gaze of the user (e.g., 710 in FIG. 14A and/or 14B) is directed to the first portion of the virtual content (e.g., the user is looking at the first portion of the virtual content) while the first hand gesture (e.g., 1404) is detected (e.g., in FIGS. 14A-14B, the user's gaze is directed at translation objects 750a-750e), ceasing display of the first portion of the virtual content (e.g., in FIG. 14F, ceasing display of translation objects 750a-750e); and in accordance with a determination that the gaze of the user is not directed to the second portion of the virtual content (e.g., in FIGS. 14A-14B, the user's gaze is not directed towards objects 1400a-1400c and/or 744a-744d) (e.g., the user is not looking at the second portion of the virtual content) while the first hand gesture is detected, maintaining display of the second portion of the virtual content (e.g., in FIGS. 14F, maintaining display of objects 1400a-1400c and/or 744a-744d). Ceasing display of a portion of the virtual content that the user is looking at in response to detecting the first hand gesture allows a user to clear virtual content with fewer user inputs, thereby reducing the number of user inputs required to perform an operation.

In some embodiments, the first portion of the virtual content corresponds to a first application (e.g., objects 744a-744d and 750a-750e correspond to a translation application and/or a translate extended reality experience) (e.g., is virtual content generated by and/or produced by the first application); the second portion of the virtual content corresponds to a system user interface (e.g., objects 1400a-1400c correspond to a system user interface) (e.g., is virtual content generated by an operating system of the computer system, is not virtual content generated by and/or produced by the first application, and/or is virtual content generated by a second application different from the first application); and ceasing display of the first portion of the virtual content while maintaining display of the second portion of the virtual content comprises: in accordance with a determination that the first portion of the virtual content corresponds to the first application, ceasing display of the first portion of the virtual content (e.g., in FIG. 14D1 and/or 14D4, electronic device 700 and/or HMD X700 ceases display of objects 744a-744 and 750a-750e); and in accordance with a determination that the second portion of the virtual content corresponds to the system user interface, maintaining display of the second portion of the virtual content (e.g., in FIG. 14D1 and/or 14D4, electronic device 700 and/or HMD X700 maintains display of objects 1400a-1400c). Ceasing display of virtual content corresponding to a first application in response to detecting the first hand gesture allows a user to clear virtual content with fewer user inputs, thereby reducing the number of user inputs required to perform an operation.

In some embodiments, the first portion of the virtual content corresponds to foreground content (e.g., in FIG. 14A, objects 744a-744d and 750a-750e correspond to foreground content) (e.g., is virtual content that is displayed at a topmost layer and/or is currently in focus); the second portion of the virtual content corresponds to background content (e.g., in FIG. 14A, objects 1400a-1400c correspond to background content) (e.g., is virtual content displayed in a background layer behind the topmost layer, is virtual content that is displayed behind the foreground content, and/or is virtual content that is not currently in focus); and ceasing display of the first portion of the virtual content while maintaining display of the second portion of the virtual content comprises: in accordance with a determination that the first portion of the virtual content corresponds to foreground content, ceasing display of the first portion of the virtual content (e.g., in FIG. 14D1 and/or 14D4, electronic device 700 and/or HMD X700 ceases display of objects 744a-744 and 750a-750e); and in accordance with a determination that the second portion of the virtual content corresponds to background content, maintaining display of the second portion of the virtual content (e.g., in FIG. 14D1 and/or 14D4, electronic device 700 and/or HMD X700 maintains display of objects 1400a-1400c). Ceasing display of foreground virtual content in response to detecting the first hand gesture allows a user to clear virtual content with fewer user inputs, thereby reducing the number of user inputs required to perform an operation.

In some embodiments, while displaying the virtual content, the computer system detects, via the one or more input devices, a second hand gesture (e.g., 1404) (e.g., one or more hand gestures, one or more air gestures, a first set of hand gestures, and/or a first set of air gestures) in front of the face of the user. In response to a first portion of the second hand gesture (e.g., shown in FIG. 14B, which represents an initial portion of hand gesture 1404), the computer system ceases display of a third portion of the virtual content while maintaining display of a fourth portion of the virtual content (e.g. in FIGS. 14B and 14C and/or FIGS. 14D2 and 14D3, electronic device 700 and/or HMD X700 ceases display of a first portion of virtual content 744a-744d and 750a-750e). In response to a second portion of the second hand gesture that is a continuation of the first portion of the second hand gesture (e.g., gesture 1404 continues from FIGS. 14C-14D1 and/or 14D3-14D4), the computer system ceases display of the fourth portion of the virtual content (e.g., in FIG. 14D1, in response to the second half of gesture 1404, electronic device 700 completes moving objects 744a-744d and 750a-750e off the display). In some embodiments, the virtual content disappears progressively based on the motion of the hand gesture, such that as the hand gesture progresses, more of the virtual content ceases to be displayed. Progressively ceasing display of the virtual content in response to progression of the hand gesture provides the user with visual feedback about the state of the system (e.g., that the system has detected the progression of the hand gesture), thereby providing improved visual feedback to the user.

In some embodiments, ceasing display of the fourth portion of the virtual content (e.g., FIG. 14D1 and/or 14D4) is performed in accordance with a determination that the second hand gesture meets the first set of criteria. In some embodiments, in response to the second portion of the second hand gesture (e.g., gesture 1404 continues from 14C-14D1 and/or from 14D3-14D4): in accordance with a determination that the second hand gesture does not meet the first set of criteria: the computer system maintains display of the fourth portion of the virtual content; and re-displays the third portion of the virtual content (e.g., if, in FIG. 14C and/or in FIG. 14D3, the user had terminated gesture 1404 and/or reversed gesture 1404, electronic device 700 and/or HMD X700 would, in some embodiments, move objects 744a-744d and 750a-750e back to the positions they are displayed in FIG. 14A). In some embodiments, when the user initiates a hand gesture (e.g., a hand gesture that satisfies initial criteria), the computer system begins ceasing display of a portion of the displayed virtual content, but if the hand gesture ultimately does not satisfy the first set of criteria, the computer system re-displays the portion of the virtual content that was previously removed from display. Re-displaying the third portion of the virtual content in accordance with a determination that the second hand gesture does not meet the first set of criteria provides the user with visual feedback about the state of the system (e.g., that the system has detected that the second hand gesture does not meet the first set of criteria), thereby providing improved visual feedback to the user.

Subsequent to ceasing display of the at least a portion of the virtual content, and while the at least a portion of the virtual content is not displayed (e.g., FIG. 14H), the computer system detects, via the one or more input devices, a third hand gesture (e.g., 1410) (e.g., one or more hand gestures, one or more air gestures, a first set of hand gestures, and/or a first set of air gestures) in front of a face of the user (e.g., 1402). In response to detecting the third hand gesture, and in accordance with a determination that the third hand gesture in front of the face of the user meets a second set of criteria (e.g., a second set of criteria different from the first set of criteria), the computer system re-displays the at least a portion of the virtual content (e.g., in FIG. 14J, electronic device 700 re-displays virtual content 744a-744d, 750a-750e, and/or 1400a-1400c). Re-displaying the at least a portion of the virtual content in response to detecting the third hand gesture allows a user to re-display previously cleared virtual content with fewer user inputs, thereby reducing the number of user inputs required to perform an operation.

In some embodiments, in response to detecting the third hand gesture (e.g., 1410), in accordance with a determination that the third hand gesture in front of the face of the user does not meet the second set of criteria, the computer system forgoes re-displaying the at least a portion of the virtual content (e.g., maintains the display shown in FIG. 14H). Forgoing re-displaying the at least a portion of the virtual content in accordance with a determination that the third hand gesture in front of the face of the user does not meet the second set of criteria provides the user with visual feedback about the state of the system (e.g., that the system has determined that the third hand gesture does not meet the second set of criteria), thereby providing improved visual feedback to the user. Forgoing re-displaying the at least a portion of the virtual content in accordance with a determination that the third hand gesture in front of the face of the user does not meet the second set of criteria enhances the operability of the computer system by helping the user to provide proper inputs and reducing user mistakes when operating/interacting with the computer system (e.g., by limiting undesired and/or inadvertent re-display of the previously cleared content).

In some embodiments, the first hand gesture (e.g., 1404) includes movement in a third direction (e.g., right to left in FIG. 14A) (e.g., movement of the user's hand in a third direction (e.g., left to right or right to left)); and the second set of criteria includes a third criterion that is met when the third hand gesture (e.g., 1410) includes movement in a fourth direction (e.g., left to right in FIG. 14H) different from the third direction. In some embodiments, the movement in the fourth direction includes movement in a direction opposite the third direction (e.g., the fourth direction is opposite the third direction, and/or the fourth direction is not opposite the third direction but includes movement in a direction opposite the third direction (e.g., the third direction is right to left, and the fourth direction includes movement from left to right (e.g., while also including movement in an upward and/or downward direction))). Re-displaying the at least a portion of the virtual content in response to detecting the third hand gesture allows a user to re-display previously cleared virtual content with fewer user inputs, thereby reducing the number of user inputs required to perform an operation. Forgoing re-displaying the at least a portion of the virtual content if the third hand gesture in front of the face of the user does not meet the second set of criteria enhances the operability of the computer system by helping the user to provide proper inputs and reducing user mistakes when operating/interacting with the computer system (e.g., by limiting undesired and/or inadvertent re-display of the previously cleared content).

In some embodiments, the first hand gesture (e.g., 1404) includes movement in a fifth direction (e.g., movement of the user's hand in a third direction (e.g., left to right or right to left)); and the second set of criteria includes a fourth criterion that is met when the third hand gesture (e.g., 1410) includes movement in the fifth direction. Re-displaying the at least a portion of the virtual content in response to detecting the third hand gesture allows a user to re-display previously cleared virtual content with fewer user inputs, thereby reducing the number of user inputs required to perform an operation. Forgoing re-displaying the at least a portion of the virtual content if the third hand gesture in front of the face of the user does not meet the second set of criteria enhances the operability of the computer system by helping the user to provide proper inputs and reducing user mistakes when operating/interacting with the computer system (e.g., by limiting undesired and/or inadvertent re-display of the previously cleared content).

In some embodiments, the second set of criteria includes a fifth criterion that is met when a duration of time that elapses between the first hand gesture (e.g., 1404) and the third hand gesture (e.g., 1410) is less than a threshold duration of time (e.g., the third hand gesture occurs within the threshold duration of time after the first hand gesture). Re-displaying the at least a portion of the virtual content in response to detecting the third hand gesture allows a user to re-display previously cleared virtual content with fewer user inputs, thereby reducing the number of user inputs required to perform an operation.

In some embodiments, at a first elapsed time after ceasing display of the at least a portion of the virtual content and while the at least a portion of the virtual content is not displayed, the computer system detects, via the one or more input devices, a first air gesture input (e.g., 1410) (e.g., one or more air gestures). In response to detecting the first air gesture input: in accordance with a determination that the first elapsed time is less than a first threshold duration of time (e.g., a predetermined and/or pre-specified duration of time), the computer system re-displays the at least a portion of the virtual content (e.g., as shown in FIG. 14J); and in accordance with a determination that the first elapsed time is greater than the first threshold duration of time, the computer system forgoes re-displaying the at least a portion of the virtual content (e.g., as shown in FIG. 14L). Re-displaying the at least a portion of the virtual content in response to detecting the first air gesture input allows a user to re-display previously cleared virtual content with fewer user inputs, thereby reducing the number of user inputs required to perform an operation.

In some embodiments, at a second elapsed time after ceasing display of the at least a portion of the virtual content and while the at least a portion of the virtual content is not displayed, the second elapsed time being greater than the first elapsed time, the computer system detects, via the one or more input devices, a first mechanical hardware input (e.g., a press of buttons 704a-704c) (e.g., an input via a physical input mechanism and/or physical input device) (e.g., one or more button presses, one or more depressions of a physical depressible input mechanism, and/or one or more rotations of a physical rotatable input mechanism). In response to detecting the first mechanical hardware input: the computer system re-displays the at least a portion of the virtual content (e.g., as shown in FIG. 14J). Re-displaying the at least a portion of the virtual content in response to detecting the first mechanical hardware input allows a user to re-display previously cleared virtual content with fewer user inputs, thereby reducing the number of user inputs required to perform an operation.

In some embodiments, subsequent to ceasing display of the at least a portion of the virtual content, and while the at least a portion of the virtual content is not displayed: in accordance with a determination that the at least a portion of the virtual content is available to be re-displayed (e.g., in accordance with a determination that a set of re-display criteria are met and/or in accordance with a determination that less than a threshold duration of time has elapsed since the first hand gesture) (e.g., virtual content that was previously cleared is available to be re-displayed in response to a particular user input), the computer system displays, via the one or more display generation components, a re-display indication (e.g., 1408); and in accordance with a determination that the at least a portion of the virtual content is not available to be re-displayed (e.g., in accordance with a determination that a set of re-display criteria are not met and/or in accordance with a determination that greater than a threshold duration of time has elapsed since the first hand gesture) (e.g., virtual content will not be re-displayed even if the user performs the particular input), the computer system forgoes display of the re-display indication (e.g., 1408) (e.g., in FIG. 14L, electronic device 700 ceases display and/or forgoes display of re-display indication 1408). Displaying the re-display indication if virtual content is available to be re-displayed, and forgoing displaying the re-display indication if virtual content is not available to be re-displayed provides the user with visual feedback about the state of the system (e.g., whether or not virtual content can be re-displayed), thereby providing improved visual feedback to the user.

In some embodiments, while displaying the re-display indication (e.g., 1408), the computer system outputs first audio content indicative of virtual content being available to be re-displayed (e.g., virtual content being available to be re-displayed if the user performs and/or provides a particular user input). Providing an audio output if virtual content is available to be re-displayed provides the user with feedback about the state of the system (e.g., that virtual content is available to be re-displayed), thereby providing improved feedback to the user.

In some embodiments while displaying the re-display indication (e.g., 1408), the computer system determines that content clearing criteria have been met (e.g., a threshold duration of time has passed since the first hand gesture and/or since the virtual content was cleared from the display). In response to determining that the content clearing criteria have been met: the computer system outputs second audio content (e.g., 1412) indicative of the content clearing criteria being met (and, optionally, ceasing display of the re-display indication). Providing an audio output if virtual content is no longer available to be re-displayed provides the user with feedback about the state of the system (e.g., that virtual content is no longer available to be re-displayed), thereby providing improved feedback to the user.

In some embodiments, in response to determining that the content clearing criteria have been met: the computer system ceases display of the re-display indication (e.g., FIGS. 14K-14L, electronic device 700 ceases display of indication 1408). In some embodiments, the content clearing criteria includes a criterion that is met when a threshold duration of time has passed since detecting the first hand gesture. In some embodiments, the content clearing criteria includes a criterion that is met when a threshold duration of time has passed since the computer system ceased display of at least a portion of the virtual content in response to the first hand gesture. In some embodiments, the content clear criteria includes a criterion that is met when the user provides one or more user inputs (e.g., one or more touch inputs, one or more gesture inputs, one or more gaze inputs, and/or one or more physical control inputs) indicative of a request to cease display of the re-display indication. Ceasing display of the re-display indication if virtual content is no longer available to be re-displayed provides the user with feedback about the state of the system (e.g., that virtual content is no longer available to be re-displayed), thereby providing improved feedback to the user.

In some embodiments, aspects/operations of methods 800, 900, 1100, 1300, and/or 1500 may be interchanged, substituted, and/or added between these methods. For example, in some embodiments, the augmented reality experience in method 800 is the extended reality experience in methods 900 and/or 1100. In another example, in some embodiments, the virtual content in method 1500 includes virtual content pertaining to the augmented reality experiences in method 800 and/or the extended reality experiences in methods 900 and/or 1100. In yet another example, in some embodiments, the computer system in method 1300 is the computer system in any one of methods 800, 900, 1100, and/or 1500. For brevity, these details are not repeated here

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

1-150. (canceled)

151. A computer system configured to communicate with one or more display generation components and one or more input devices, the computer system comprising:
one or more processors; and
memory storing one or more programs configured to be executed by the one or more processors, the one or more programs including instructions for:
concurrently displaying, via the one or more display generation components, in a three-dimensional environment, representations of a plurality of augmented reality experiences, including:
a first representation of a first augmented reality experience; and
a second representation of a second augmented reality experience that is different from the first augmented reality experience, wherein the second representation is different from the first representation;
while concurrently displaying, in the three-dimensional environment, the representations of the plurality of augmented reality experiences, receiving, via the one or more input devices, a first user input; and
in response to receiving the first user input:
ceasing display of the representations of one or more of the plurality of augmented reality experiences; and
in accordance with a determination that the first user input corresponds to selection of the first representation of the first augmented reality experience, displaying, via the one or more display generation components, in the three-dimensional environment, the first augmented reality experience.

152. The computer system of claim 151, wherein:
the representations of the plurality of augmented reality experiences are displayed on one or more additive light displays; and
the three-dimensional environment is an optical passthrough environment that is visible to a user through the one or more additive light displays.

153. The computer system of claim 151, the one or more programs further including instructions for:
in response to receiving the first user input:
in accordance with a determination that the first user input corresponds to selection of the second representation of the second augmented reality experience, displaying, via the one or more display generation components, in the three-dimensional environment, the second augmented reality experience,
wherein:
displaying the first augmented reality experience includes displaying a first set of interactive elements;
displaying the second augmented reality experience includes displaying a second set of interactive elements different from the first set of interactive elements;
the first representation of the first augmented reality experience includes representations of the first set of interactive elements; and
the second representation of the second augmented reality experience includes representations of the second set of interactive elements different from the representations of the first set of interactive elements.

154. The computer system of claim 153, wherein:
displaying the first augmented reality experience includes displaying the first set of interactive elements overlaid on a passthrough environment;
displaying the second augmented reality experience includes displaying the second set of interactive elements overlaid on the passthrough environment;
the first representation of the first augmented reality experience includes first placeholder background content representative of the passthrough environment; and
the second representation of the second augmented reality experience includes second placeholder background content representative of the passthrough environment.

155. The computer system of claim 153, wherein:
the representations of the first set of interactive elements are non-interactive; and
the representations of the second set of interactive elements are non-interactive.

156. The computer system of claim 153, wherein:
at least a portion of the first representation of the first augmented reality experience is displayed in a first color corresponding to the first augmented reality experience; and
at least a portion of the second representation of the second augmented reality experience is displayed in a second color corresponding to the second augmented reality experience, wherein the second color is different from the first color.

157. The computer system of claim 153, wherein:
the first representation of the first augmented reality experience includes a first identifier corresponding to the first augmented reality experience;
the second representation of the second augmented reality experience includes a second identifier different from the first identifier and corresponding to the second augmented reality experience;
displaying the first augmented reality experience includes displaying the first identifier as part of the first augmented reality experience; and
displaying the second augmented reality experience includes displaying the second identifier as part of the second augmented reality experience.

158. The computer system of claim 153, the one or more programs further including instructions for:
in response to receiving the first input:
in accordance with a determination that the first user input corresponds to selection of the first representation of the first augmented reality experience:
prior to displaying the first augmented reality experience, displaying, via the one or more display generation components, a first animation in which the first representation of the first augmented reality experience moves toward a viewpoint of a user of the computer system.

159. The computer system of claim 158, wherein:
the first representation of the first augmented reality experience includes a first border that surrounds the representations of the first set of interactive elements;
the second representation of the second augmented reality experience includes a second border that surrounds the representations of the second set of interactive elements; and
displaying the first animation includes displaying the first border moving toward the viewpoint of the user of the computer system until the first border is no longer displayed.

160. The computer system of claim 158, the one or more programs further including instructions for:
in response to receiving the first input:
in accordance with a determination that the first user input corresponds to selection of the first representation of the first augmented reality experience:
displaying, via the one or more display generation components, crossfading of the representations of the first set of interactive elements with the first set of interactive elements.

161. The computer system of claim 153, the one or more programs further including instructions for:
in response to receiving the first input:
in accordance with a determination that the first user input corresponds to selection of the first representation of the first augmented reality experience:
ceasing display of the representations of the first set of interactive elements; and
displaying, via the one or more display generation components, the first set of interactive elements.

162. The computer system of claim 151, the one or more programs further including instructions for:
prior to receiving the first user input, and while concurrently displaying, in the three-dimensional environment, the representations of the plurality of augmented reality experiences:
displaying, via the one or more display generation components, the first representation of the first augmented reality experience at a first display position;
while displaying the first representation of the first augmented reality experience at the first display position, receiving, via the one or more input devices, a second user input corresponding to a request to navigate from the first representation of the first augmented reality experience to the second representation of the second augmented reality experience; and
in response to receiving the second user input:
ceasing display of the first representation of the first augmented reality experience at the first display position; and
displaying, via the one or more display generation components, the second representation of the second augmented reality experience at the first display position.

163. The computer system of claim 151, wherein concurrently displaying the representations of the plurality of augmented reality experiences includes displaying the representations of the plurality of augmented reality experiences in a stack, wherein the first representation of the first augmented reality experience is stacked on top of the second representation of the second augmented reality experience.

164. The computer system of claim 151, the one or more programs further including instructions for:
prior to receiving the first user input, and while concurrently displaying, in the three-dimensional environment, the representations of the plurality of augmented reality experiences including concurrently displaying the first representation of the first augmented reality experience and the second representation of the second augmented reality experience, receiving, via the one or more input devices, a third user input corresponding to a request to navigate through the representations of the plurality of augmented reality experiences; and
in response to receiving the third user input:
ceasing display of the first representation of the first augmented reality experience while maintaining display of the second representation of the second augmented reality experience.

165. The computer system of claim 151, wherein:
the determination that the first user input corresponds to selection of the first representation of the first augmented reality experience comprises a determination that the first user input is a selection input that includes:
a gaze input directed toward the first representation of the first augmented reality experience; and
a hardware press input detected while the gaze input is directed toward the first representation of the first augmented reality experience.

166. The computer system of claim 151, wherein:
the determination that the first user input corresponds to selection of the first representation of the first augmented reality experience comprises a determination that the first user input is a selection input that includes:
a voice input indicative of a user request to select a selectable object.

167. The computer system of claim 151, wherein:
the determination that the first user input corresponds to selection of the first representation of the first augmented reality experience comprises a determination that the first user input is a selection input that includes:
a gaze input directed toward the first representation of the first augmented reality experience that meets a first set of gaze duration criteria.

168. The computer system of claim 151, the one or more programs further including instructions for:
while concurrently displaying the representations of the plurality of augmented reality experiences, displaying, via the one or more display generation components, one or more setting controls, including a first setting control corresponding to a first setting of the computer system;
while displaying the one or more setting controls, receiving, via the one or more input devices, a first settings input corresponding to the first setting of the computer system;
in response to receiving the first settings input, modifying the first setting from a first value to a second value different from the first value;
while concurrently displaying the representations of the plurality of augmented reality experiences and while the first setting is set to the second value, receiving, via the one or more input devices, a third user input; and
in response to receiving the third user input:
in accordance with a determination that the third user input corresponds to selection of the first representation of the first augmented reality experience, displaying, via the one or more display generation components, in the three-dimensional environment, the first augmented reality experience while maintaining the first setting at the second value; and
in accordance with a determination that the first user input corresponds to selection of the second representation of the second augmented reality experience, displaying, via the one or more display generation components, in the three-dimensional environment, the second augmented reality experience while maintaining the first setting at the second value.

169. The computer system of claim 168, wherein:
the first setting is a passthrough tinting setting;
the first value corresponds to a first amount of applied to the three-dimensional environment; and
the second value corresponds to a second amount of tinting applied to the three-dimensional environment different from the first amount of tinting.

170. The computer system of claim 168, wherein:
the first setting is a volume setting;
the first value corresponds to a first volume; and
the second value corresponds to a second volume different from the first volume.

171. The computer system of claim 168, the one or more programs further including instructions for:
while concurrently displaying the representations of the plurality of augmented reality experiences and the one or more setting controls, displaying, via the one or more display generation components, device status information indicative of the status of one or more characteristics of the computer system.

172. The computer system of claim 151, wherein the representations of the plurality of augmented reality experiences are viewpoint-locked objects that stay in a respective region of a field of view of a user of the computer system as the viewpoint of the user shifts relative to the three-dimensional environment.

173. The computer system of claim 172, wherein:
concurrently displaying the representations of the plurality of augmented reality experiences comprises concurrently displaying the representations of the plurality of augmented reality experiences in a first orientation in which the representations of the plurality of augmented reality experiences are aligned to gravity; and
the one or more programs further include instructions for:
while concurrently displaying the representations of the plurality of augmented reality experiences, detecting a change in orientation of the viewpoint of the user; and
in response to detecting the change in orientation of the viewpoint of the user:
rotating the representations of the plurality of augmented reality experiences from the first orientation to a second orientation based on the change in orientation of the viewpoint of the user to continue to align the representations of the plurality of augmented reality experiences to gravity.

174. The computer system of claim 173, wherein rotating the representations of the plurality of augmented reality experiences from the first orientation to the second orientation comprises:
at a first time subsequent to detecting the change in orientation of the viewpoint of the user, displaying, via the one or more display generation components, the representations of the plurality of augmented reality experiences in the first orientation, wherein at the first time, the representations of the plurality of augmented reality experiences are not aligned to gravity due, at least in part, to the change in orientation of the viewpoint of the user; and
at a second time subsequent to the first time, displaying, via the one or more display generation components, the representations of the plurality of augmented reality experiences in the second orientation to align the representations of the plurality of augmented reality experiences to gravity.

175. The computer system of claim 172, wherein:
displaying the first augmented reality experience includes concurrently displaying a first set of objects, including a first object and a second object, and wherein:
the first object is a viewpoint-locked object; and
the second object is an environment-locked object.

176. The computer system of claim 151, the one or more programs further including instructions for:
displaying, via the one or more display generation components, in the three-dimensional environment, the first augmented reality experience;
while displaying the first augmented reality experience, receiving, via the one or more input devices, a first voice input indicative of a user request to change from the first augmented reality experience to the second augmented reality experience; and
in response to receiving the first voice input:
ceasing display of the first augmented reality experience; and
displaying, via the one or more input devices, in the three-dimensional environment, the second augmented reality experience.

177. The computer system of claim 151, the one or more programs further including instructions for:
while the computer system is in a sleep state, receiving, via the one or more input devices, a first wake input corresponding to a request to transition the computer system from a sleep state to a wake state; and
in response to receiving the first wake input, displaying, via the one or more display generation components, the first augmented reality experience.

178. The computer system of claim 151, the one or more programs further including instructions for:
while the computer system is in a sleep state, receiving, via the one or more input devices, a first wake input corresponding to a request to transition the computer system from a sleep state to a wake state; and
in response to receiving the first wake input, displaying, via the one or more display generation components, the representations of the plurality of augmented reality experiences.

179. The computer system of claim 151, wherein the plurality of augmented reality experiences includes one or more of: a camera augmented reality experience; a translate augmented reality experience; a reading augmented reality experience; a music augmented reality experience; a navigation augmented reality experience; a photos augmented reality experience; a video messaging augmented reality experience; and/or a workout augmented reality experience.

180. A non-transitory computer-readable storage medium storing one or more programs configured to be executed by one or more processors of a computer system that is in communication with one or more display generation components and one or more input devices, the one or more programs including instructions for:
concurrently displaying, via the one or more display generation components, in a three-dimensional environment, representations of a plurality of augmented reality experiences, including:
a first representation of a first augmented reality experience; and
a second representation of a second augmented reality experience that is different from the first augmented reality experience, wherein the second representation is different from the first representation;
while concurrently displaying, in the three-dimensional environment, the representations of the plurality of augmented reality experiences, receiving, via the one or more input devices, a first user input; and
in response to receiving the first user input:
ceasing display of the representations of one or more of the plurality of augmented reality experiences; and
in accordance with a determination that the first user input corresponds to selection of the first representation of the first augmented reality experience, displaying, via the one or more display generation components, in the three-dimensional environment, the first augmented reality experience.

181. A method, comprising:
at a computer system that is in communication with one or more display generation components and one or more input devices:
concurrently displaying, via the one or more display generation components, in a three-dimensional environment, representations of a plurality of augmented reality experiences, including:
a first representation of a first augmented reality experience; and
a second representation of a second augmented reality experience that is different from the first augmented reality experience, wherein the second representation is different from the first representation;
while concurrently displaying, in the three-dimensional environment, the representations of the plurality of augmented reality experiences, receiving, via the one or more input devices, a first user input; and
in response to receiving the first user input:
ceasing display of the representations of one or more of the plurality of augmented reality experiences; and
in accordance with a determination that the first user input corresponds to selection of the first representation of the first augmented reality experience, displaying, via the one or more display generation components, in the three-dimensional environment, the first augmented reality experience.
